(19) United States
(12) Patent Application Publication
(10) Pub. No.: US 2026/0072142 A1
(43) Pub. Date: Mar. 12, 2026

(54) High utilization scanning LIDAR system

(71) Applicant: Innoviz Technologies Ltd., Rosh HaAyin (IL)

(72) Inventors: David Cohen, Nesher (IL); David Elooz, Kfar Ha'Roe (IL); Ido Amrani, Modi'in-Maccabim-Re'ut (IL); Neriya Feldmus, Elkana (IL); Ran Dahari, Rehovot (IL); Sagiv Bar David, Petach Tikva (IL); Yuval Yifat, Tel Aviv-Yafo (IL)

(21) Appl. No.: 19/318,415

(22) Filed: Sep. 4, 2025

Related U.S. Application Data
(60) Provisional application No. 63/692,102, filed on Sep. 7, 2024.

(51) Int. Cl. G01S 7/481; G01S 7/484; G01S 7/4861; G01S 7/4911; G01S 7/4913; G01S 17/931; G02B 26/12

(52) U.S. Cl. CPC G01S 7/4817; G01S 7/4815; G01S 7/484; G01S 7/4861; G01S 7/4911; G01S 7/4913; G02B 26/123; G02B 26/127; G01S 17/931

(57) ABSTRACT

Disclosed herein are methods and systems for scanning an environment using a LIDAR system comprising one or more light sources configured to emit light, one or more rotatable light deflectors having a plurality of reflective facets to direct light emitted by the light source(s) to scan a Field of View (FOV) of the LIDAR system, and one or more optical switches having at least two states. The optical switch(es) interposed between the light source(s) and the rotatable light deflector(s) is configured to switch between the at least two states such that, in a first state, the one or more optical switches direct the emitted light towards the FOV via a first reflective facet of the plurality of reflective facets, and in a second state, the one or more optical switches direct the emitted light towards the FOV via a second reflective facet of the plurality of reflective facets.

### RELATED APPLICATIONS

The present application claims priority to U.S. Provisional Patent Application No. 63/692,102, filed on Sep. 7, 2024, whose disclosure is incorporated herein by reference in its entirety.

### TECHNICAL FIELD

The present disclosure relates to Light Detection and Ranging (LIDAR) technology for scanning a surrounding environment, and, more specifically, but not exclusively, to increasing scanning utilization of the LIDAR system by projecting light to scan the surrounding environment through multiple different optical paths.

### BACKGROUND

With the advent of driver assist systems and autonomous vehicles, automobiles are equipped with systems capable of reliably sensing and interpreting their surroundings, including identifying obstacles, hazards, objects, and other physical parameters that might impact navigation of the vehicle. To this end, various technologies are currently used, for example, Radio Detection and Ranging (RADAR), LIDAR, camera-based systems, and/or the like operating alone, in conjunctions and/or in a redundant manner.

LIDAR based object detection and surroundings mapping has proved to be highly efficient, reliable, and robust compared to other detection technologies. However, while such LIDAR based detection systems may be extremely efficient, their performance, whether employing pulsed or continuous wave illumination, may be affected, and possibly significantly degraded due to environmental interference such as, for example, noise (e.g., ambient light, crosstalk, stray light, etc.), excessive light reflection, parasitic reflections, external light sources, and interferences at the component and electrical circuits level, to name just a few.

### SUMMARY

It is an object of the present disclosure to provide methods, systems and/or software program products for increasing scanning utilization of LIDAR systems by scanning an environment of the LIDAR system via multiple optical paths each utilizing a different facet of a rotating scanner at a respective time segment of the scan period (cycle) thus increasing utilization of the scanner for an increased scanning time during each scan cycle. This objective is achieved by the features of the independent claims. Further implementation forms are apparent from the dependent claims, the description, and the figures. It should be noted that multiple such implementation forms may be combined together to any single embodiment.

According to a first aspect of embodiments disclosed herein, there is provided a LIDAR system, comprising one or more light sources configured to emit light, one or more rotatable light deflectors having a plurality of reflective facets to direct light emitted by the one or more light sources to scan a Field of View (FOV) of the LIDAR system, and one or more optical switches having at least two states. The one or more optical switches interposed between the one or more light sources and the one or more rotatable light deflectors are configured to switch between the at least two states such that: in a first state, the one or more optical switches direct the emitted light towards the FOV via a first reflective facet of the plurality of reflective facets, and in a second state, the one or more optical switches direct the emitted light towards the FOV via a second reflective facet of the plurality of reflective facets.

According to a second aspect of embodiments disclosed herein, there is provided a method of scanning a field of view (FOV) of a LIDAR system, comprising using one or more processors configured for: operating one or more light sources of a LIDAR system to emit light, operating one or more rotatable light deflectors to rotate, the one or more light deflectors have a plurality of reflective facets; operating, at first time segment of a scan period of the LIDAR system, one or more optical switches interposed between the one or more light sources and the rotatable light deflector to switch to a first state for directing the light emitted by the one or more light sources towards the FOV via a first reflective facet of the plurality of reflective facets of the one or more rotatable light deflector, and operating, at second time segment of the scan period, the one or more optical switches to switch to a second state for directing the emitted light towards the FOV via a second reflective facet of the plurality of reflective facets.

According to a third aspect of embodiments disclosed herein, there is provided a LIDAR system, comprising: one or more light sources configured to emit a plurality of light beams, one or more light sensors configured to receive light, one or more rotatable light deflectors having a plurality of reflective facets for directing light beams emitted by the one or more light sources to scan a field of view (FOV) of the LIDAR system and directing light reflected from the FOV towards the one or more light sensor, and one or more processors. The one or more processors are configured for operating the one or more light sources, at a first time segment of a scan period of the LIDAR system, to emit a first subset of light beams towards the FOV via a first reflective facet of the one or more rotatable light deflectors and directing light reflected from the FOV towards the one or more light sensors via the first reflective facet, and operating the one or more light sources, at a second time segment of the scan period, to emit a second subset of light beams towards the FOV via a second reflective facet of the one or more rotatable light deflectors and directing light reflected from the FOV towards the one or more light sensors via the second reflective facet.

In a further implementation form of the first, and/or second aspects optionally together with one or more of the other implementation forms, the LIDAR system further comprises one or more processors configured to set the one or more optical switches in the first state during a first time segment of a scan period of the LIDAR system and in the second state during a second time segment of the scan period different from the first time segment.

In a further implementation form of the first, second, and/or third aspects optionally together with one or more of the other implementation forms, the first time segment and the second time segment are defined according to a size of a cross section of a beam of the emitted light and a length of each reflecting facet.

In a further implementation form of the first, and/or second aspects optionally together with one or more of the other implementation forms, the one or more processors are configured to synchronize switching of the one or more optical switches between states with rotation of the one or more rotatable light deflectors based on a number of the plurality of reflective facets and a number of the at least two states.

In a further implementation form of the first, and/or second aspects optionally together with one or more of the other implementation forms, the one or more processors are configured to prevent transmission of light emitted by the one or more light sources towards the one or more optical switches during a transition time period during which the one or more optical switches transitions between states.

In a further implementation form of the first, second, and/or third aspects optionally together with one or more of the other implementation forms, the emitted light is directed to a first portion of the FOV via the first reflective facet and to a second portion of the FOV via the second reflective facet, wherein the first and second portions are distinct from each other or at least partially overlapping with each other.

In a further implementation form of the first, second, and/or third aspects optionally together with one or more of the other implementation forms, one or more light sensors of the LIDAR system are configured to receive light reflected from the FOV scanned by the light emitted by the one or more light sources. The one or more light sensors are configured to generate signal data indicative of light collected by the one or more light sensors. Wherein first signal data is associated with light received by the one or more light sensors from the FOV in response to light projected towards the FOV via the first reflective facet, and second signal data is associated with light received by the one or more light sensors from the FOV in response to light projected towards the FOV via the second reflective facet. The association is based on a timing of the first and second states of the one or more optical switches.

In a further implementation form of the first, second, and/or third aspects optionally together with one or more of the other implementation forms, the emitted light directed towards the FOV and the reflected light which is received from the FOV and directed to the one or more light sensors share a common optical path comprising one or more optical components.

In a further implementation form of the first, and/or second aspects optionally together with one or more of the other implementation forms, the one or more optical switches are further configured to direct the light reflected from the FOV toward the one or more light sensors of the LIDAR system. Wherein in the first state light received from the FOV via the first reflective facet is directed toward the one or more light sensors, and in the second state light received from the FOV via the first reflective facet is directed toward the one or more light sensors.

In a further implementation form of the first, and/or second aspects optionally together with one or more of the other implementation forms, the one or more optical switches comprise a rotatable element comprising one or more mirror sections configured to reflect light, and one or more pass-through sections configured to pass light.

In a further implementation form of the first, and/or second aspects optionally together with one or more of the other implementation forms, when the rotatable element is in the first state, the emitted light is deflected by the one or more mirror sections toward the FOV via the first reflective facet, and when the rotatable element is in the second state, the emitted light passes through the one or more pass-through sections toward the FOV via the second reflective facet.

In a further implementation form of the first, and/or second aspects optionally together with one or more of the other implementation forms, the one or more pass-through sections comprises an aperture and/or a window transparent to the emitted light.

In a further implementation form of the first, second, and/or third aspects optionally together with one or more of the other implementation forms, the one or more rotatable light deflectors comprise a multi-faceted polygon.

In a further implementation form of the first, second, and/or third aspects optionally together with one or more of the other implementation forms, the one or more light sources are configured to emit a plurality of distributed light beams.

In a further implementation form of the first, second, and/or third aspects optionally together with one or more of the other implementation forms, the LIDAR system of any one of claims 1-15, further comprising: one or more first lenses interposed between the one or more light sources and the one or more optical switches and configured to focus the emitted light directed towards the one or more optical switches, and one or more second lenses interposed between the one or more optical switches and the one or more rotatable deflectors and configured to collimate the focused light received from the one or more optical switches.

In a further implementation form of the first, second, and/or third aspects optionally together with one or more of the other implementation forms, the LIDAR system of any one of claims 1-16, further comprising: one or more first mirrors disposed along a first optical path through which the light emitted by the one or more light sources is directed towards the FOV via the first reflective facet, and one or more second mirrors disposed along a second optical path through which the light emitted by the one or more light sources is directed towards the FOV via the second reflective facet. Wherein the one or more first mirrors and the one or more second mirrors are oriented according to a structure of the one or more rotatable light deflectors and an extent of the FOV.

In a further implementation form of the first, second, and/or third aspects optionally together with one or more of the other implementation forms, the plurality of reflective facets comprise one or more tilted reflective facets having a reflective surface tilted with respect to a rotation axis of the one or more light deflectors.

In a further implementation form of the first, second, and/or third aspects optionally together with one or more of the other implementation forms, objects in the FOV are mapped based on increased pixel data generated through increased pixel rate based on aggregated signal data indicative of light reflected from the FOV via the first reflective facet and via the second reflective facet.

In a further implementation form of the first, second, and/or third aspects optionally together with one or more of the other implementation forms, aggregated signal data is produced by aggregating signal data indicative of light reflected from the FOV via the first reflective facet at incident angles, with respect to a projection of a normal to the first reflective facet on a plane perpendicular to a rotation axis of the rotatable light deflector, having an absolute value smaller than a certain threshold angle and signal data indicative of light reflected from the FOV via the second reflective facet at incident angles, with respect to a projection of a normal to the second reflective facet on a plane perpendicular to a rotation axis of the rotatable light deflector, having an absolute value, having an absolute value smaller than the certain threshold angle.

In a further implementation form of the first, second, and/or third aspects one or more of the plurality of reflective facets is tilted with respect to a rotation axis of the one or more light deflectors. The one or more processors are further configured to aggregate first signal data indicative of light reflected from the FOV in response to light projected towards the FOV via the one or more tilted reflective facets and one or more second signal data indicative of light reflected from the FOV in response to light projected towards the FOV via one or more another reflective facets of the plurality of reflective facets. Wherein the first signal data is indicative of light received in response to light projected towards the FOV at incident angles, with respect to a projection of a normal to the one or more tilted reflective facets on a plane perpendicular to a rotation axis of the rotatable light deflector, having an absolute value smaller than a certain threshold angle, and the one or more second signal data is indicative of light received in response to light projected towards the FOV at incident angles, with respect to a projection of a normal to the one or more another reflective facets on a plane perpendicular to a rotation axis of the rotatable light deflector, having an absolute value smaller than a certain threshold angle.

In a further implementation form of the first, second, and/or third aspects optionally together with one or more of the other implementation forms, one or more processors of the LIDAR system are further configured to operate one or more light sensors of the LIDAR system. Wherein in the first state of the one or more optical switches light reflected from the FOV is directed to the one or more light sensors via a first reflective facet, and in the second state of the one or more optical switches light reflected from the FOV is directed to the one or more light sensors via a second reflective facet.

Consistent with other disclosed embodiments, non-transitory computer-readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments by way of example only. With specific reference now to the drawings in detail, it is stressed that the particulars are shown by way of example and for purposes of illustrative discussion of embodiments disclosed herein. In this regard, the description taken with the drawings makes apparent to those skilled in the art how disclosed embodiments may be practiced.

The accompanying drawings, which are incorporated in and constitute a part of this disclosure, illustrate various disclosed embodiments.

In the drawings:

FIG. 1 and FIG. 2 are schematic illustrations of an exemplary LIDAR system, in accordance with embodiments of the present disclosure;

FIG. 3 is a schematic illustration of an exemplary LIDAR system configured to direct light for scanning portions of a FOV via multiple optical paths, in accordance with embodiments of the present disclosure;

FIG. 4A and FIG. 4B are schematic illustrations of exemplary scanning polygons of a LIDAR system configured to scan portions of its FOV via multiple optical paths, in accordance with embodiments of the present disclosure;

FIG. 5 is a schematic illustration of an exemplary optical switch deployed in a LIDAR system for directing light via multiple optical paths for scanning an FOV of the LIDAR system, in accordance with embodiments of the present disclosure;

FIG. 6A and FIG. 6B are schematic illustrations of instantaneous positions of an exemplary scanning polygon of a LIDAR system having reflective facets for directing light to a FOV of the LIDAR system, in accordance with embodiments of the present disclosure;

FIG. 7 is a schematic illustration of optical elements deployed to direct light through an exemplary optical switch of a LIDAR system configured for directing light via multiple optical paths for scanning an FOV of the LIDAR system, in accordance with embodiments of the present disclosure;

FIG. 8A and FIG. 8B are schematic illustrations of an exemplary LIDAR system configured to direct light for scanning its FOV and receive light reflected from the FOV via multiple optical paths, in accordance with embodiments of the present disclosure;

FIG. 9A and FIG. 9B are schematic illustrations of exemplary scanning polygons of a LIDAR system having tilted reflective facets for directing light to scan a FOV of the LIDAR system, in accordance with embodiments of the present disclosure;

FIG. 10 illustrates spherical projection of light by a LIDAR system for scanning its FOV via multiple optical paths utilizing different facets of a scanning polygon having tilted reflective facets, in accordance with embodiments of the present disclosure;

FIG. 11A, FIG. 11B and FIG. 11C are schematic illustrations of exemplary scanning polygons of a LIDAR system configured for scanning respective FOVs, in accordance with embodiments of the present disclosure;

FIG. 12A and FIG. 12B are schematic illustrations of an exemplary LIDAR system comprising multiple rotatable light deflectors configured to direct light for scanning its FOV and receive light reflected from the FOV via multiple optical paths, in accordance with embodiments of the present disclosure;

FIG. 13 is a flow chart of an exemplary process of scanning an FOV of a LIDAR by light directed towards the FOV through multiple optical paths of the LIDAR system selected using an optical switch, in accordance with embodiments of the present disclosure;

FIG. 14 is a flow chart of an exemplary process of scanning an FOV of a LIDAR by projecting to the FOV distinct beam subsets directed via multiple optical paths of the LIDAR system, in accordance with embodiments of the present disclosure.

FIG. 15A and FIG. 15B are schematic illustrations of an exemplary LIDAR system configured to scan its FOV using distinct beam subsets directed via multiple optical paths of the LIDAR system, in accordance with embodiments of the present disclosure; and

### DETAILED DESCRIPTION

The present disclosure relates to LIDAR technology for scanning a surrounding environment, and, more specifically, but not exclusively, to increasing scanning utilization of the LIDAR system by projecting light to scan the surrounding environment through multiple different optical paths each having a respective viewpoint.

LIDAR systems, in particular LIDAR systems relying on mechanical scanners, for example, rotatable light deflectors such as, for example, scanning polygons may suffer limited scan cycle utilization since the reflective facets deflecting the projected light towards the Field of View (FOV) of the LIDAR system may be positioned and oriented for efficient scanning during only a limited portion of the time of the scan period. The scan period may correspond, for example, to a line scan time period, i.e., the time for scanning a line, for example, a horizontal line across a horizontal extent of the FOV (hFOV) and/or part thereof. In another example, the scan period may correspond to a scan cycle time period, i.e., the time for scanning the entire FOV and/or part thereof.

For example, assuming a certain LIDAR system comprising a scanning polygon is configured to scan a FOV having an hFOV of 120° between −60° and 60°. Each of the reflective facets of the scanning polygon may be properly oriented for scanning the 120° hFOV during a certain time interval of the scan period (e.g., line scan time period), for example, a time interval which is between 30% and 50% of the complete scan period. At other times of the scan period, the reflective facets of the polygon may not be properly oriented for scanning the FOV, i.e., the reflective facets may not be oriented in useful angles with respect to the FOV and may thus be useless for effectively scanning the FOV. Effective scanning of the FOV may translate to projecting all or at least most of the light emitted by the LIDAR's light source toward the FOV. Such improper orientation of the reflective facets with respect to the FOV may be due to one or more limitations, for example, the light beam(s) directed towards the reflective facet may be incident on a corner between two neighboring facets. In another example, the angle of the facet with respect to the light beam(s) may be extreme, increasing a grazing angle of the light beam(s) incident on the reflective fact which may cause “smearing” of the light beam(s) on the facet which may thus project towards the FOV with reduced focus and/or collimation and hence reduce effectivity of the projected light beam(s). Utilization of the scan period, (e.g., scan cycle, line scan, etc.) may be therefore significantly limited, since during certain time intervals of the scan period the system may be idle while waiting for the polygon to rotate to a useful angle.

According to some embodiments of the present disclosure, there are provided devices, systems, and methods for increasing utilization of the scan period by scanning the FOV from a plurality of different viewpoints with respect to the FOV. In particular, the FOV may be scanned with light directed to the FOV through a plurality of optical paths in the LIDAR system each utilizing a different reflective facet of the scanning polygon having a respective viewpoint with respect to the FOV. Increasing utilization in this case refers to increasing the amount of data captured over a time period and utilizing the system while the instantaneous position of a scanner may be not ideal for scanning light incident on it from a specific direction (this portion of the time period may be referred to as ‘wait time’). According to some embodiments, the system may use at least two reflective facets, a first and second reflective facet, to scan a single row in the FOV. When the angle of incidence of the light beam on the first facet is not optimal, the light may be directed towards the second reflective facet of the polygon towards the FOV. In effect, a single span of the FOV (e.g., horizontal) is scanned using more than one facet of the polygon.

One or more scan periods may be divided to a plurality of time segments wherein during each time segment a respective one of the reflective facets of the scanning polygon, as it rotates, may be oriented and/or positioned with respect to the FOV to effectively scan the FOV.

The LIDAR system may therefore be operated during each scan period to direct light for scanning (illuminating) the FOV through a plurality of different optical paths in the LIDAR system each using a respective effectively oriented reflective facet. As such, during each time segment the light is directed toward the FOV through a respective optical path via a respective reflective facet.

For example, a time period allocated for scanning a line, for example, a horizontal line, or a vertical column may be divided to two time segments where during the first time segment the light may be directed toward the FOV through a first optical path via a first reflective facet of the scanning polygon while during the second time segment the light may be directed toward the FOV through a second optical path via a second reflective facet. In another example, a time period allocated for a scan cycle of the FOV may be divided to two time segments where during the first time segment of the scan cycle, the light is directed toward the FOV through the first optical path utilizing the first reflective facet while during the second time segment of the scan cycle, the light may be directed toward the FOV through the second optical path via the second reflective facet.

In particular, the light projected towards the FOV through the plurality of optical paths may originate from the same one or more light sources of the LIDAR system configured to emit light, for example, one or more laser beams. Moreover, light received from the FOV including light reflected from one or more objects in the FOV illuminated with the light projected through the plurality of optical paths may be received and measured by the same one or more light sensors.

One or more methods, technologies, and/or architectures may be applied to direct the light emitted by the light source(s) of the LIDAR system to the first optical path at a first time, and a second optical path at a second time.

For example, one or more optical switches may be interposed in the LIDAR system between the light source(s) and the light deflector, for example, the scanning polygon. The optical switch(es) may have a plurality of states such that in each state they may direct the light emitted from the light source(s) towards the scanning polygon through different ones of the plurality of optical paths. The optical switch(es) may be thus operated, in synchronization with the scanning polygon to switch between states during each scan period such that during a first time segment of the scan period, the light may be directed from the light source(s) to the scanning polygon through a first optical path and deflected towards the FOV via a first reflective facet, while during a second time segment of the scan period, the light may be directed from the light source(s) to the scanning polygon through a second optical path and deflected towards the FOV via a second reflective facet, and so on. The first time segment and the second time segment may be distinct.

In another example, the light source(s) may be configured to emit a plurality of light beams, for example, an array of beams. The LIDAR system may include one or more optical elements configured to direct a respective subset of the plurality of light beams towards the scanning polygon through a plurality of different optical paths each via a respective reflective facet of the scanning polygon. The light source(s) may be operated, in synchronization with the scanning polygon, to emit a respective subset of light beams during each time segment of one or more scan periods, for example, during a first time segment of the scan period emit a first subset of light beams which may be directed from the light source(s) to the scanning polygon through a first optical path and deflected towards the FOV via a first reflective facet, during a second time segment of the scan period emit a second subset of light beams which may be directed from the light source(s) to the scanning polygon through a second optical path and deflected towards the FOV via a second reflective facet, and so on.

Scanning the FOV of the LIDAR system by projecting light towards the FOV from a plurality of different reflective facets of the scanning polygon during different time segments of a scan period may be beneficial and advantageous in comparison with currently existing LIDAR systems.

First, existing LIDAR systems may typically scan a FOV with light projected towards the FOV from a single facet of their scanning polygon which may significantly limit the utilization of the scan period (e.g., scan cycle) since the instantaneously used reflective facet may be positioned to effectively scan the FOV during only a portion of the scan period which may be significantly limited (e.g., 30-50% of the scan period). Effective positioning may indicate that the entire beam spot is incident on a single facet, or substantially all of the light emitted towards the FOV via the facet is reflected by the facet (in contrast with a portion of the light). Additionally or alternatively, effective positioning may indicate that the angle of incidence of the emitted light with the reflective facet is not above a threshold value. Scanning the FOV by projecting light from a plurality of different reflective facets of the scanning polygon during different segments of each scan period may therefore significantly increase utilization of the scan period since during each time segment a different reflective facet may be oriented to effectively scan the FOV and/or part thereof. As such, more time of each scan period, i.e., a larger part of the scan period (e.g., 70-90%), may be utilized for scanning the FOV thus increasing the number of points sampled in the FOV, reducing the frame rate, and/or increasing angular extent of the FOV. The increased sampling may yield an increased pixel rate which may significantly increase detection performance of the LIDAR system, for example, accuracy, distance, reliability, consistency, immunity to noise, and/or the like, for example, through faster and improved generation of 3D models representing the FOV (e.g., point cloud) generated based on the pixel data.

Moreover, scanning the FOV by projecting light from a single viewpoint of the LIDAR system with respect to the FOV may limit the angular extent of the FOV since the surface of the reflective facet, specifically its usable surface may be limited. In contrast, scanning the FOV through a plurality of optical paths each utilizing a respective reflective facet positioning with respect to the FOV may potentially increase the angular extent of the FOV (e.g., horizontal extent and/or vertical extent) which may be scanned by the LIDAR system. This may increase ability to detect objects in a larger FOV based on the depth and detection data generated by the LIDAR system.

Furthermore, scanning the FOV from a single optical path may suffer distortions, and/or degraded quality, in particular where the projected light is incident on the facet at large incidence angles (grazing angles) with respect to a vector normal to the facet and may be therefore smeared, and/or overextended on the facet. This may induce distortions in the scanned image of the FOV including increased divergence of projected light, “keystone” effects, and more. Such distortions and/or performance degradation may be overcome and/or corrected by scanning the FOV and/or part thereof from a plurality of different viewpoints, for example, two sides of the scanning polygon such that the FOV and/or part thereof may be mapped based on light projected primarily and/or exclusively to the near field from each side of the scanning polygon.

The following detailed description refers to the accompanying drawings. Wherever possible, the same reference numbers are used in the drawings and the following description to refer to the same or similar parts.

While illustrative embodiments are described herein, it is to be understood that these are not necessarily limited in their application to the details of construction and/or arrangement of the components, systems, or methods, since modifications, adaptations and other implementations are possible. For example, as may be appreciated by one skilled in the art, substitutions, additions, and/or modifications may be made to the components illustrated in the drawings, and the illustrative methods described herein may be modified by substituting, reordering, removing, or adding steps to the disclosed methods.

Accordingly, the following detailed description is not limited to the disclosed embodiments and examples. Instead, the proper scope is defined by the appended claims.

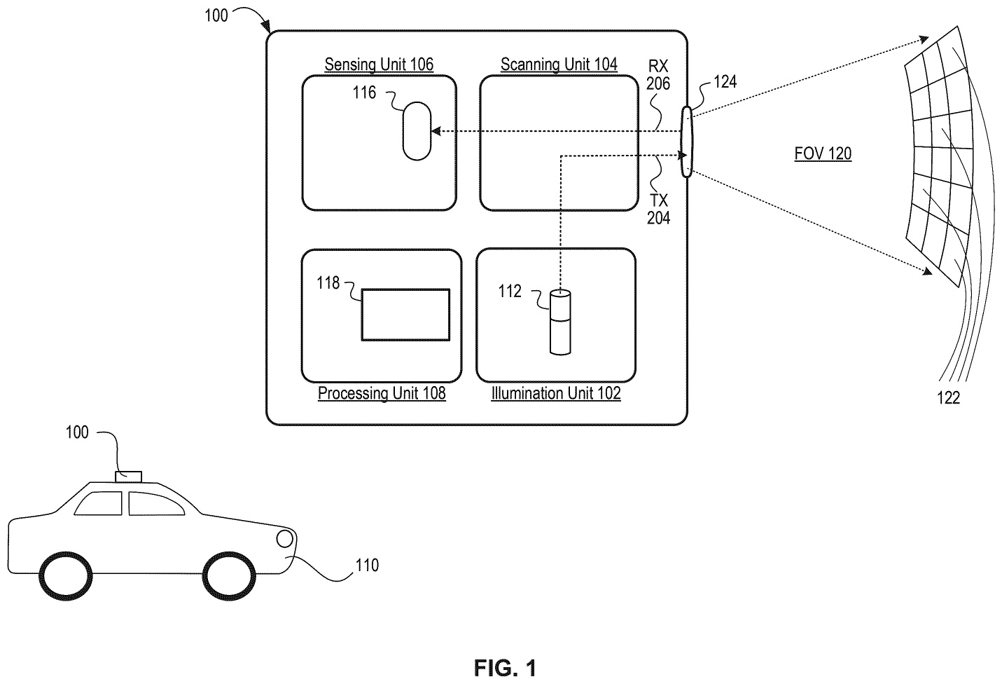

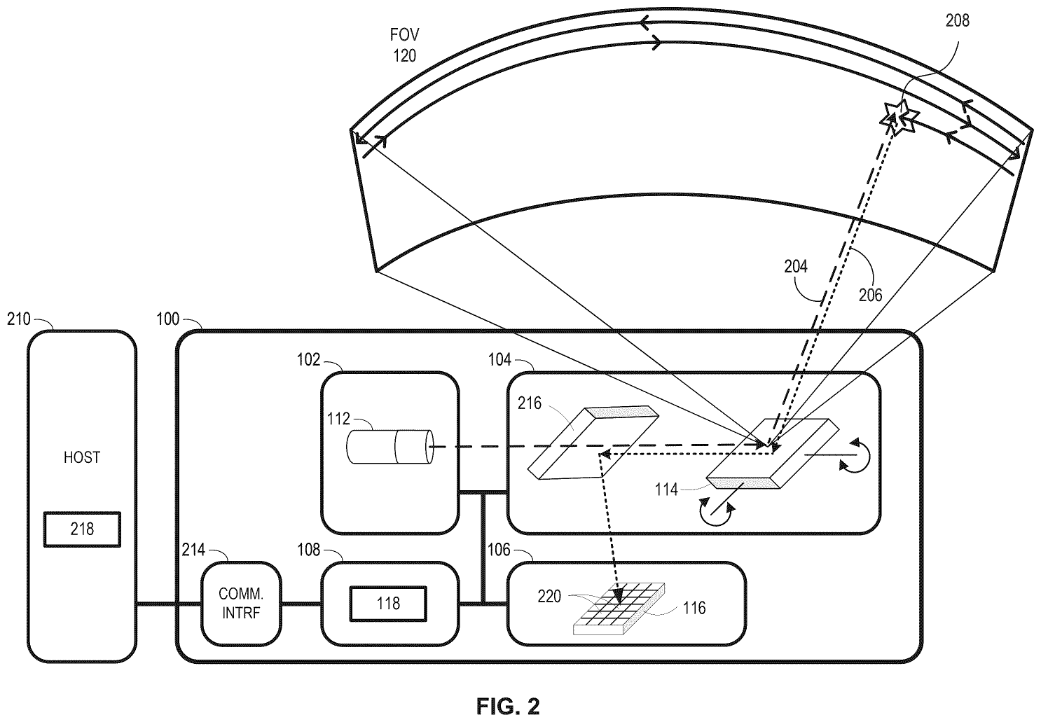

Referring now to the drawings, FIG. 1 and FIG. 2 are schematic illustrations of an exemplary LIDAR system, in accordance with embodiments of the present disclosure. The LIDAR system 100 may be used, for example, in one or more ground vehicles 110, autonomous and/or semi-autonomous, for example, road-vehicles such as, for example, cars, buses, vans, trucks and any other terrestrial vehicle. Ground vehicles 110 equipped with the LIDAR system 100 may scan their environment and drive to a destination vehicle with reduced and potentially without human intervention. In another example, the LIDAR system 100 may be used in one or more autonomous/semi-autonomous aerial-vehicles such as, for example, Unmanned Aerial Vehicles (UAV), drones, quadcopters, and/or any other airborne vehicle or device. In another example, the LIDAR system 100 may be used in one or more autonomous or semi-autonomous water vessels such as, for example, boats, ships, hovercrafts, submarines, and/or the like. Autonomous aerial-vehicles and watercrafts with LIDAR system 100 may scan their environment and navigate to a destination autonomously or under remote human operation.

It should be noted that the LIDAR system 100 or any of its components may be used together with any of the example embodiments and methods disclosed herein. Moreover, while aspects of the LIDAR system 100 may be described herein with respect to an exemplary vehicle-based LIDAR platform, the LIDAR system 100, any of its components, or any of the processes described herein may be applicable to one or more LIDAR systems of other platform types. As such, LIDAR systems such as the LIDAR system 100 may be installed, mounted, integrated, and/or otherwise deployed, in dynamic and/or stationary deployment for one or more other applications, for example, a surveillance system, a security system, a monitoring system, and/or the like. Such LIDAR systems may be configured to scan their environment in order to detect objects according to their respective application needs, criteria, requirements, and/or definitions.

The LIDAR system 100 be configured to detect tangible objects in an environment of the LIDAR system 100, specifically in a scene contained in an FOV 120 of the LIDAR system 100. The LIDAR system 100 may detect object in the FOV 120 based on reflected light, and more specifically, based on light projected by the LIDAR system 100 and reflected by objects in the FOV 120.

The scene may include some or all objects within the FOV 120, in their relative positions and in their current states, for example, ground elements (e.g., earth, roads, grass, sidewalks, road surface marking, etc.), sky, man-made objects (e.g., vehicles, buildings, signs, etc.), vegetation, people, animals, light projecting elements (e.g., flashlights, sun, other LIDAR systems, etc.), and/or the like.

An object refers to a finite composition of matter that may reflect light from at least a portion thereof. An object may be at least partially solid (e.g., car, tree, etc.), at least partially liquid (e.g., puddles on a road, rain, etc.), at least partly gaseous (e.g., fumes, clouds, etc.), made of a multitude of distinct particles (e.g., sandstorm, fog, spray, etc.), and/or a combination thereof. An object may be of one or more scales of magnitude, such as, for example, ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on.

The LIDAR system 100 may be configured to detect objects by scanning the environment of the LIDAR system 100, i.e., illuminating at least part of the FOV 120 of the LIDAR system 100 and collecting and/or receiving light reflected from (scattered of) objects in the illuminated part(s) of the FOV 120. The LIDAR system 100 may scan the FOV 120 and/or part thereof in a plurality of scanning cycles (frames) conducted at one or more frequencies (frame rate), for example, 5 frames per second (fps), 10 fps, 15 fps, 20 fps, and/or the like.

The LIDAR system 100 may apply one or more scanning mechanisms, methods, and/or implementations for scanning the environment. For example, the LIDAR system 100 may scan the environment by moving and/or pivoting one or more deflectors of the LIDAR system 100 which are configured to deflect light emitted from one or more light sources of the LIDAR system 100 in differing directions toward distinct parts of the FOV 120. In another example, the LIDAR system 100 may scan the environment by changing positioning (i.e., location and/or orientation) of one or more sensor associated with the LIDAR system 100 with respect to the FOV 120. In another example, the LIDAR system 100 may scan the environment by changing positioning (i.e., location, and/or orientation) of one or more of the light sources associated with the LIDAR system 100 with respect to the FOV 120. In another example, the LIDAR system 100 may scan the environment by changing the positioning of the sensor(s) and the light source(s) associated with the LIDAR system 100 with respect to the FOV 120.

The FOV 120 scanned by the LIDAR system 100, i.e., the environment in which the LIDAR system 100 may detect objects, may include an extent of the observable environment of LIDAR system 100 in which objects may be detected. The extent of the FOV 120 may be defined by a horizontal range (e.g., 50°, 120°, 360°, etc.), and a vertical elevation (e.g., ±20°, +40°−20°, ±90°, 0°−90°, etc.). The FOV 120 may also be defined within a certain range, for example, up to a certain depth/distance (e.g., 100 m, 200 m, 300 m, etc.), and up to a certain vertical distance (e.g., 10 m, 25 m, 50 m, etc.).

The FOV 120 may be divided (segmented) into a plurality of portions 122 (segments), also designated FOV pixels, having uniform and/or different sizes. In some embodiments, as illustrated in FIG. 1, the FOV 120 may be divided into a plurality of portions 122 arranged in the form of a two-dimensional array of rows and columns. At any given time during a scan of the FOV 120, the LIDAR system 100 may scan an instantaneous FOV which comprises a respective portion 122. Obviously, the portion 122 scanned during each instantaneous FOV may be narrower than the entire FOV 120, and the LIDAR system 100 may thus move the instantaneous FOV within the FOV 120 in order to scan the entire FOV 120.

Detecting an object may broadly refer to determining an existence of the object in the FOV 120 of the LIDAR system 100 which reflects light emitted by the LIDAR system 100 toward one or more light sensors, interchangeably designated sensors or detectors, associated with the LIDAR system 100. Additionally, or alternatively, detecting an object may refer to determining one or more physical parameters relating to the detected object and generating information indicative of the determined physical parameters, for example, a distance between the detected object and one or more other objects (e.g., the LIDAR system 100, another object detected in the FOV 120, ground (earth), etc.), a kinematic parameter of the detected object (e.g., relative velocity, absolute velocity, movement direction, expansion of the object, etc.), a reflectivity (level) of the detected object, and/or the like.

The LIDAR system 100 may employ one or more detection technologies. For example, the LIDAR system 100 may employ Time of Flight (ToF) detection where the light signal emitted by the LIDAR system 100 may comprise one or more short pulses, whose rise and/or fall time may be detected in reception of the emitted light after reflected by one or more objects in the FOV 120. In another example, the LIDAR system 100 may employ Continuous Wave (CW) detection, for example, Frequency Modulated Continuous Wave (FMCW), phase-shift continuous wave, and/or the like.

The LIDAR system 100 may detect objects in the scanned FOV 120 and/or part thereof by processing detection results based on sensory data received from the sensor(s). For example, in a ToF based LIDAR system 100, such sensory data may include temporal information indicative of a period of time between the emission of a light signal (pulse) by the light source(s) of the LIDAR system 100 and the time of detection of a reflected light signal (pulse) by the sensor(s) associated with the LIDAR system 100. In another example, in a CW based LIDAR system, the sensory data may include information indicative of one or more differences between the transmitted light signal (reference signal) and the reflected light signal, for example, a frequency difference, a phase difference, and/or the like.

For various reasons, the LIDAR system 100 may detect only part of one or more objects which are present in the FOV 120. For example, light may be reflected from only some sides of an object, typically the side(s) opposing the LIDAR system 100 which may be therefore detected by the LIDAR system 100. In another example, light emitted by the LIDAR system 100, for example, a laser beam may be projected on only part of an object projected onto a road or a building. In another example, an object may be partly blocked and/or obscured by another object between the LIDAR system 100 and the detected object. In another example, ambient light and/or one or more other interferences (e.g., adversarial environmental conditions) may interfere with detection of one or more portions of an object.

Optionally, detecting an object by the LIDAR system 100 may further refer to identifying the object, for example, classifying a type of the object (e.g., car, person, tree, road, traffic light, etc.), recognizing a specific object (e.g., natural site, structure, monument, etc.), determining a text value of the object (e.g., license plate number, road sign markings, etc.), determining a composition of the object (e.g., solid, liquid, transparent, semitransparent, etc.), and/or the like.

As seen in FIG. 1, the LIDAR system 100 may comprise a illumination unit 102, a scanning unit 104, a sensing unit 106, and a processing unit 108. According to some embodiments, the LIDAR system 100 may be mountable on a vehicle 110.

Optionally, the LIDAR system 100 may include one or more optical windows 124 for transmitting outgoing light projected toward the FOV 120 and/or for receiving incoming light reflected from objects in FOV 120. The optical window(s) 124, for example, an opening, a flat window, a lens, or any other type of optical window may be used for one or more purposes, for example, collimating the projected light, focusing of the reflected light, and/or the like.

The LIDAR system 100 may be contained in a single housing and/or divided among a plurality of housings connected to each other via one or more communication channels, for example, a wired channel, fiber optics cable, and/or the like deployed between the first and second housings, a wireless connection (e.g., RF connection), fiber optics cable, and/or any combination thereof. For example, the light related components of the LIDAR system 100, i.e., the projecting unit 102, the scanning unit 104, and the sensing unit 106 may be deployed and/or contained in a first housing while the processing unit 108 may be deployed and/or contained in a second housing. In such case, the processing unit 108 may communicate with the illumination unit 102, the scanning unit 104, and/or the sensing unit 106 via the communication channel(s) connecting the separate housings for controlling of the scanning unit 104 and/or for receiving from the sensing unit 106 sensory information indicative of light reflected from the scanned scene.

The LIDAR system 100 may apply one or more scanning modes, technologies, and/or techniques for scanning the FOV 120. For example, the LIDAR system 100 may apply raster (flying spot) scanning in which one or more light beams, for example, laser beams, are projected to scan the FOV 120 in one or more scan patterns, for example, scan side to side lines, scan up-down columns, and/or the like. In such case, the FOV 120 may be segmented to a plurality of segments (portions) 122 each corresponding to an instantaneous FOV scanned at any given time by the raster LIDAR system. In another example, the LIDAR system 100 may apply scan-line scanning in which one or more light beams projected by the LIDAR system 100 may form an elongated light beam, for example, a vertical line which is moved horizontally to scan the FOV 120 such that the instantaneous FOV scanned at any given time by the raster scan-line LIDAR system may comprise a vertical portion of the FOV 120. In another example, the LIDAR system 100 may apply flash scanning in which one or more light beams may be projected by the LIDAR system 100 to simultaneously illuminate the entire FOV 120 such that the instantaneous FOV scanned at any given time by the raster scan-line LIDAR system may comprise the entire FOV 120.

The LIDAR system 100 may employ one or more designs, architectures, and/or configurations, optionally depending on the scanning mode of the LIDAR system 100, for implementing optical paths, specifically an outbound optical path (transmission path TX) for transmitting light 204 emitted by the illumination unit 102 and directed towards the scene, i.e., towards the FOV 120, and an inbound optical path (reception path RX) for directing light 206 reflected from objects in the FOV 120 towards the sensing unit 106. For example, the LIDAR system 100 may employ bistatic architecture, sometimes referred to as biaxial architecture, in which the outbound light projected and exiting the LIDAR system 100 toward the scene and the inbound light reflected from the scene and entering the LIDAR system 100 pass through substantially different optical paths each comprising one or more distinct optical components, for example, a window, an aperture, a lens, a mirror, a beam splitter, and/or the like. In another example, as shown in FIG. 2, the LIDAR system 100 may employ monostatic architecture, sometimes referred to as coaxial architecture, in which the outbound light 204 and the inbound light 206 may pass thorough substantially common or similar (same) optical paths sharing some and typically most optical components. This means that the outbound light 204, directed towards the FOV 120 via the transmission optical path (TX), and the inbound light 206, directed from the FOV 120 towards one or more sensors of the LIDAR system 100 via the reception path (RX), may pass through the common optical path and thus through shared optical component(s) deployed along the shared optical path.

Optically, configuration, and/or implementation of the optical paths of the transmitted light 204 and the reflected light 206 may depend on a scanning mode of the LIDAR system 100.

The illumination unit 102 may include one or more light sources 112 configured to emit light in one or more light forms, formats, and/or modes, for example, laser light. The light source(s) 112 may include, for example, a laser diode, a solid-state laser, a high-power laser, an edge emitting laser, a Vertical-Cavity Surface-Emitting Laser (VCSEL), an External Cavity Diode Laser (ECDL), A distributed Bragg reflector (DBR) laser, a laser array, and/or the like.

The light source(s) 112 may be configured and/or operated, for example, by the processing unit 108, to emit light according to one or more light emission patterns defined by one or more light emission parameters, for example, lighting mode (e.g., pulsed, Continuous Wave (CW), quasi-CW, etc.), light format (e.g., angular dispersion, polarization, etc.), spectral range (wavelength), energy/power (e.g., average power, maximum power, power intensity, instantaneous power, etc.), timing (e.g., pulse width (duration), pulse repetition rate, pulse sequence, pulse duty cycle, etc.), and/or the like. Optionally, the projecting unit 102 may further comprise one or more optical elements associated with one or more of the light source(s) 112, for example, a lens, an aperture, a window, a light filter, a waveplate, a waveguide, a beam splitter, and/or the like for adjusting the light emitted by the light source(s) 112, or example, collimating, focusing, polarizing, and/or the like the emitted light beams.

Moreover, the illumination unit 102 may include one or more light sources 112 configured to emit a plurality of light beams, typically simultaneously, such that each of the light beams illuminates a respective portion, section, and/or segment of the instantaneous FOV, for example, a respective portion 122 scanned by the LIDAR system 100 at any given moment.

The scanning unit 104 may be configured to scan the FOV 120 and/or part thereof by illuminating FOV 120 with light emitted by the light source(s) 112 and projecting the light 204 toward the scene thus serving as a steering element on the outbound path, i.e., the transmission path TX, of the LIDAR system 100 for directing the projected light 204 towards the scene, i.e., towards the FOV 120.

The scanning unit 104 may be further used on the inbound path of the LIDAR system 100, i.e., the reception path RX, for directing the light (photons) 206 reflected from one or more objects in at least part of the FOV 120 toward the sensing unit 106. The scanning unit 104 may therefore optionally include one or more optical elements, for example, a lens, a telephoto, a prism, a waveguide and/or the like configured to direct the reflected light 206 toward the sensing unit 106.

The scanning unit 104 may include one or more optical paths for transmitting the light 204 towards the FOV 120 and for receiving the reflected light 206. These optical paths may be separate for the outbound light 205 and the inbound light 206, for example, in a bi-axial architecture, or at least partly common and shared by the outbound light 205 and the inbound light 206, for example, in a monostatic architecture.

Moreover, since the illumination unit 102 may be configured to emit a plurality of light beams, for example, a beam array, on the transmission path TX (outbound path) of the LIDAR system 100, the scanning unit 104 may be configured to project the plurality of light beams for illuminating the FOV 120 and/or part thereof. Complementary, on the reception path RX (inbound path) of the LIDAR system 100, i.e., the scanning unit 104 may be configured to direct towards the sensing unit 106 light 206 reflected from one or more objects in at least part of the FOV 120 illuminated by the plurality of light beams.

The scanning unit 104 may include one or more light deflectors 114 configured to deflect the light emitted by the light source(s) 112 for scanning the FOV 120. The light deflector(s) 114 may include one or more scanning mechanism, module, devices, and/or elements configured to cause the emitted light to deviate from its original path, for example, a mirror, a prism, a controllable lens, a mechanical mirror, a mechanical scanning polygon, an active diffraction (e.g., controllable LCD), a Risley prisms, a waveguide, a non-mechanical-electro-optical beam steering (such as made, for example, by Vescent), a polarization grating (such as offered, for example, by Boulder Non-Linear Systems), an Optical Phase Array (OPA), and/or the like.

For example, the deflector(s) 114 may comprise one or more mechanical light deflectors, for example, a scanning polygon, interchangeable designated polygon scanner, having a plurality of reflective facets, for example, three, four, five, six and/or the like configured as mirrors and/or prisms to deflect light projected onto the facet(s) of the polygon. In another example, the deflector(s) 114 may comprise one or more Micro Electro-Mechanical Systems (MEMS) mirrors configured to move by actuation of a plurality of benders connected to the mirror.

In another example, the scanning unit 104 may include one or more non-mechanical deflectors 114, for example, a non-mechanical-electro-optical beam steering element such as, for example, an OPA which does not require any moving components or internal movements for changing the deflection angles of the light but is rather controlled by steering, through phase array means, a light projection angle of the light source(s) 112 to a desired projection angle. It is noted that any discussion relating to moving or pivoting the light deflector(s) 114 is also applicable, mutatis mutandis, to controlling any type of light deflector 114 such that it changes its deflection behavior.

At any given time, i.e., at any instantaneous point in time, during each scan cycle of the FOV 120 and/or part thereof by the LIDAR system 100, the deflector(s) 114 may be positioned in a respective instantaneous position defining a respective location, position and/or orientation in space. In particular, each instantaneous position of the deflector(s) 114 may correspond to a respective instantaneous FOV, i.e., a respective portion 122 of the FOV 120. This means that while positioned in each of a plurality of instantaneous positions during each scan cycle of the FOV 120 and/or part thereof, the deflector(s) 114 may scan a respective one of the plurality of portions 122 of the FOV 120, i.e., project light 204 toward the respective portion 122 and/or direct light (photons) reflected from the respective portion 122 toward the sensing unit 106.

The scanning unit 104 may be configured and/or operated to scan the FOV 120 and/or part thereof, on the outbound path and/or on the inbound path, at one or more scales of scanning. For example, the scanning unit 104 may be configured to scan the entire FOV 120. In another example the scanning unit 104 may be configured to scan one or more ROIs which cover only part of the FOV 120, for example, 10% or 25% of the FOV 120. Optionally, the scanning unit 104 may dynamically adjust the scanning scale, i.e., the scanned area, either between different scanning cycles and/or during the same scanning cycle.

Optionally, the scanning unit 104 may further comprise one or more optical elements associated with the deflector(s) 114, for example, a lens, an aperture, a window, a light filter, a waveplate, a waveguide, a beam splitter, and/or the like for adjusting the light emitted by the light source(s) 112 and/or for adjusting the light reflected from the scene, for example, collimate the projected light 204, focus the reflected light 206, and/or the like.

For example, as seen in FIG. 2, in one or more monostatic configurations, the LIDAR system 100 may comprise one or more asymmetrical deflectors 216 configured not to deflect the projected light 204 emitted by the illumination unit 102 and deflect reflected light 206 toward the sensing unit 106. Optionally, the asymmetrical deflector 216 may be configured to prevent reflected light 206 from hitting the illumination unit 102, and to direct all the reflected light 206 toward the sensing unit 106, thereby increasing detection sensitivity. The asymmetrical deflector 216 may comprise one or more optical elements having two sides capable of deflecting a beam of light hitting it from one side in a different direction than it deflects a beam of light hitting it from the second side. The asymmetrical deflector 216 may include, for example, a polarization beam splitter. In another example, the asymmetrical deflector 216 may include an optical isolator configured to allow passage of light in only one direction. In another example, the asymmetrical deflector 216 may include a mirrored surface with an aperture in its center such that the projected light 204 emitted by one or more light sources 112 positioned behind the deflector 216 may be transmitted through the aperture in the deflector 216 towards the FOV 120 while reflected light 206 received from the FOV 120 is reflected by the mirrored surface of the deflector 216 towards the sensor(s) 116. These exemplary embodiments of the deflector 216 should not be construed as limiting as other configurations, designs and/or architectures of the deflector 216 may be known in the art or may become apparent to a person skilled in the art.

The sensing unit 106 may include one or more sensors 116 (interchangeably designated light sensors) configured to receive and sample light received from the surroundings of LIDAR system 100, specifically from the scene, i.e., the FOV 120, and generate reflection signals, interchangeably designated trace signals or trace data, indicative of light captured by the sensor(s) 116 which may include light reflected from one or more objects in the FOV 120. The sensor(s) 116 may include one or more devices, elements, and/or systems capable of measuring properties of electromagnetic waves, specifically light, for example, energy/power, intensity, frequency, phase, timing, duration, and/or the like and generate output signals indicative of the measured properties. The sensor(s) 116 may be configured and/or operated to sample incoming light according to one or more operation modes, for example, continuous sampling, periodic sampling, sampling according to one or more timing schemes, and/or sampling instructions.

The sensing unit 106 may include a sensor array comprising a plurality of sensors 116 wherein each set of one or more of the sensors 116 may correspond to a respective pixel mapping one or more portions of the FOV 120 scanned at any given moment. For example, assuming the illumination unit 102 is configured to project a plurality of light beams, each set of one or more of the plurality of sensors 116 of the sensor array may be associated with a respective one of the plurality of light beams, i.e., each sensor 116 may be configured to receive light reflected from one or more objects in the FOV 120 illuminated by its respective associated light beam. In another example, assuming the illumination unit 102 is configured to project a single elongated light beam (scan line), the light reflected by one or more objects in the FOV 120 responsive to being illuminated by the elongated light beam may be divided to a plurality of portions each directed (transmitted) to a respective one of the plurality of sensors 116.

These pixels, relating to the light sensors 116 and thus interchangeably designated sensing pixels, may typically correspond to non-overlapping regions in the FOV 120. The sensing pixels should not be confused with the FOV pixels. Rather, each FOV pixel, which may correspond to a respective portion 122, i.e., an instantaneous FOV scanned during a certain instantaneous point in time, may be mapped by one or more sensing pixels activated during the certain instantaneous point in time.

Each sensor 116 may include one or more light detectors of one or more types having differing parameters, for example, sensitivity, size, recovery time, and/or the like. The sensor(s) 116 may include a plurality of light detectors of a single type, or of multiple types selected according to their characteristics to comply with one or more detection requirements of the LIDAR system 100, for example, reliable and/or accurate detection over a span of ranges (e.g., maximum range, close range, etc.), dynamic range, temporal response, robustness against varying environmental conditions (e.g., temperature, rain, illumination, etc.), and/or the like.

For example, as seen in FIG. 1B, each sensor 116 comprising, for example, a Silicon Photomultipliers (SiPM), a non-silicon photomultipliers, and/or the like, may include one or more light detectors constructed from a plurality of detecting elements 220, for example, an Avalanche Photodiode (APD), Single Photon Avalanche Diode (SPAD), and/or the like. The plurality of detecting elements 220, each configured to cause an electric current to flow when light (photons) passes through an outer surface of the respective detecting element 220, may be disposed on a common silicon substrate for detecting photons reflected back from the FOV 120. The detecting elements 220 of each sensor 116 may be typically arranged as an array in one or more arrangements over a detection area of the sensor 116, for example, a rectangular arrangement, for example, as shown in FIG. 1B, a square arrangement, an alternating rows arrangement, and/or the like. Optionally, the detecting elements 220 may be arranged in a plurality of regions which jointly cover the detection area of the sensor 116. Each of the plurality of regions may comprise a plurality of detecting elements 220, for example, SPADs having their outputs connected together to form a common output signal of the respective region.

The processing unit 108 may include one or more processors 118, homogenous or heterogeneous, comprising one or more processing nodes and/or cores optionally arranged for parallel processing, as clusters and/or as one or more multi core processor(s). The processor(s) 118 may execute one or more software modules such as, for example, a process, a script, an application, a (device) driver, an agent, a utility, a tool, an Operating System (OS), a plug-in, an add-on, and/or the like each comprising a plurality of program instructions stored in a non-transitory medium (program store) of the LIDAR system 100 and executed by one or more processors such as the processor(s) 118. The non-transitory medium may include, for example, persistent memory (e.g., ROM, Flash, SSD, NVRAM, etc.) volatile memory (e.g., RAM component, cache, etc.) and/or the like such as the storage 234 and executed by one or more processors such as the processor(s) 232. The processor(s) 118 may optionally integrate, utilize and/or facilitate one or more hardware elements (modules), for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU), an Artificial Intelligence (AI) accelerator and/or the like. The processor(s) 118 may therefore execute one or more functional modules implemented using one or more software modules, one or more of the hardware modules and/or combination thereof.

The processor(s) 118 may therefore execute one or more functional modules to control functionality of the LIDAR system 100, for example, configuration, operation, coordination, and/or the like of one or more of the functional elements of the LIDAR system 100, for example, the illumination unit 102, the scanning unit 104, and/or the sensing unit 106. The processor 118 may communicate with the functional elements of the LIDAR system 100 via one or more channels, interconnects, and/or networks deployed in the LIDAR system 100, for example, a bus (e.g., PCIe, etc.), a switch fabric, a network, a vehicle network, and/or the like. While the processor(s) 118 may comprise multiple processors, and/or processing devices, for brevity and clarity, the processor(s) 118 are designated in the singular form hereinafter, i.e., the processor 118.

The processor 118 may control, for example, the scanning unit 104 to scan the environment of the LIDAR system 100 according to one or more scanning schemes and/or scanning parameters, for example, extent (e.g., angular extent) of the FOV 120, extent (e.g., angular extent) of one or more regions of interest (ROI) within the FOV 120, maximal range within the FOV 120, maximal range within each ROI, maximal range within each region of non-interest, resolution (e.g., vertical angular resolution, horizontal angular resolution, etc.) within the FOV 120, resolution within each ROI, resolution within each region of non-interest, scanning mode (e.g., raster, alternating pixels, etc.), scanning speed, scanning cycle timing (e.g., cycle time, frame rate), and/or the like.

In another example, the processor 118 may be configured to coordinate operation of the light source(s) 112 with movement of the deflector(s) 114 for scanning the FOV 120 and/or part thereof. In another example, the processor 118 may be configured to configure and/or operate the light source(s) 112 to project light according to one or more light emission patterns. In another example, the processor 118 may be configured to coordinate operation of the sensor(s) 116 with movement of the deflector(s) 114 to activate one or more selected sensor(s) 116 and/or pixels according to the scanned portion of the FOV 120.

In another example, the processor 118 may be configured to receive the reflection signals generated by the sensor(s) 116 which are indicative of light captured by the sensor(s) 116 which may include light reflected from the scene specifically light reflected from one or more objects in the scanned FOV 120 and/or part thereof. In another example, the processor 118 may be configured to analyze the trace signals (reflection signals) received from the sensor(s) 116 in order to detect one or more objects, conditions, and/or the like in the environment of the LIDAR system 100, specifically in the scanned FOV 120 and/or part thereof. Analyzing the trace data indicative of the reflected light 206 may include, for example, determining a ToF of the reflected light 206, based on timing of outputs of reflection signals, specifically with respect to transmission timing of projected light 204, for example, light pulses, corresponding to the respective reflected light 206. In another example, analyzing the trace data may include determining a power of the reflected light, for example, average power across an entire return pulse, and a photon distribution/signal may be determined over the return pulse period (“pulse shape”).

The processor 118 may be further configured to analyze the trace data, i.e., the reflection signals received from the sensor(s) 116 which are indicative of light received from the scene, i.e., the FOV 120 and/or part thereof including at least part of the light emitted by the LIDAR system 100 and reflected from one or more objects in the FOV 120. Based on analysis of the trace data indicative of the light reflected from one or more objects detected in the scene, i.e., in the FOV 120 and/or part thereof, the processor 118 may extract depth data relating to the scene and may derive and/or determine one or more attributes of the detected objects. Such object attributes may include, for example, a distance between the LIDAR system 100 and the detected object, a reflectivity of the detected object, a spatial location of the detected object, for example, with respect to one or more coordinate systems (e.g., Cartesian (X, Y, Z), Polar (r, θ, φ), etc.), and/or the like. Based on the trace data coupled with the scanning scheme of the scanning unit 104, i.e., the instantaneous positioning and/or orientation of the deflector 114, the processor 118 may determine the portion 122 of the FOV 120 to which the trace data relates and may map the objects detected in the scene scanned by the LIDAR system 100.

The processor 118 may combine, join, merge, fuse, and/or otherwise aggregate information, for example, depth data pertaining to different objects, and/or different features of objects detected in the scene. For example, the processor 118 may be configured to generate and/or reconstruct one or more 3D models, interchangeably designated depth maps herein, of the environment of the LIDAR system 100, i.e., of objects scanned in the scene included in the FOV 120 and/or part thereof. The data resolution associated with the depth map representation(s) of the FOV 120 which may depend on the operational parameters of the LIDAR system 100 may be defined by horizontal and/or vertical resolution, for example, 0.1°×0.1°, 0.3°×0.3°, 0.1°×0.5° of the FOV 120, and/or the like.

The processor 118 may generate depth map(s) in one or more forms, formats and/or types, for example, a point cloud model, a polygon mesh, a depth image holding depth information for each pixel of a 2D image and/or array, and/or any other type of 3D model of the scene. A point cloud model (also known a point cloud) may include a set of data points located spatially which represent the scanned scene in some coordinate system, i.e., having an identifiable locations in a space described by a coordinate system, for example, Cartesian, Polar, and/or the like. Each point in the point cloud may be a dimensionless, or a miniature cellular space whose location may be described by the point cloud model using the set of coordinates.

The point cloud may further include additional information for one or more and optionally all of its points, for example, reflectivity (e.g., energy of reflected light, etc.), color information, angle information, and/or the like. A polygon mesh or triangle mesh may include, among other data, a set of vertices, edges and faces that define the shape of one or more 3D objects (polyhedral object) detected in the scanned scene. The processor 118 may further generate a sequence of depth maps over time, i.e., a temporal sequence of depth maps, for example, each depth map in the sequence may be associated with a respective scanning cycle (frame). In another example, the processor 118 may update one or more depth maps over time based on depth data received and analyzed in each frame.

Optionally, the processor 118 may control the light projection scheme of the light emitted to the environment of the LIDAR system 100, for example, adapt, and/or adjust the light emission pattern and/or the scanning pattern, to improve mapping of the environment of the LIDAR system 100. For example, the processor 118 may control the light projection scheme to illuminate different portions 122 across the FOV 120 according to different illumination parameters in order to differentiate between light reflected from the different portions 122. In another example, the processor 118 may apply a first light projection scheme for one or more first areas in the FOV 120, for example, a ROI and a second light projection scheme for one or more other parts of the FOV 120. In another example, the processor 118 may adjust the light projection scheme between scanning cycles (frames) such that a different light projection scheme may be applied in different frames. In another example, the processor 118 may adjust the light projection scheme based on detection of reflected light, either during the same scanning cycle (e.g., the initial emission) and/or between different frames (e.g., successive frames), thus making the LIDAR system 100 extremely dynamic.

Optionally, the LIDAR system 100 may include a communication interface 214 comprising one or more wired and/or wireless communication channels and/or network links, for example, PCIe, Local Area Network (LAN), Gigabit Multimedia Serial Link (GMSL), vehicle network, InfiniBand, wireless LAN (WLAN), cellular network, and/or the like. Via the communication interface 214, the LIDAR system 100, specifically the processor 118 may transfer data and/or communicate with one or more external systems, for example, a host system 210, interchangeable designated host herein.

The host 210, which may include any computing environment comprising one or more processors 218 such as the processor 118 which may interface with the LIDAR system 100. For example, the host 210 may include one or more systems deployed and/or located in the vehicle 110 such as, for example, an ADAS, a vehicle control system, a vehicle safety system, a client device (e.g., laptop, smartphone, etc.), and/or the like. In another example, the host 210 may include one or more remote systems, for example, a security system, a surveillance system, a traffic control system, an urban modelling system, and/or other systems configured to monitor their surroundings. In another example, the host 210 may include one or more remote cloud systems, services, and/or platforms configured to collect data from vehicles 110 for one or more monitoring, analysis, and/or control applications. In another example, the host 210 may include one or more external systems, for example, a testing system, a monitoring system, a calibration system, and/or the like.

The host 210 may be configured to interact and communicate with the LIDAR system 100 for one or more purposes, operations, and/or actions, for example, configure the LIDAR system 100, control operation of the LIDAR system 100, analyze data received from the LIDAR system 100, and/or the like. For example, the host 210 may generate one or more depth maps and/or 3D models based on trace data, and/or depth data received from the LIDAR system 100. In another example, the host 210 may configure one or more operation modes, and/or parameters of the LIDAR system 100, for example, define an ROI, define an illumination pattern, define a scanning pattern, and/or the like. In another example, the host 210 may dynamically adjust in real-time one or more operation modes and/or parameters of the LIDAR system 100.

According to some embodiments disclosed herein, a LIDAR system such as the LIDAR system 100 may scan an FOV such as the FOV 120 from a plurality of different viewpoint of the FOV 120. In particular, the LIDAR system 100 may scan the FOV 120 by projecting the light 204 through a plurality of optical paths each having a respective viewpoint of the FOV 120. Each optical path utilizes a different facet of a mechanical light deflector such as the deflector 114, for example, a scanning polygon. For example, the LIDAR system may be configured to scan the FOV 120 by projecting light directed to the FOV 120 through two distinct optical paths during the same scan period wherein the light directed through the two optical paths is projected via two different reflective facets towards the FOV 120 from two sides of the scanning polygon such that the light is projected towards the FOV 120 from two different viewpoints (angle ranges).

The scan period may correspond, for example, to a time period of a line scan, i.e., the time of scanning a line, for example, a horizontal line across the horizontal extent of the FOV (hFOV) of the FOV 120 and/or part thereof. In such case, during a first time segment (potion) of the line scan time period, the LIDAR system may project light toward the FOV 120 via a first optical path utilizing a first reflective facet of the deflector 114, and during a second time segment of the line scan time period, the LIDAR system may project light toward the FOV 120 via a second optical path utilizing a second reflective facet of the deflector 114. In another example, the scan period may correspond to the time period of a scan cycle, i.e., the time of scanning the entire FOV 120 and/or part thereof. In such case, during a first time segment (potion) of the scan cycle time period, the LIDAR system may project light toward the FOV 120 via a first optical path utilizing a first reflective facet of the deflector 114, and during a second time segment of the scan cycle time period, the LIDAR system may project light toward the FOV 120 via a second optical path utilizing a second reflective facet of the deflector 114.

It should be noted that the terms “different reflective facets”, “respective reflective facet”, and similar terms used herein with respect to the optical paths and viewpoints of the FOV 120 actually refer to different positions or locations of the reflective facets on the deflector 114. These positions may be occupied by different reflective facets at different times. For example, a deflector 114 comprising a spinning polygon having a plurality of reflective facets, e.g., four reflective facets, may have two positions, specifically positions oriented outwards toward the FOV 120, from which light may be projected for effectively scanning the FOV 120. However, these effective facet positions may be occupied by different reflective facets of the scanning polygon at different times of the scan period or scan cycle. For brevity, while referring to different facet positions as described herein, these terms are simply designated different reflective facets.

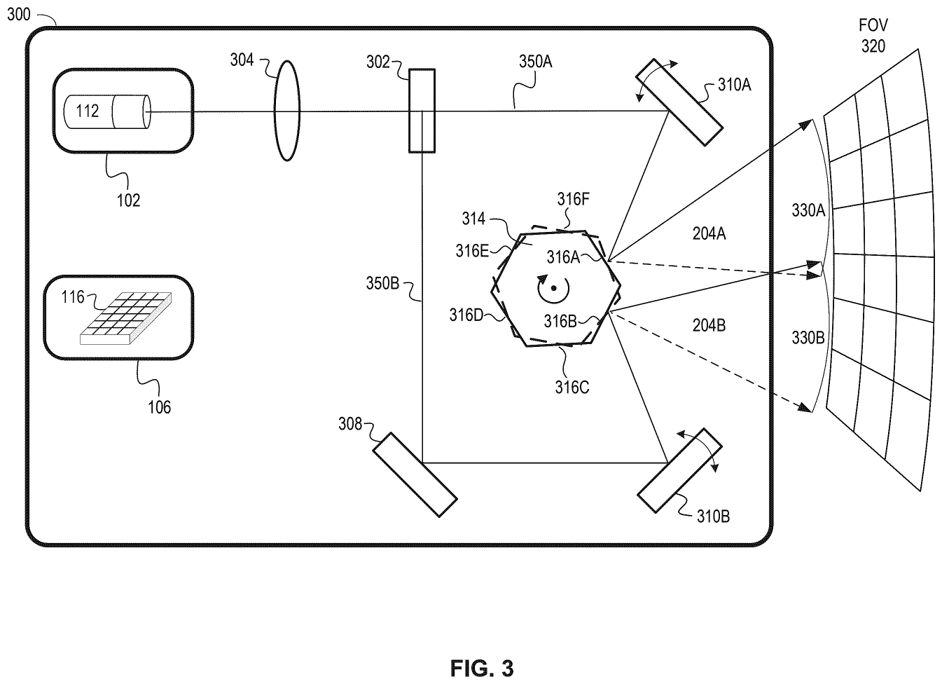

Reference is now made to FIG. 3, which is a schematic illustration of an exemplary LIDAR system configured to direct light for scanning portions of its FOV via multiple optical paths, in accordance with embodiments of the present disclosure.

FIG. 3 illustrates a schematic top view of an exemplary LIDAR system 300 such as the LIDAR system 100. The LIDAR system 300 may be mounted, for example, on a vehicle such as the vehicle 110 for scanning an FOV 320 such as the FOV 120 in order to utilize one or more detection channels for the vehicle 110, for example, a primary object detector, a short range detector, and/or the like.

The LIDAR system 300 may be configured to scan the FOV 120 by directing the projected light 204 towards the FOV 320 through a plurality of optical paths each utilizing a different reflective facet of a mechanical light deflector such as the deflector 114 scanner, for example, a scanning polygon. In particular, projected light 204 may be directed to the FOV 120 through the plurality of optical paths and via respective reflective facets of the scanning polygon during different time segments of a scan period of the FOV 120 by the LIDAR system 300, for example, a scan cycle, a partial scan cycle, and/or the like. As such, during each time segment of the scan period, projected light 204 may be directed towards the FOV 320 through a single optical path and via a single reflective facet.

The LIDAR system 300 may include an illumination unit such as the illumination unit 102 comprising one or more light sources such as the light source 112 configured to emit light, for example, one or more laser beams. The LIDAR system 300 may also include a sensing unit such as the sensing unit 106 comprising one or more light sensors such as the sensors 116 configured to receive and sample (measure) light received from the surroundings of LIDAR system 100, specifically from the scene in the FOV 320 including light reflected from one or more objects in the FOV 320 which are illuminated with the light emitted by the light source(s) 112. The sensor(s) 116 may generate reflection signals (trace signals, or trace data) indicative of light captured by the sensor(s) 116.

The LIDAR system 300 may include a light deflector such as the light deflector 114, for example, a multi-faceted scanning polygon 314 having a plurality of plurality of mirror like reflective facets 316 (e.g., 3, 4, 5, 6, etc. facets) configured to deflect light incident on the facets 316. For example, the scanning polygon 314 may be shaped as a Hexagon having six side reflective facets 316, namely 316A, 316B, 316C, 316D, 316E and 316F.

The reflective facets 316 of the scanning polygon 314 may have reflective surfaces adapted to reflect most and typically all of the light incident on the reflective surface. In particular, the reflective surfaces of the reflective facets 316 may be adapted to effectively, reliability, accurately, and durably reflect the light emitted by the light source(s) 112 which may be characterized by one or more illumination parameters, for example, wavelength and/or wavelength range, intensity (e.g., average power, maximum power, etc.), and/or the like. The reflective surfaces of the reflective facets 316 of the scanning polygon 314 may be produced, coated, and/or treated, as known in the art. For example, the reflective surfaces of one or more of the reflective facets 316 may be produced of one or more materials which highly reflect the light emitted by the light source(s) 112. In another example, the reflective surfaces of one or more of the reflective facets 316 may be coated with one or more materials, substances, and/or the like characterized by high reflectivity of light such as the light by the light source(s) 112.

The polygon 314 may be configured and/or operated, for example, by one or more processors such as the processor 118, to rotate in one or more axes for deflecting the light emitted by the light source(s) 112 and direct (project, transmit) the projected light 204 toward the FOV 320 for scanning the FOV 320 and/or part thereof. For example, the scanning polygon 314 may be rotated around an axis perpendicular to the horizontal plane of the LIDAR system 300 such that the rotating polygon 314 may deflect the projected light 204 across a horizontal extent of the FOV 320 for horizontally scanning the FOV 320 and/or part thereof. In another example, the scanning polygon 314 may be rotated around an axis parallel to the horizontal plane of the LIDAR system 300 such that the rotating polygon 314 may deflect the projected light 204 across a vertical extent of the FOV 320 for vertically scanning the FOV 320 and/or part thereof. In another example, the scanning polygon 314 may be rotated around multiple axes, for example, the axis perpendicular to the horizontal plane of the LIDAR system 300 and the axis parallel to the horizontal plane of the LIDAR system 300 and the axis such that the rotating polygon 314 may deflect the projected light 204 across both a horizontal extent and a vertical extent of the FOV 320 for horizontally and vertically scanning the FOV 320 and/or part thereof.

The LIDAR system 300 may optionally comprise one or more optical elements 304, for example, a lens, an aperture, a window, a light filter, a waveguide, a waveplate, a beam splitter, and/or the like for adjusting the light emitted by the light source(s) 112, or example, collimating, focusing, polarizing, and/or the like the emitted light beams.

The LIDAR system 300 may further include one or more optical switches 302 interposed between the light source(s) 112 and the rotatable light deflector, i.e., the scanning polygon 314. The optical switch 302 is operable to direct emitted light to different reflective facets during respective portions of a scan cycle. The optical switch(es) 302 may be configured and/or operated, for example, by one or more processors such as the processor 118, to direct the light emitted by the light source(s) 112 toward FOV 320 through a plurality of internal optical paths 350 in the LIDAR system 300 via a plurality of the reflective facets 316 of the polygon 314.

In particular, the optical switch(es) 302 may have a plurality of states, for example, two states, three states, and/or the like such that at any given moment the optical switch(es) 302 may be set in one of the plurality of states. In each state, the optical switch(es) 302 may direct the light emitted by the light source(s) 112 toward the FOV 320 through one of the optical paths 350 each utilizing one of the plurality of reflective facets 316 of the scanning polygon 314. For example, the optical switch(es) 302 may be configured and/or operated to switch between two states such that, in a first state the optical switch(es) 302 directs the emitted light towards the FOV 320 through a first optical path 350A via a first reflective facet 316A of the plurality of reflective facets 316, and in a second state the optical switch(es) 302 directs the emitted light towards the FOV 320 through a second optical path 350B via a second reflective facet 316B of the plurality of reflective facets 316.

Since at any given moment the optical switch(es) 302 may be in a single state, the processor(s) 118 may set the optical switch(es) 302 to each of its states during different segments (portions) of the scan period (e.g., line scan. Scan cycle, and/or part thereof. For example, the processor(s) 118 may set the optical switch(es) 302 to the first state during a first time segment of the scan period of the LIDAR system, the second state during a second time segment of the scan period. The first and second time segments are different from the first time segment.

This means that the light emitted from the light source(s) 112 and directed by the optical switch(es) 302 may not be simultaneously directed via multiple optical paths 350. Rather, at any given time the light emitted by the light source(s) 112 may be directed by the optical switch(es) 302 towards the FOV 320 through only one optical path 350 via only one of the reflective facets 316 of the polygon 314. For example, during the first time segment while the optical switch(es) 302 is in the first state, the emitted light may be directed to the FOV 320 through the first optical path 350A via the first reflective facet 316A for projecting light 204A to scan the FOV 320 and/or part thereof. During the second time segment while the optical switch(es) 302 is in the first state, the emitted light may be directed to the FOV 320 through the second optical path 350B via the second reflective facet 316B for projecting light 204B to scan the FOV 320 and/or part thereof.

As seen, due to rotation of the polygon 314, the projected light 204A directed through the first optical path 350A may be projected via the rotating first reflective facet 316A to scan the FOV 320 across a first horizontal extent 330A, designated horizontal FOV (hFOV), which may include at least part of the FOV 320 and optionally the entire FOV 320. Similarly, due to rotation of the polygon 314, the projected light 204B directed through the second optical path 350B may be projected via the rotating second reflective facet 316B to scan the FOV 320 across a second horizontal extent 330A (hFOV) which may include at least part of the FOV 320 and optionally the entire FOV 320.

It should be noted that the number of reflective facets 316 of the scanning polygon 314 may be typically larger than two and the scanning polygon 314 may thus comprise three or more reflective facets 316. As such, due to rotation of the polygon 314, during each scan period the polygon 314 may be positioned such that the light 204 is deflected toward the FOV 320 via respective reflective facets 316 which face the FOV 320 during the respective scan period and/or part thereof. Therefore, during each scan period a respective set of reflective facets 316 nay be used for deflecting the projected light 204. For example, for the two optical paths embodiment illustrated in FIG. 3, during each scan period a respective pair of reflective facets 316 may be selected from the three or more reflective facets 316 for deflecting the projected light 204A and 204B towards the FOV 320. For example, during a first scan period, the first and second reflective facets may comprise the reflective facets 316A and 316B, respectively. However, during a subsequent scan period, the first and second reflective facets may comprise the reflective facets 316F and 316A respectively while in a further subsequent scan period, the first and second reflective facets may comprise the reflective facets 316E and 316F respectively, and so on.

The LIDAR system 300 may further include one or more optical elements 310 interposed along the one or more optical paths 350 of the light emitted by the light source(s) 112, for example, between the optical switch(es) 302 and the scanning polygon 314. Each of the optical elements 310, for example, a mirroring element, may have a mirror surface for configuring, setting, and/or adjusting one or more of the optical paths 350. For example, an optical element 310A may be interposed in the first optical path 350A to deflect light emitted by the light source(s) 112 in the direction of the scanning polygon 314. In another example, an optical element 310B may be interposed in the second optical path 350B to deflect light emitted by the light source(s) 112 in the direction of the scanning polygon 314. In another example, another optical element, for example, a mirror 308 may be deployed along the second optical path 350B for deflecting the light emitted by the light source(s) 112 towards the optical element 310B from which the emitted light is deflected toward the polygon 314.

One or more of the optical elements 310A and 310B may include a dynamic optical element, for example, a vertical scanner configured to rotate around an axis parallel to the horizontal axis of the LIDAR system 110A and having a mirror like reflective surface for deflecting the light emitted by the light source(s) 112 across a vertical extent of the reflective facets 316 of the polygon 314 to project the light 204A and/or 204B respectively for vertically scanning the FOV 320 and/or part thereof. In another, one or more of the optical elements 310A and 310B may include a fixed mirror, for example, a folding mirror for deflecting emitted light across towards the polygon 314 or to project the light 204A and/or 204B respectively for scanning the FOV 320 and/or part thereof.

Optionally, the light source(s) 112 may be configured to emit a plurality of distributed light beams which may be directed to the FOV 320 through the plurality of optical paths 350 each utilizing a respective reflective facet 316 of the scanning polygon 314, for example, the first optical path 350A directing the emitted light towards the FOV 320 via the first reflective facet 316A, the second optical path 350B directing the emitted light towards the FOV 320 via the first reflective facet 316A, and/or the like.

The sensor(s) 116 of the LIDAR system 300 may be configured and/or operated to receive light 206 reflected from the FOV 820 illuminated and scanned by the projected light 204. As described herein before, the sensor(s) 116 may be further configured to generate signal data (reflection data, trace data,) indicative of the light collected by sensor(s) 116.

In particular, the sensor(s) 116 may be synchronized with operation and switching of the optical switch(es) 302 and thus configured and/or operated to generate signal data indicative of the reflected light 206 directed from the FOV 820 through the plurality of optical paths 350 via multiple reflective facets 316 of the scanning polygon 314 based on switching timing of the states of the optical switch(es) 302. For example, during the first time segment of the scan period, while the optical switch(es) 302 is in the first state, the sensor(s) 116 may be configured and/or operated to receive light 206A reflected from the FOV 820 scanned with light 204A directed through the first optical path 350A and projected to the FOV 320 via the first reflective facet 316A. In another example, during the second time segment of the scan period, while the optical switch(es) 302 is in the second state, the sensor(s) 116 may be configured and/or operated to receive light 206B reflected from the FOV 820 scanned with light 204B directed through the second optical path 350B and projected to the FOV 320 via the second reflective facet 316B.

This may allow distinction between light 206 reflected from the FOV 320 by one or more objects which are illuminated with projected light 204 directed to the FOV 320 through the plurality of optical paths 350 each via a respective one of the plurality of reflective facets 316. Distinguishing between reflected light corresponding to projected light 204 directed through the plurality of optical paths 350 may allow associating the signal data generated by the sensor(s) 116 with the reflected light 206 corresponding to projected light 204 directed to the FOV 320 through each optical path 350. This may be essential for achieving high performance objects detection which is done based on analysis of the signal data, for example, accuracy, reliability, consistency, and/or the like. This is since the light 204 projected via different reflective facets 316 may be directed towards respective points, portions and/or locations in the FOV 320 which depend on the selected reflective facet 16 coupled with the instantaneous position of the scanning polygon 314. The points, portions and/or locations in the FOV 320 scanned by projected light 204 via different reflective facets 316 may be therefore different.

Therefore, associating between the reflected light 206 and temporal/spatial positioning of the scanning polygon 314 which defines the direction of projection of the projected light 204 and thus the scanned points, portions and/or locations in the FOV 320 may be essential to support high performance detection which relies on such association.

The plurality of optical paths through which the projected light 204 is directed toward the FOV 320 may be each configured and/or adapted such that the projected light 204 scans at least a portion (region) of the FOV 320 which may extend from part of the FOV 320 to the entire FOV 320. As such the portions of the FOV 320 scanned by projected light 204 originating from the plurality of optical paths, for example, projected light 204A and projected light 204B, may be distinct from each other or at least partially overlapping with each other, i.e., fully overlapping with each other or partially overlapping with each other.

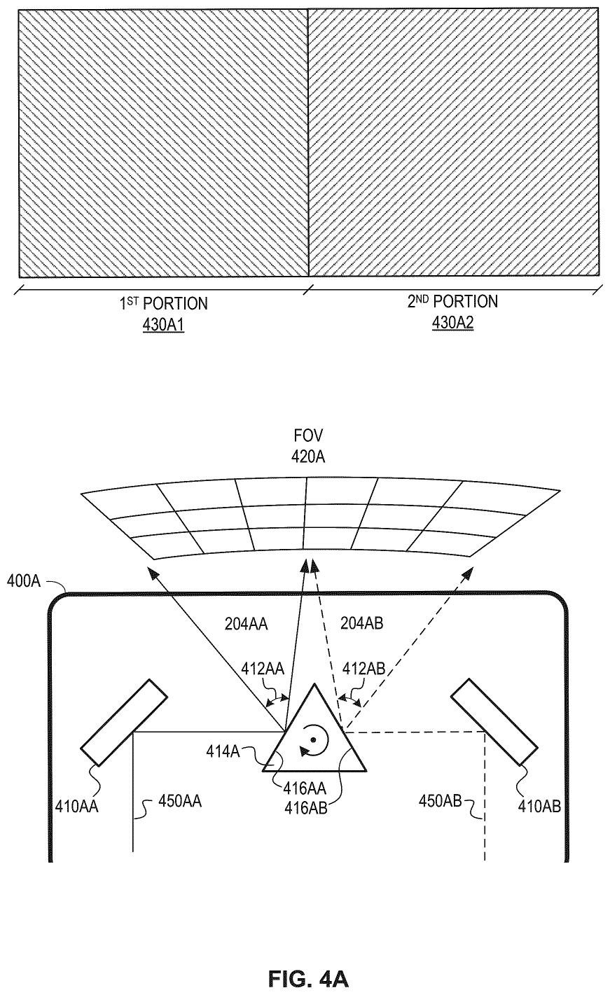

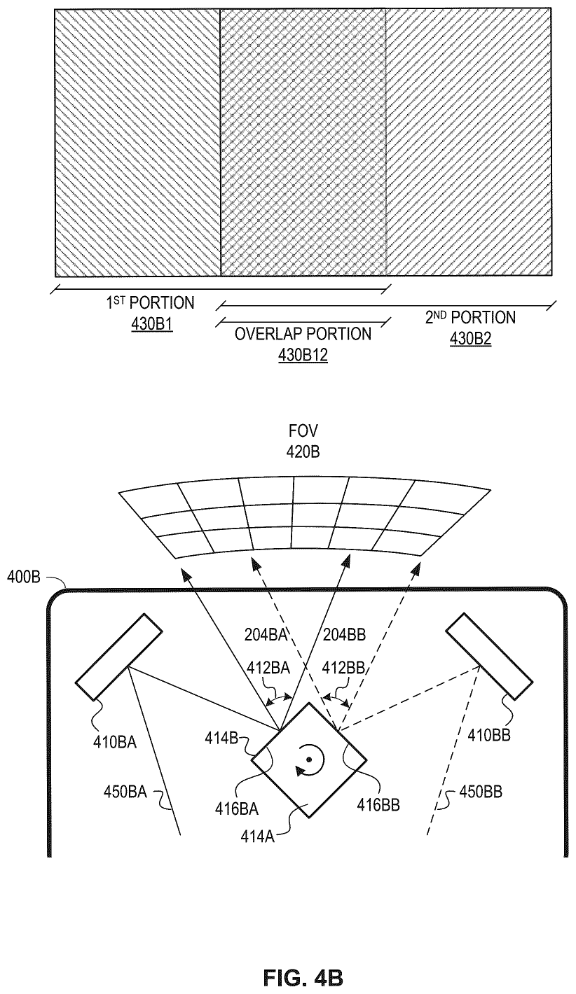

Reference is now made to FIG. 4A and FIG. 4B, which are schematic illustrations of exemplary scanning polygons of a LIDAR system configured to scan portions of its FOV via multiple optical paths, in accordance with embodiments of the present disclosure.

As seen in FIG. 4A, an exemplary light deflector such as the light deflector 114 of a LIDAR system 400A such as the LIDAR system 300, for example, a triangular scanning polygon 414A having three reflective facets 416A such as the reflective facets 316 may be configured and operated to project light 404A for scanning an FOV 420A. In particular, the FOV 420A may be scanned by projected light 404AA and 404AB directed from one or more light sources such as the light source 112 to the FOV 420A through two different optical paths 450AA and 450AB respectively via two different reflective facets 416AA and 416AB respectively of the triangular scanning polygon 414A.

One or more processors such as the processor(s) 118 may operate the triangular scanning polygon 414A, for example, coordinate its rotation such that projected light 204AA and projected light 204AB are transmitted to illuminate and scan distinct portions of the FOV 420A. For example, the processor(s) 118 may coordinate operation of optical elements in the LIDAR system 400A, for example, an optical switch such as the optical switch(es) 302, the triangular polygon 414A to direct the light emitted by the light source(s) 112 through the first optical path 450AA during a first time segment of the scan period. During this first time segment, the triangular polygon 414A may rotate and the projected light 204AA may therefore scan a first horizontal extent (hFOV) represented by angle 412AA. In another example, the processor(s) 118 may coordinate operation of the optical switch(es) 302 and/or the triangular polygon 414A to direct the light emitted by the light source(s) 112 through the second optical path 450AB during a second time segment of the scan period. During this second time segment, the triangular polygon 414A may rotate and the projected light 204AB may therefore scan a second horizontal extent (hFOV) represented by angle 412AB.

As seen, a projected FOV 430A created based on the scanned spherical FOV 420A may be constructed of two distinct portions, a first portion (region) 430A1 created based on the spherical FOV scanned by projected light 204AA, and a second portion (region) 430A2 created based on the spherical FOV scanned by projected light 204AB.

As seen in FIG. 4B, an exemplary light deflector 114 of a LIDAR system 400B such as the LIDAR system 300, for example, a square scanning polygon 414B having four reflective facets 416B such as the reflective facets 316 may be configured and operated to project light 204B for scanning an FOV 420B. In particular, the FOV 420B may be scanned by projected light 204BA and 404BB directed from one or more light sources such as the light source 112 to the FOV 420B through two different optical paths 450BA and 450BB respectively via two different reflective facets 416BA and 416BB respectively of the triangular scanning polygon 414A.

One or more processors such as the processor(s) 118 may operate the square scanning polygon 414B, for example, coordinate its rotation such that projected light 204BA and projected light 204BB are transmitted to illuminate and scan partially overlapping portions of the FOV 420B. For example, the processor(s) 118 may coordinate operation of optical elements in the LIDAR system 400B, for example, an optical switch such as the optical switch(es) 302, the square polygon 414B to direct the light emitted by the light source(s) 112 through the first optical path 450BA during a first time segment of the scan period. During this first time segment, the square polygon 414B may rotate and the projected light 204BA may therefore scan a first horizontal extent (hFOV) represented by angle 412BA. In another example, the processor(s) 118 may coordinate operation of the optical switch(es) 302 and/or the square polygon 414B to direct the light emitted by the light source(s) 112 through the second optical path 450BB during a second time segment of the scan period. During this second time segment, the square polygon 414B may rotate and the projected light 204BB may therefore scan a second horizontal extent (hFOV) represented by angle 412BB.

As seen, a projected FOV 430A created based on the scanned spherical FOV 420B may thus comprise three portions (regions), a first portion (region) 430B1 created based on the spherical FOV scanned by projected light 204BA, a second portion (region) 430B2 created based on the spherical FOV scanned by projected light 204BB, and a third portion (region) 430B12 created based on the spherical overlapping FOV scanned by both projected light 204BA and 204BB. The overlap portion 430B12, which may be scanned with increased temporal and/or spatial resolution, may correspond to a Region of Interest (ROI) in the FOV 420B, for example, an area in front of a vehicle such as the vehicle 110 on which the LIDAR system 300 is mounted.

As seen in FIG, 4A and FIG. 4B, the optical paths 450 are defined and/or adjusted using one or more optical elements 410 such as the optical element 310, in particular, a mirror elements having a reflective surface configured to reflect and/or deflect light incident on the surface of the mirror elements 410, for example, a folding mirror, a vertical scanner, and/or the like.

For example, as seen in FIG. 4A, a first mirror element 410AA may be deployed for deflecting the light emitted by the light source(s) 112 and directed through the first optical path 450AA towards the triangular scanning polygon 414A such that light 204AA may be projected towards the FOV 420A via the first reflective facet 416AA. Similarly, a second mirror element 410AB may be deployed for deflecting the light emitted by the light source(s) 112 and directed through the second optical path 450AB towards the triangular scanning polygon 414A such that light 204AB may be projected towards the FOV 420A via the second reflective facet 416AB.

For example, as seen in FIG. 4B, a first mirror element 410BA may be deployed for deflecting the light emitted by the light source(s) 112 and directed through the first optical path 450BA towards the square scanning polygon 414B such that light 204BA may be projected towards the FOV 420B via the first reflective facet 416BA. Similarly, a second mirror element 410BB may be deployed for deflecting the light emitted by the light source(s) 112 and directed through the second optical path 450BB towards the square scanning polygon 414A such that light 204BB may be projected towards the FOV 420B via the second reflective facet 416BB.

The optical elements 310, for example, the mirror elements 410 may be deployed, positioned, and/or oriented in the LIDAR system 300 according to one or more considerations, parameters, and/or properties of the LIDAR system 400, one or more of its components and/or elements, the FOV 320, and more.

For example, the first mirror element 410AA may be positioned and/or oriented to form a straight angle (90°) between the light received from the light source(s) 112 via the first optical path 450AA and the light deflected towards the triangular scanning polygon 414A. Similarly, the second mirror element 410AB may be positioned and/or oriented to form a straight angle (90°) between the light received from the light source(s) 112 via the second optical path 450AB and the light deflected towards the triangular scanning polygon 414A. This arrangement and orientation of the mirror elements 410AA and 410AB coupled with the triangle shape and structure of the triangular scanning polygon 414A may enable scanning an increased FOV 420A which may be covered by the two substantially distinct portions of the FOV 420A scanned by the projected light 204AA and 204AB directed to the FOV 420A through the two different optical paths 450AA and 450AB.

In another example, the first mirror element 410BA may be positioned and/or oriented to form a sharp angle (<90°) between the light received from the light source(s) 112 via the first optical path 450BA and the light deflected towards the square scanning polygon 414B. Similarly, the second mirror element 410BB may be positioned and/or oriented to form a sharp angle (<90°) between the light received from the light source(s) 112 via the second optical path 450BB and the light deflected towards the square scanning polygon 414B. This arrangement and orientation of the mirror elements 410BA and 410BB coupled with the square shape and structure of the square scanning polygon 414B may enable scanning the FOV 420B with overlapping portions of the FOV 420B scanned by both projected light 204BA and projected light 204BB which may provide increased spatial and/or temporal resolution of the scanned overlapping portion (region) which may be an ROI.

The optical switch 302 may be designed, constructed, and/or shaped using one or more mechanisms, techniques, technologies, and/or architectures for directing the light emitted by the light source(s) 112 towards the FOV 320 via a plurality of optical paths 350, specifically via a single respective optical path 350 at any given time. The optical switch 302 may be implemented, for example, by one or more dynamically rotatable elements having mirroring and pass-through sections. The rotatable element(s) may be interposed between the light source(s) 112 and the light deflector 114, for example, the scanning polygon 314 such that when rotated, the light directed towards the rotatable element(s) may hit a mirror section of the rotatable element during a first time segment of the scan period and be deflected towards the first optical path 350A or pass through a pass-through section of the rotatable element during a second time segment of the scan period and be directed towards the second optical path 350B.

In another example, the optical switch 302 may utilize one or more light gating elements, for example, a shutter having a mirror surface which may be dynamically open and closed at high frequency. The light gating element(s) may be interposed between the light source(s) 112 and the light deflector 114, for example, the scanning polygon 314 and operated to dynamically switch between its closed state (first state) and open state (second state). During the first time segment of the scan period, the shutter may be set in the closed state such that the light emitted by the light source(s) 112 and directed towards the shutter may hit the mirror surface of the closed shutter and be deflected towards the first optical path 350A. During the second time segment of the scan period, the shutter may be set in the open state such that the light emitted by the light source(s) 112 may pass through the open shutter towards the second optical path 350B.

In another example, the optical switch 302 may utilize one or more optical Micro-Electrical-Mechanical System (MEMS) such as, for example, a Digital Micromirror Device (DMD), and/or the like. The DMD may be dynamically switched between a plurality of orientation and/or positions at high frequencies. The DMD may be interposed between the light source(s) 112 and the light deflector 114, for example, the scanning polygon 314 and operated to dynamically switch between its orientation modes such that when set in each orientation mode, the DMD may deflect the light emitted by the light source(s) 112 towards a respective one of the plurality of optical paths 350. For example, during the first time segment, the DMD may be set in a first orientation (first state) such that the light emitted by the light source(s) 112 may be deflected towards the first optical path 350A. During the first time segment, the DMD may be set in the second orientation (second state) for deflecting the emitted by the light source(s) 112 towards the second optical path 350B.

In another example, the optical switch 302 may include one or more optical liquid crystal elements, for example, a liquid crystal lens having a laterally shiftable optical axis such that the lateral optical axis of the liquid crystal lens may be dynamically shifted between a plurality of optical axes. The liquid crystal lens may be interposed between the light source(s) 112 and the light deflector 114, for example, the scanning polygon 314 and operated to dynamically switch between a plurality of lateral axes such that when shifted to each lateral axis, the liquid crystal lens may direct the light emitted by the light source(s) 112 towards a respective one of the plurality of optical paths 350. For example, during the first time segment, the liquid crystal lens may be shifted to a first lateral axis such that the light emitted by the light source(s) 112 may be traversed towards the first optical path 350A while in a second orientation second state) the light source(s) 112 may be deflected towards the second optical path 350B.

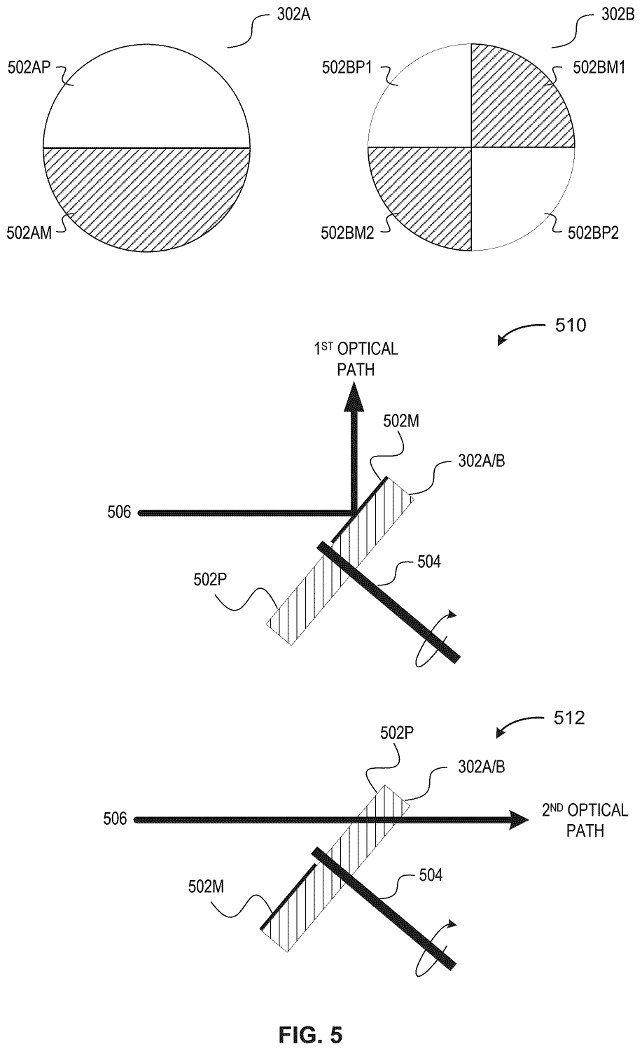

Reference is now made to FIG. 5, which is a schematic illustration of an exemplary optical switch deployed in a LIDAR system for directing light via multiple optical paths for scanning an FOV of the LIDAR system, in accordance with embodiments of the present disclosure.

Exemplary optical switches 302A and 302B such as the optical switch 302 may be interposed in a LIDAR system such as the LIDAR system 300 for directing the light emitted by the light source(s) 112 towards the FOV 320 via a plurality of reflective facets of a light deflector such as the light deflector 114, for example, the plurality of reflective facets 316 of the rotatable scanning polygon 314. In particular, the optical switches 302A and 302B each having a plurality of states may be operated by one or more processors such as the processor(s) 118 to switch between the states such that in each state, the optical switch 302A may direct the light emitted by the light source(s) 112 towards the FOV 320 through a plurality of distinct optical paths each utilizing a respective reflective facet 316 of the scanning polygon 314.

The optical switches 302A and 302B (which may also be designated chopper) may comprise a rotatable element having a circular shape, for example, which comprises one or more one mirror sections 502M and one or more pass-through sections 502P. For example, the optical switch 302A may comprise a single mirror section 502AM and a single pass-through section 502AP, while the optical switch 302B may comprise two mirror sections 502BM1 and 502BM2 opposite each other and two pass-through sections 502BP1 and 502BP2 also opposite each other. The mirror sections 502M may be configured to reflect and/or deflect light incident on the surface of the mirror 502M and may be therefore produced of and/or coated with of one or more materials, as known in the art, which highly reflect light, in particular the light emitted by the light source(s) 112 which may be characterized by one or more illumination parameters (e.g., wavelength, intensity, etc.). The pass-through sections 502P may be configured to pass light transmitted via the pass-through section 502P and may comprise an aperture (e.g., hole, slit, gap, opening, etc.) and/or a window transparent to light, specifically the light emitted by the light source(s) 112 which may be characterized by the one or more illumination parameters

As described herein before, the rotatable element of the optical switches 302A and 302B may be switched, specifically rotated around a shaft 504, between states. As seen in 510, in a first state of the optical switch 302A or the optical switch 302B, a mirror section 502M may be positioned in a path of light 506 emitted by the light source(s) 112. As such, the emitted light 506 may be deflected by the mirror section 502M toward the FOV 320 through a first optical path such as the optical path 350A via a first reflective facet 316 of the scanning polygon 314. As seen in 512, in a second state of the optical switch 302A or the optical switch 302B, a pass-through section 502P may be positioned in the path of the emitted light 506 which may pass through the pass-through section 502P toward the FOV 320 through a second optical path such as the optical path 350B via a second reflective facet 316 of the scanning polygon 314.

It should be noted that while the optical switch 302A may be rotated between two states corresponding to the two sections 502AM and 502AP, the optical switch 302B may be rotated between four states, state one, state two, state three, and state four corresponding to the four sections 502BM1, 502BP1, 502BM2 and 502BP2. In states one and three, for example, the mirror sections 502BM1 and 502BM2 respectively may be positioned in the path of the emitted light 506. In state one the emitted light 506 may be deflected by the mirror section 502BM1 toward the FOV 320 through the first optical path 350A via a first reflective facet 316 while in state three the emitted light 506 may be deflected by the mirror section 502BM1 toward the FOV 320 also through the first optical path 350A but optionally via another reflective facet 316 which is different from the first reflective facet 316. Complementary, in states two and four, the pass-through sections 502BP1 and 502BP2 respectively may be positioned in the path of the emitted light 506. In state two the emitted light 506 may pass through the pass-through section 502BP1 toward the FOV 320 through the second optical path 350B via a second reflective facet 316 while in state four the emitted light 506 may pass through the pass-through section 502BP1 toward the FOV 320 also through the second optical path 350B but optionally via another reflective facet 316 which is different from the second reflective facet 316.

In order to efficiently scan the FOV 320, the processor(s) 118 may operate, coordinate and/or synchronize operation of one or more optical elements of the LIDAR system 300, for example, the optical switch(es) 302, the light deflector 114, specifically the rotating scanning polygon 314, the vertical scanner 310A, and/or the like.

For example, the processor(s) may be configured to synchronize operation of the optical switch(es) 302 between states with rotation of the rotatable light deflector, i.e., the scanning polygon 314 such that the projected light 204 directed to the FOV 204 through multiple optical paths 350 via different reflective facets 316 may effectively scan the FOV 320, for example, the projected light 204A may effectively scan the portion 330A of the FOV 320, and the projected light 204B may effectively scan the portion 330B of the FOV 320. To this end, the processor(s) 118 may switch the optical switch(es) 302 to the first state during the first time segment of the scan period during which the scanning polygon 314 rotates between positions in which the first reflective facet 316A is positioned to deflect the projected light 204A across the horizontal extent 330A. Similarly, the processor(s) 118 may switch the optical switch(es) 302 to the second state during the second time segment of the scan period during which the scanning polygon 314 rotates between positions in which the second reflective facet 316B is positioned to deflect the projected light 204B across the portion 330B.

In particular, the processor(s) may synchronize switching of the optical switch 302 between states with rotation of the scanning polygon 314 based on a number reflective facets 316 of the scanning polygon 314 and a number of the states of the optical switch 302. For example, assuming the optical switch has 2 states, and the scanning polygon has 6 reflective facets 316, a complete cycle of pairs of a respective state and a corresponding reflective facet 316 may include 12 distinct time segments corresponding to 12 distinct state-facet pairs. In another example, assuming the optical switch has 4 states, and the scanning polygon has 5 reflective facets 316, a complete cycle of pairs of a respective state and a corresponding reflective facet 316 may include 20 distinct time segments corresponding to 20 distinct state-facet pairs.

In another example, the processor(s) 118 may coordinate switching of the optical switch(es) 302 with operation of the light source(s) 112 and/or one or more optical elements disposed along the optical path between the optical switch(es) 302 and the optical switch(es) 302 in order to prevent transmission of the light emitted by the light source(s) 112 towards the optical switch(es) 302 during a transition time period during which the optical switch(es) 302 transitions between states. For example, the processor(s) 118 may turn OFF the light source(s) 112 during the transition time period of the optical switch(es) 302. In another example, the processor(s) 118 may operate one or more optical elements 302 interposed between the light source(s) 112 and the optical switch(es) 302, for example, a shutter to block light passing through the shutter and towards the optical switch(es) 302 during the transition time period.

Preventing transmission of light through the optical switch(es) 302 during the transition time period may prevent simultaneous transmission of light through multiple optical paths via multiple reflective facets 316 of the scanning polygon 314 which may reduce detection performance of the LIDAR system 300 due to false interpretation of light reflected from the FOV 320 in response to illumination from multiple projection paths.

The processor(s) 118 may further coordinate rotation of the scanning polygon 314 with switching of the optical switch(es) 302 and optionally with the light source(s) 112 to effectively utilize sections of the reflective facets 316 for deflecting the projected light 204 to efficiently scan the FOV 120 and/or part thereof. For example, the processor(s) 118 may control, coordinate, and/or synchronize operation of the scanning polygon 314, the optical switch(es) 302 and optionally with the light source(s) 112 to avoid or at least reduce projection of the light emitted by the light source(s) 112 on a corner of the scanning polygon 314 since such projection may result in at leas some of the light deflected away from the FOV 320 thus reducing the amount of projected light 204 deflected towards the FOV 320. Reduced projected light 204 may significantly reduce detection performance of the LIDAR system 300, for example, reduced range, reduced accuracy, reduced reliability, and/or the like. In addition, the light deflected away from the FOV 320 may yield stray light which may be captured by one or more of the sensors 116 of the LIDAR system 300 which may output signal data that may be falsely interpreted as relating to objects and/or targets in the FOV 320.

In another example, the processor(s) 118 may control, coordinate, and/or synchronize operation of the scanning polygon 314, the optical switch(es) 302 and optionally the light source(s) 112 to project the light emitted by the light source(s) 112 such that an incidence angle of the light on each reflective facet 316 of the scanning polygon 314 does not exceed a certain angle with respect to a projection of a normal to the respective reflective facet 316 on a plane perpendicular to a rotation axis of the rotatable scanning polygon 314. In particular, the processor(s) 118 may control, coordinate, and/or synchronize operation of the scanning polygon 314, the optical switch(es) 302 and optionally with the light source(s) 112 such that the absolute value of the angle of incidence of the light on each reflective facet 316 with respect to the projection of the normal on the plane perpendicular to the rotation axis of the scanning polygon 314 may be smaller than a certain threshold angle, for example, 60°, 75°, 90°, and/or the like.

For example, the processor(s) 118 may control operation of the scanning polygon 314, the optical switch(es) 302 and optionally the light source(s) 112 such that the absolute value of the angle of incidence of the light on the first reflective facet 316A with respect to the projection of the normal on the plane perpendicular to the rotation axis of the scanning polygon 314 may be smaller than the certain threshold angle and the absolute value of the angle of incidence of the light on the second reflective facet 316A with respect to the projection of the normal on the plane perpendicular to the rotation axis of the scanning polygon 314 may be smaller than a certain threshold angle.

Limiting the angle of incidence may prevent excessive grazing incidence angles which decrease detection performance of the LIDAR system 300 since grazing angles may reduce efficiency and/or effectivity of light projection due to the fact that at such angles, the beam (spot, or beam cross section) of light emitted by the light source(s) 112 may be smeared and/or overspread on the reflective surface of the reflective facets 316A and may be thus at least partially diffused when projected towards the FOV 320 which may induce distortions in the projected light (excessive angles).

The processor(s) 118 may control, coordinate, and/or synchronize operation of the scanning polygon 314, the optical switch(es) 302 and optionally the light source(s) 112 according to the time segments of the scan period, for example, the first time segment and/or the second time segment, defined for each optical path and thus for each reflective fact 316 which may be predefined, adapted, and/or adjusted to effectively utilize the sections of the reflective facets 316 and avoid or at least reduce projection of light on corners of the scanning polygon 314.

Optionally, the time segments of the scan period, for example, the first time segment and/or the second time segment, may be defined, adapted, and/or adjusted according to a size of a cross section of a beam of the emitted light 606, a length of each reflecting facet 316, and optionally a rotation speed of the scanning polygon 314. In particular, the switching timing for the optical switch(es) 320, i.e., the time segments of the scan period may be defined to avoid or at least reduce excessive grazing angles and/or projection of light on corners of the scanning polygon 314. For example, assuming the emitted light 606 has a large cross section, the switching timing defining the time segments o the scan period may be set to reduce duration of each time segment in attempt to increase a distance of the light beam from corners of the reflective facets 316 to prevent the large beam from hitting a corner of the scanning polygon 314, and/or reduce the incidence angles since large cross section beams may have increased beam dispersion at high grazing angles. In another example, assuming the emitted light 606 has a small cross section, the switching timing defining the time segments o the scan period may be set to increase duration of each time segment in order to increase the FOV 620 for example since the distance of the light beam from corners of the reflective facets 316 may be increased due to the smaller cross section of the light beam and typically smaller dispersion at high grazing angles.

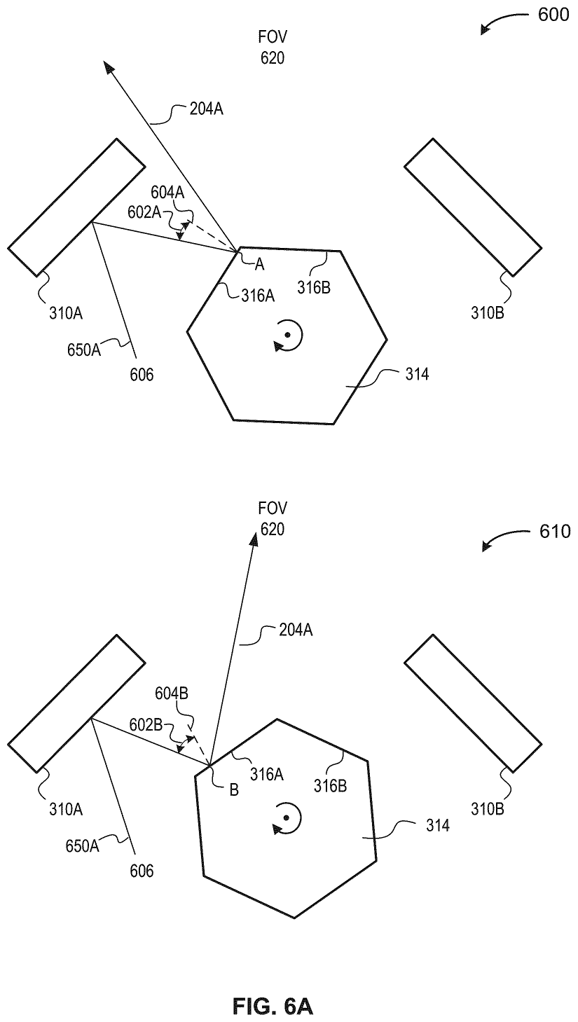

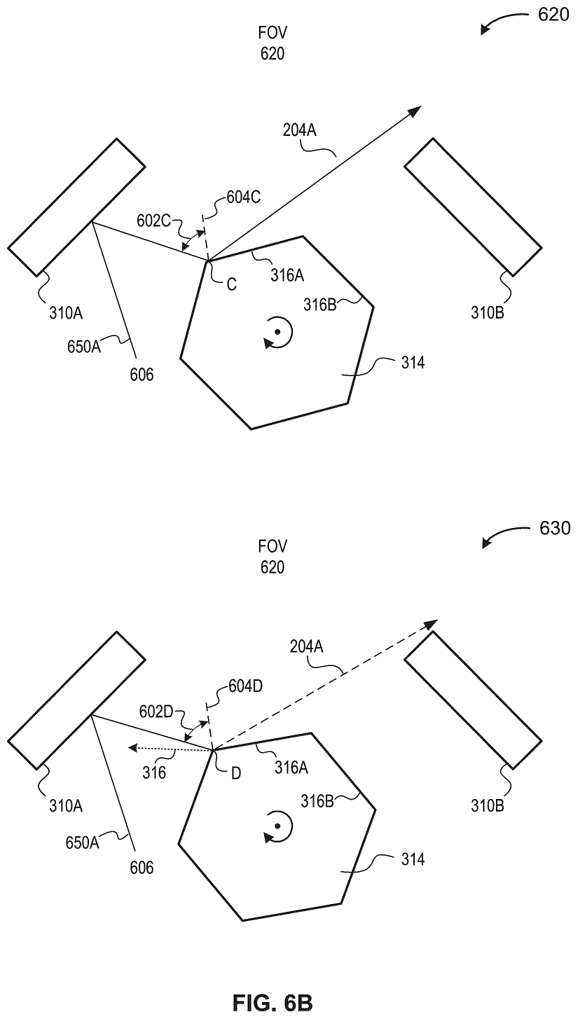

Reference is now made to FIG. 6A and FIG. 6B, which are schematic illustrations of instantaneous positions of an exemplary scanning polygon of a LIDAR system having reflective facets for directing light to a FOV of the LIDAR system, in accordance with embodiments of the present disclosure.

Illustrations 600, 610, 620, and 630 show an exemplary rotatable light deflector such as the rotatable light deflector 114, for example, a rotatable scanning polygon such as the scanning polygon 314 of a LIDAR system such as the LIDAR system 300 which is operated by one or more processors such as the processor(s) 118 to deflect 606 light emitted by one or more light sources such as the light source 112 and direct projected light such as the projected light 204 towards an FOV such as the FOV 320. As seen, one or more optical elements such as the optical element 310, for example, a folding mirror, a vertical scanner, and/or the like may be deployed along each optical path 650 such as the optical paths 360 for directing the light 606 towards the reflective facets 316.

Specifically, illustrations 600, 610, 620, and 630 depict various instantaneous positions of the scanning polygon 314 and the angle of deflection (transmission, projection) of the projected light 204 towards the FOV 320 which may be defined by an incidence angle 602 of the light 606 on a reflective facet 316 with respect to a projection of a normal 604 to the respective reflective facet 316 on a plane perpendicular to a rotation axis of the rotatable scanning polygon 314.

For brevity, illustrations 600, 610, 620, and 630 relate to deflection of light directed to the FOV 320 through only one of the optical paths, for example, an optical path 650A such as the optical path 350A via one of the reflective facets 316 of scanning polygon 314, for example, the first reflective facet 316A. It should be understood that the exact same working principles, modes, and/or concepts apply to deflection of light directed to the FOV 320 through one or more other optical paths, for example, an optical path such as the optical path 350B via one or more other reflective facets 316 of scanning polygon 314, for example, the second reflective facet 316B.

As seen in illustration 600, at an exemplary first time instance the scanning polygon 314 is positioned in a first instantaneous position such that the light 606 directed through the first optical path 650A and deflected from the optical element 310A hits (incident) the first reflective facet 316A at point A at an angle 602A with respect to the normal 604A. Since the reflection angle of light equals the incidence angle, and the incidence angle 602A is significantly sharp, the projected light 204A may be deflected towards the FOV 620 at a sharp angle.

As seen in illustration 610, at an exemplary second time instance the scanning polygon 314 is positioned in a second instantaneous position such that the light 606 directed through the first optical path 650A and deflected from the optical element 310A hits the first reflective facet 316A at point B at an angle 602B with respect to the normal 604B. Again, as the reflection angle of the projected light 204A equals the incidence angle of light 606 on the first reflective facet 316A which is increased with respect to the angle 602A, the projected light 204A may be deflected towards the FOV 620 at a less sharp angle compared to the first instantaneous position.

As seen in illustration 620, at an exemplary third time instance the scanning polygon 314 is positioned in a third instantaneous position such that the light 606 directed through the first optical path 650A and deflected from the optical element 310A hits the first reflective facet 316A at point C at an angle 602C with respect to the normal 604C. As evident, the angle 602C is significantly large and may be considered a high grazing angle.

As seen in illustration 630, at an exemplary fourth time instance the scanning polygon 314 is positioned in a fourth instantaneous position such that the light 606 directed through the first optical path 650A and deflected from the optical element 310A hits the first reflective facet 316A at point D, which is a corner of the scanning polygon 314, at an angle 602D with respect to the normal 604C. As seen, since the light 606 hits the corner of the scanning polygon 314, some of the light 606 (marked with a dashed line) may be projected as light 204A towards the FOV 620 while another part of the light 606 (marked with a dotted line) may be deflected away from the FOV 620.

As discussed herein before, in order to increase detection performance of the LIDAR system 300 by reducing grazing angles and avoiding corners of the polygon 314, the processor(s) 118 and/or the time segments defining switching of the optical switch(es) 302 may be configured to direct light towards the FOV 620 during a time period between the first and second time instants such that the emitted light 606 may hit the first reflective facet 316A at a section between point A and B while preventing the emitted light 606 from hitting the first reflective facet 316A at larger angles, such as, for example, at point C and D.

As described herein before with respect to the LIDAR system 100, the LIDAR system 300 may comprise one or more processors such as the processor 118 and may optionally communicate with one or more hosts such as the host 210 comprising one or more processors such as the processor 218. The processor(s) 118 and/or the processor(s) 218, collectively designated mapping processor(s) herein after, may each individually, and/or separately, jointly, and/or in distributed computing, map the environment of the LIDAR system 300.

Specifically, the mapping processor(s) may map, for example, detect, classify, characterize, and/or the like one or more objects detected in a scene in the FOV 320 based on analysis of the signal data generated by the sensor(s) 116 which is indicative of the light 206 reflected from objects in the FOV 320 scanned with projected light 204 directed towards the FOV 320 through the plurality of optical paths 350 via multiple reflective facets 316 of the scanning polygon 314. For example, the mapping processor(s) may generate one or more 3D models, and/or depth maps representing the FOV 320 and/or part thereof, for example, a point cloud model, a polygon mesh, a depth image holding depth information for each pixel of a 2D image and/or array, and/or the like.

Since during each scan period (e.g., scan cycle) the FOV 320 and/or part thereof is scanned by projected light 204 directed towards the FOV 320 through a plurality of different optical paths each via a respective reflective facet 316 of the scanning polygon 314, a significantly increased time portion of the scan period may be utilized. This is since at each time segment of the scan period, the light 204 may be directed towards the FOV 320 via a most efficient reflective facet 316 which is best positioned with respect to the FOV 320 and thus more efficiently scan the FOV 320 for an increased portion of the scan cycle. For example, assuming the during the first time segment of the scan period, the first reflective facet 316A is oriented with respect to the FOV 320 to efficiently scan the at least part of the FOV 320 while during the second time segment of the scan period, the second reflective facet 316B is oriented with respect to the FOV 320 to efficiently scan the at least part of the FOV 320 which may be at least partially overlapping with the part of the FOV 320 scanned during the first time segment or a distinct part of the FOV 320. In such case, the mapping processor(s) may operate the optical switch(es) 302 to switch between states in synchronization with the scanning polygon 314 such that during the first time segment the light emitted by the light source(s) 112 may be directed towards the FOV 320 through the first optical path 350A via the first reflective facet 316A while during the second time segment the light emitted by the light source(s) 112 may be directed towards the FOV 320 through the second optical path 350B via the first reflective facet 316B.

As described herein before, the sensor(s) 116 may be configured to receive light 306 reflected from the FOV 320 responsive to illuminating (scanning) the FOV 320 with projected light 204 directed towards the FOV 320 through the plurality of optical paths 350 and generate signal data accordingly. For example, during the first time segment the sensor(s) 116 receive a first reflected light 306A reflected from the FOV 320 in response to projected light 204A and generate a first signal data indicative of this first reflected light. During the second time segment the sensor(s) 116 may receive a second reflected light 306B reflected from the FOV 320 in response to projected light 204B and generate a second signal data indicative of this second reflected light.

Evidently, since utilization of the scan period is significantly increased, the volume of signal data indicative of the light reflected responsive to illuminating (scanning) the FOV 320 with projected light 204 directed towards the FOV 320 through the plurality of optical paths 350 and generate signal data accordingly during the increased utilization scan period may be also significantly increased, for example, by aggregating the first signal data and the second signal data.

The mapping processor(s) may associate the signal data received from the sensor(s) 116 with the light 206 reflected from the FOV 320 responsive to projection of light 204 through the plurality of optical paths via the plurality of reflective facets 316. In particular, the mapping processor(s) may make this association based on the timing of switching the optical switch(es) 320 between states. For example, the mapping processor(s) may associate a first signal data generated by the sensor(s) 116 during the first time segment of the scan period with light reflected from the FOV 320 in response to light 204 projected to the FOV 320 via the first reflective facet 316A. In another example, the mapping processor(s) may associate a second signal data generated by the sensor(s) 116 during the second time segment of the scan period with light reflected from the FOV 320 in response to light 204 projected to the FOV 320 via the second reflective facet 316A.

Moreover, the mapping processor(s) may be optionally configured to operate one or more of the sensor(s) 116 only during the time segments during which the optical switch(es) 302 are set in its states, for example, the first state, the second state, and/or the like while disabling the sensor(s) 116 during transition of the optical switch(es) 320 between states.

The mapping processor(s) may therefore produce increased pixel data based on the increased aggregated signal data indicative of the light 306 reflected from the FOV in response to projecting the light 204 via the plurality of reflective facets 316, for example, the first reflective facet 316A and via the second reflective facet 316B during the same scan period. The increased pixel data may express and or represent an increased vertical and/or horizontal resolution, an increased vertical and/or horizontal extent, and/or the like. The mapping processor(s) may further use the increased pixels data to improve mapping of the FOV 320 and/or part thereof, for example, generate a point cloud having, for example, an increased vertical and/or horizontal resolution, an increased vertical and/or horizontal extent (i.e., increased spherical extent), an/do the like.

Optionally, the mapping processor(s) may be configured to produce the aggregated signal data by aggregating signal data indicative of light 206 reflected from the FOV in response to light 204 projected towards the FOV 320 via reflective facets 316 of the rotatable light deflector, for example, the scanning polygon 314 with incident angles, with respect to the projection of the normal to the respective reflective facet 316 on the plane perpendicular to the rotation axis of the scanning polygon 314, having an absolute value smaller than the certain threshold angle.

For example, the mapping processor(s) may aggregate first signal data indicative of light 306 reflected from the FOV 320 in response to the light 204A projected towards the FOV 320 via the first reflective facet 316A and light 204B projected towards the FOV 320 via the second reflective facet 316B. In particular, the mapping processor(s) may use light 306 reflected from the FOV 320 in response to the projected light 204A having incidence angles, with respect to the projection of the normal to the first reflective facet 316A on the plane perpendicular to the rotation axis of the scanning polygon 314 which have absolute values smaller than the certain threshold angle. Similarly, the mapping processor(s) may use light 306 reflected from the FOV 320 in response to the projected light 204B having incidence angles, with respect to the projection of the normal to the second reflective facet 316B on the plane perpendicular to the rotation axis of the scanning polygon 314 which have absolute values smaller than the certain threshold angle.

This means that the aggregated signal data may comprise only signal data indicative of reflected light 206 corresponding to projected light 204 which hits a respective reflective facet 316 at incidence angles having an absolute value smaller than the threshold angle. As such, the signal data may exclude data indicative of light 306 reflected from the FOV 320 in response to projection of light 204 having excessive grazing angles with the reflective facets 316 and/or hitting corners of the scanning polygon thus increasing detection performance of the LIDAR system 300.

Optionally, in order to reduce a size and/or form factor of the optical switch(es) 302, one or more optical elements, for example, a lens, a prism, a waveguide, and/or the like may be interposed between the light source(s) 112 and the optical switch(es) 320 in order to focus the light received from the light source(s) 112 so that the received light may be directed towards a reduced size and smaller form factor optical switch(es) 302. One or more other optical elements, for example, a lens, a prism, a waveguide, and/or the like may be deployed on the other side of the optical switch(es) 302, i.e., interposed between the optical switch(es) 320 and the scanning polygon 314 in order to de-focus, for example, collimate the focused light received from the optical switch(es) 302 and direct collimated light towards the scanning polygon 314.

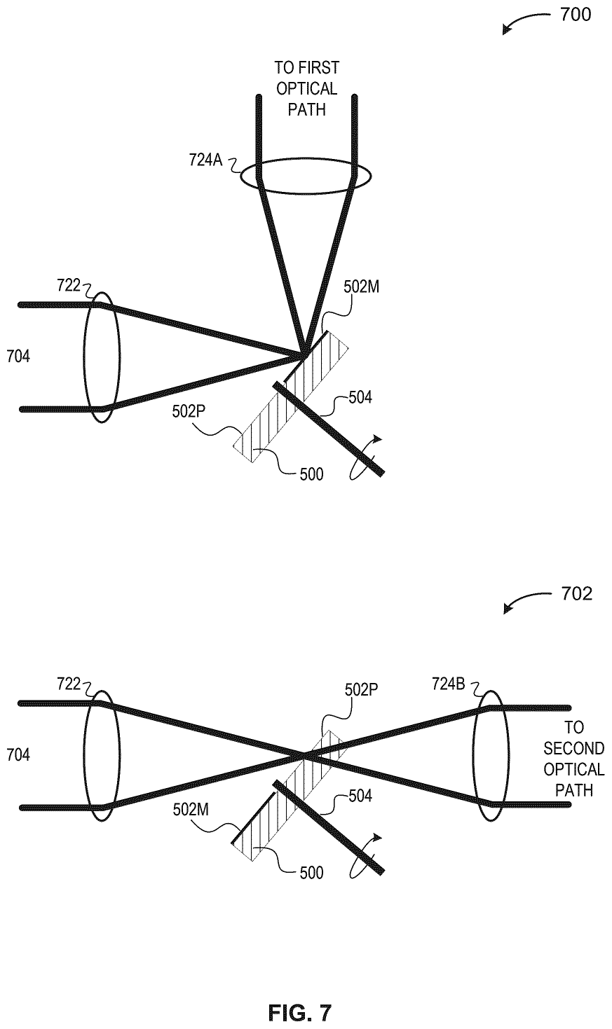

Reference is now made to FIG. 7, which is a schematic illustration of optical elements deployed to direct light through an exemplary optical switch of a LIDAR system configured for directing light via multiple optical paths for scanning an FOV of the LIDAR system, in accordance with embodiments of the present disclosure.

An exemplary optical switch such as the optical switch 500 may be deployed in a LIDAR system such as the LIDAR system 300 for directing light emitted by one or more light sources such as the light source 112 towards an FOV such as the FOV 320 through a plurality of different optical paths each utilizing a respective one of a plurality of reflective facets of a rotatable light deflector such as the light deflector 114, for example, a scanning polygon such as the scanning polygon 314.

As described herein before, the optical switch 500 may comprise a rotatable element having one or more mirror section such as the mirror section 502M and one or more pass-through sections such as the pass-through section 502P. When rotated around a shaft such as the shaft 504, the mirror section(s) 502M may deflect the light 704 received from the light source(s) 112 (not shown) towards the scanning polygon 314 (not shown) via a first optical path such as the first optical path 350A while the pass-through section(s) 502P may pass the light 704 received from the light source(s) 112 towards the scanning polygon 314 via a second optical path such as the second optical path 350B.

As seen in illustrations 700 and 702, one or more first lenses 722 may be interposed between the light source(s) 112 and the optical switch 500. The first lens(s) 722 may be configured to focus the emitted light 704 transmitted towards the optical switch 500. According to some embodiments, the first lens(s) 722 may be deployed, positioned and/or oriented such that the optical switch 500 may be placed at the focal plane of the first lens(s) 722. However, in some embodiments, the optical switch 500 may not be placed in the focal plane of the first lens(s) 722 but rather shifted towards or away from the first lens(s) 722 such that the light directed through the first lens(s) 722 towards the optical switch 500 is de-focused at the optical switch 500. This may be done to prevent focusing extreme light energy on the surface of the optical switch 500, for example, the mirror section(s) 502M and thus reduce parasitic light (e.g., stray light) within the LIDAR system 300 due to light deflected by the mirror section(s) 502M away from the designated optical path, for example, the first optical path 350A.

On the other side of the optical switch 500 one or more second lenses 724 may be interposed between the optical switch 500 and the rotatable deflector 114, specifically the scanning polygon 314 for de-focusing and/or collimating the focused light received from the optical switch 500. For example, as seen in illustration 700, one or more second lenses 724A may be interposed between the optical switch 500 and the scanning polygon 314 for de-focusing and/or collimating the focused light which is directed towards the scanning polygon 314 via the first optical path 350A. In another example, as seen in illustration 702, one or more second lenses 724B may be interposed between the optical switch 500 and the scanning polygon 314 for de-focusing and/or collimating the focused light which is directed towards the scanning polygon 314 via the second optical path 350B.

The second lens(s) 724 may be deployed, positioned and/or oriented to such that the focal plane of the second lens(s) 724 may coincide with the focal plane of the first lens(s) in order to effectively de-focus and/or collimate the light focused by the first lens(s) 722.

While illustrated with respect to the projected light 704, the optical elements 722 and 724 may also adjust the light received from the FOV via the first and second optical paths before and after the received light is received from the two optical paths and directed through the optical switch 500 towards one or more sensors such as the sensor 116 (not shown). Specifically, the optical elements 722 and 724 may adjust the received light in a similar manner to the adjustment applied to the projected light 704 in a reverse path.

Reference is made once again to FIG. 3.

The optical path of light received from the FOV 320 including light reflected from one or more objects in the FOV 320 illuminated with the projected light 204 may be implemented using one or more architectures, and/or techniques.

For example, the LIDAR system 300 may utilize a bistatic (biaxial) architecture in which the optical path of the light received from the scene, i.e., received from the FOV 320 (inbound path), may be substantially distinct from the optical path of the light 204 projected to illuminate and scan the FOV 320 (outbound path). This means that in biaxial architectures and deployments, the inbound path and outbound path may not share optical elements, and the light received from the FOV 320 may be directed through the LIDAR system 300 towards the sensor(s) 116 via one or more optical elements different from the optical element(s) used for directing the light emitted by the light source(s) 112 through the LIDAR system 300 towards the FOV 320. In one exemplary biaxial implementation of the LIDAR system 300, the sensing unit 106 may include an array, for example, a 2D array of sensors 116 disposed and configured to receive light from the FOV 320, optionally via one or more optical elements such as, for example, a lens, a prism, a waveguide, and/or the like. In another exemplary biaxial implementation of the LIDAR system 300, the light received from the FOV 320 may be received through the rotatable light deflector, for example, the scanning polygon 314 which is also used for transmitting the projected light 204 but is directed to the sensor(s) 116 via an optical path different from the optical path of the light emitted from the light source(s) 112 and projected to scan the FOV 320. It should be noted that the description is not limited to the exemplary bistatic (biaxial) implementations described herein and may include other biaxial implementations which may become apparent to a person skilled in the art.

According to some embodiments disclosed herein, the LIDAR system 300 may utilize a monostatic architecture in which the inbound optical path and the outbound optical path may utilize a substantially common or similar (same) optical path sharing some optical components deployed on the common path. This means that the light received from the FOV 320 is directed towards the sensor(s) 116 through substantially the same optical paths used for directing the light 204 projected to scan the FOV 320 from the light source(s) 112.

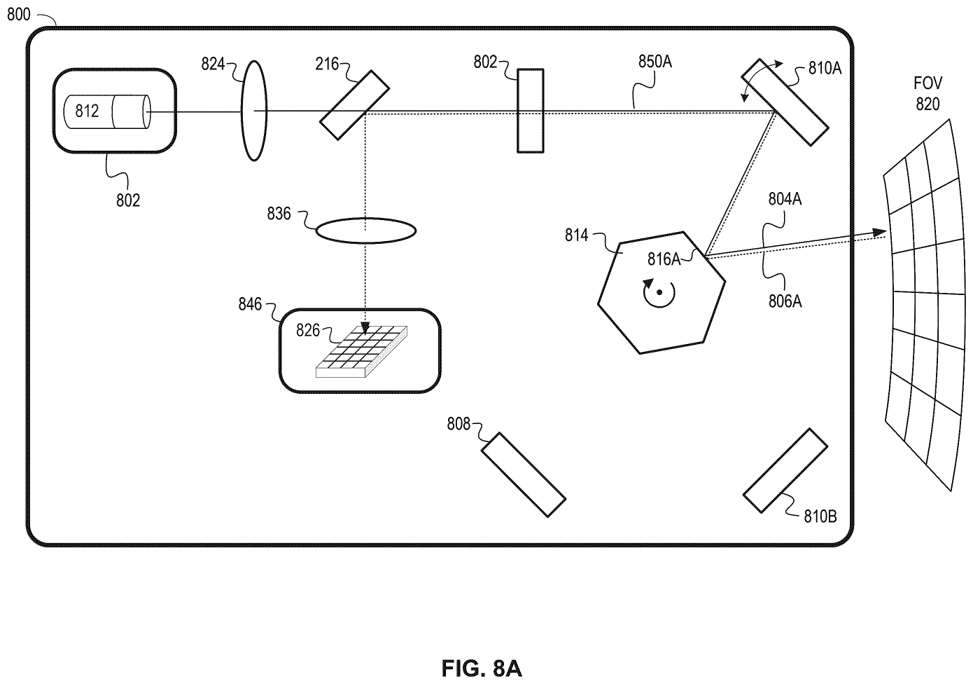

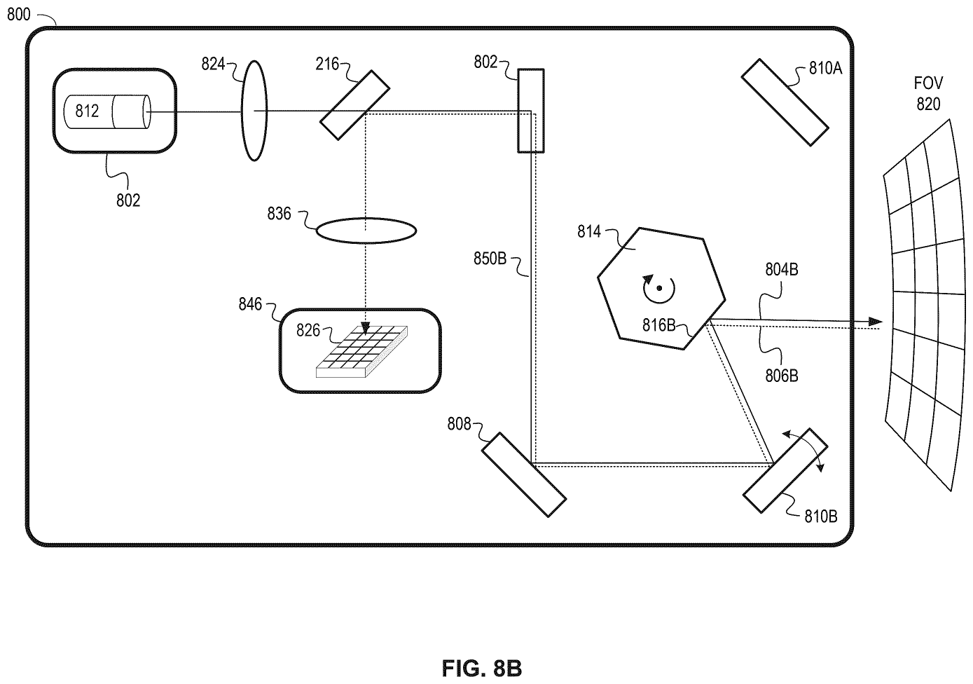

Reference is now made to FIG. 8A and FIG. 8B, which are schematic illustrations of an exemplary LIDAR system configured to direct light for scanning its FOV and receive light reflected from the FOV via multiple optical paths, in accordance with embodiments of the present disclosure.

An exemplary LIDAR system 800 such as the LIDAR system 300 may be deployed and configured to scan an FOV 820 such as the FOV 320 and/or part thereof. The LIDAR system 800 may include an illumination unit 802 such as the illumination unit 102 comprising one or more light sources 812 such as the light source 112, a sensing unit 846 such as the sensing unit 106 comprising one or more light sensors 826 such as the sensor 116 and a light deflector such as the light deflector 114, for example, a multi-faceted scanning polygon 814 such as the scanning polygon 314 having a plurality of reflective facets 816 such as the reflective facets 316.

The LIDAR system 800 may employ monostatic architecture such that light 804 projected to illuminate and scan the FOV 820 and light 806 (interchangeably designated reflected light 806) received from the FOV 820 share an at least partially common optical path through the LIDAR system 800. This means that the light emitted by the light source(s) 812 is directed in an outbound optical path through the LIDAR system 800 and projected (light 804) to scan the FOV 820 through one or more common (shared) optical elements through which the light 806 received from the FOV 820 is directed towards the sensor(s) 116. While a monostatic architecture is described herein for the LIDAR system 800, this should not be construed as limiting since, as described for the LIDAR system 300, according to some embodiments, the LIDAR system 800 may employ a bistatic architecture in which the transmitted light 804 and reflected light 806 may be directed via separate optical paths each comprising one or more optical elements which are not shared between the transmit and receive optical paths.

A shown in FIG. 8A and FIG. 8B, using one or more optical switches 802 such as the optical switch 302, the projected light 804 may be directed towards the FOV 820 through a plurality of optical paths via different reflective facets 816 of the scanning polygon 814, and the reflected light 806 may be also directed towards the sensor(s) 826 via the same plurality of optical paths each utilizing one of the plurality of reflective facets 816 of the scanning polygon 814.

Specifically, reflected light 806 may be directed via the at least partially common optical path through which the corresponding projected light 804 is directed. For example, the light emitted by the light source(s) 812 may be directed towards the FOV 820 via two optical paths, namely a first optical path 850A through which light 804A is projected to scan the FOV 820 and/or part thereof (illustrated in FIG. 8A), and a second optical path 850A through which light 804B is projected to scan the FOV 820 and/or part thereof (illustrated in FIG. 8B).

Reflected light 806A may correspond to projected light 804A, i.e., the light 806A may be reflected from one or more objects in the FOV 820 illuminated (scanned) by the projected light 804A, while reflected light 806B may correspond to projected light 804B, i.e., the light 806BA may be reflected from one or more objects in the FOV 820 illuminated (scanned) by the projected light 804B.

Therefore as seen in FIG. 8A, as the LIDAR system 800 employs monostatic architecture, the reflected light 806A may be directed towards the sensor(s) 826 through the first optical path 850A through which the projected light 804A is directed from the light source(s) 812 towards the FOV 820. Complementary, as seen in FIG. 8B, the reflected light 806B may be directed towards the sensor(s) 826 through the second optical path 850B through which the projected light 804B is directed from the light source(s) 812 towards the FOV 820.

As seen in FIG. 8A and FIG. 8B, similarly to both projected light 804A and 804B being emitted by the same light source(s) 812, both reflected light 806A and 806B are directed via the plurality of optical paths, for example, the optical paths 850A and 850B to the same sensor(s) 816.

Due to its monostatic configuration, the LIDAR system 800 may comprise one or more asymmetrical deflectors such as the asymmetrical deflectors 216, for example, a polarization beam splitter, an optical isolator, a slitted folding mirror (i.e., a mirror having an aperture, hole or slit in it), and/or the like configured not to deflect the light emitted by the light source(s) 812 and directed towards the FOV 820 while deflecting light 206 reflected from the FOV 820 towards the sensor(s) 816. As described herein before, the asymmetrical deflector 216 may be optionally configured to prevent the reflected light 206 from hitting the light source(s) 812, and direct most and potentially all the reflected light 206 toward the sensor(s) 816, thereby increasing detection sensitivity.

The common optical elements shared by the outbound optical path of the projected light 804 and the inbound optical path of the reflected light 806 may include the scanning polygon 814. For example, projected light 804A and reflected light 806A directed through the first optical path 850A may be directed via a first reflective facet 816A from the light source(s) 812 and to the sensor(s) 816, respectively. In another example, projected light 804B and reflected light 806B directed through the second optical path 850B may be directed via a first reflective facet 816B from the light source(s) 812 and to the sensor(s) 816, respectively.

The optical elements shared by the projected light 804 and the reflected light 806 in the LIDAR system 800 may further include one or more additional optical elements deployed in the LIDAR system 800.

For example, the reflected light 806 received from the FOV 820 and deflected by the scanning polygon 814 may pass through an optical switch 802 such as the optical switch 302 configured to switch between states. In each state, in addition to directing light emitted by the light source(s) 812 towards the scanning polygon 814 and the FOV 820 through a respective one of the plurality of optical paths 850, the optical switch 802 also directs the reflected light 806 received from the FOV through the respective optical path 850 towards the sensor(s) 816. For example, when in a first state, the reflected light 806A corresponding to the projected light 804A and received from the FOV 820 via the first reflective facet 816A may be directed by the optical switch 802 towards the sensor(s) 816. However, when in a second state, the reflected light 806B corresponding to the projected light 804B and received from the FOV 820 via the second reflective facet 816B may be directed by the optical switch 802 towards the sensor(s) 816.

In another example, the reflected light 806 deflected from the reflective facet 816 of the scanning polygon may be further manipulated, for example, deflected by one or more optical elements 810 such as the optical element 310 (FIGS. 3) and 410 (FIG. 4) interposed along one or more of the optical paths 850, specifically between the scanning polygon and the sensor(s) 816. The optical elements 810 may be configured to adjust, set, and/or adjust the optical paths 850. For example, the optical elements 810 may comprise folding mirror elements having a reflective surface, for example, a mirror, a vertical scanner, and/or the like configured to deflect the projected light 804 emitted by the light source(s) 812 towards the FOV 820 and deflect the reflected light 806 received from the scanning polygon 814 towards the sensor(s) 816. For example, an optical element 810A, for example, a mirror, a vertical scanner, and/or the like may be interposed between the scanning polygon 814 and the optical switch 802 for deflecting the reflected light 806A received via the reflective facet 816A towards the optical switch 802 through the first optical path 850A. In another example, an optical element 810B, for example, a mirror, a vertical scanner, and/or the like may be interposed between the scanning polygon 814 and the optical switch 802 for deflecting the reflected light 806B received via the reflective facet 816B towards the optical switch 802 through the second optical path 850B.

One or more other optical components may be deployed in one or more of the common outbound and inbound optical paths 850. For example, an optical element 808, for example, a folding mirror may be deployed along the second optical path 850B for deflecting the projected light 804B directed by the optical switch 802 through the second optical path 850B towards the scanning polygon 814, and also deflecting, towards the optical switch 802 and the sensor(s) 816, the reflected light 806B received via the second reflective facet 816B and optionally the optical element 810B.

The LIDAR system 800 may further optionally comprise one or more additional optical elements 824 and/or 826, for example, a lens, an aperture, a window, a light filter, a waveguide, a waveplate, a beam splitter, and/or the like deployed for adjusting the light 804 emitted by the light source(s) 812 and/or the reflected light 806 received from the FOV 820 respectively, for example, collimating, focusing, de-focusing, polarizing, and/or the like the emitted and/or reflected light.

According to some embodiments disclosed herein, one or more of the facets of a light deflector such as the light deflector 114, for example, a scanning polygon such as the scanning polygon 314 of a LIDAR system such as the LIDAR system 300 may have one or more tilted reflective facet 316 each having a reflective surface tilted with respect to a rotation axis of the light deflector 114, i.e., the rotation axis of the scanning polygon 314. The tilted facet(s) 316 may be configured, adjusted, and/or selected to adjust the FOV 320 scanned by the LIDAR system 300. The titled facets configuration may be applied to any LIDAR system employing substantially similar scanning architecture, for example, a LIDAR system such as the LIDAR system 800 and/or the like in which one or more of the reflective facets 816 of the spinning polygon 814 may be tilted.

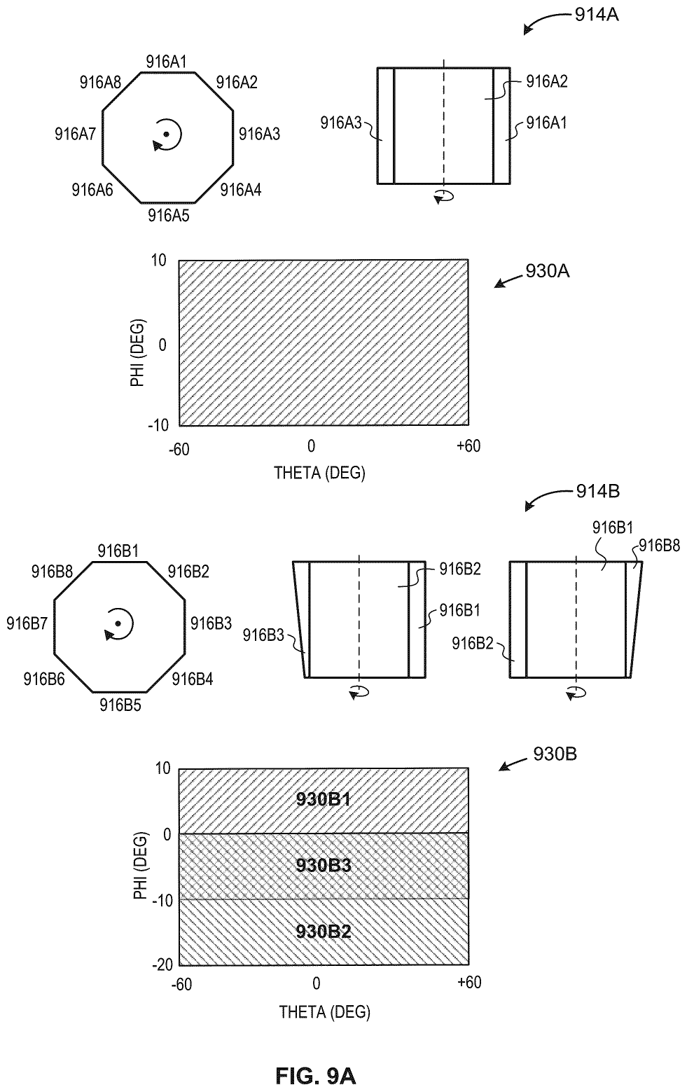

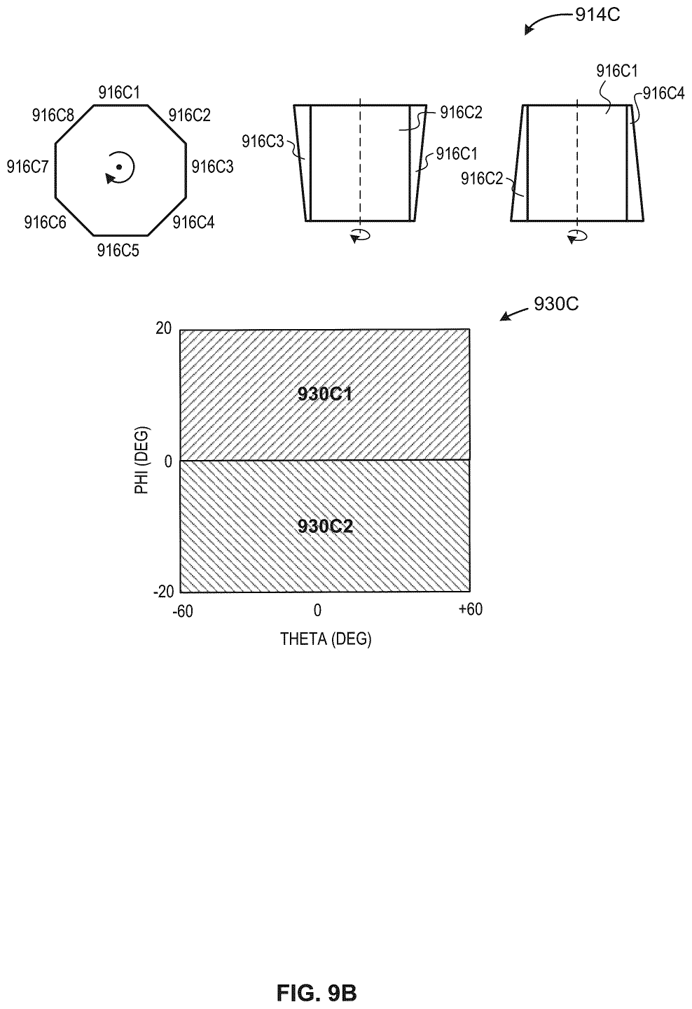

Reference is now made to FIG. 9A and FIG. 9B, which are schematic illustrations of exemplary scanning polygons of a LIDAR system having tilted reflective facets for directing light to scan a FOV of the LIDAR system, in accordance with embodiments of the present disclosure.

As seen in FIG. 9A, an exemplary scanning polygon 914A such as the scanning polygon 314, for example, an octagon scanner may have a plurality of reflective 916A such as the reflective facets 316, specifically eight reflective 916A, namely 916A1, 916A2, 916A3, 916A4, 916A5, 916A6, 916A7m and 916A8 as seen in a top view of the scanning polygon 914A. All of the reflective facets 916A of the scanning polygon 914A may be straight, i.e., have a straight or perpendicular reflective surface with respect to the rotation axis of scanning polygon 914A, as representatively seen in a front view of the scanning polygon 914A showing some of the reflective facets 916A, specifically, reflective facets 916A1, 016A2, and 916A3.

Assuming the scanning polygon 914A is included in a LIDAR system such as the LIDAR system 300 for scanning an FOV such as the FOV 320 across a horizontal extent of, for example, 120° between −60° and 60°. Further assuming the LIDAR system 300 includes a vertical scanner such as the vertical scanner 310A and/or 310B adapted to deflect the light emitted by the one or more light sources such as the light source 112 across a vertical extent of, for example, 20° between −10° and 10° of the reflective facets 916A of the scanning polygon 916A to project the light 204 for vertically scanning the FOV 320 and/or part thereof.

In such case, since all of the reflective facets 916A of the scanning polygon 914A are straight, a projected FOV 930A of the scanned FOV 320 scanned via one or more of the reflective facets 916A may extend across a horizontal extent (expressed by theta) of 120° between −60° and 60° and a vertical extent (expressed by phi) of 20° between −10° and 10°.

As seen in FIG. 9A, another exemplary scanning polygon 914B such as the scanning polygon 914, i.e., an octagon scanner may have a plurality of reflective 916B such as the reflective facets 916A. However, while some of the reflective facets 916B may be straight as those of the polygon 914A, for example, 916B1, 916B2, 916B4, 916B5, 916B6, and 916B7, the other reflective facets, namely reflective facets 916B3, 916B6, and 916A8 may be tilted, for example, tilted downward 10° with respect to the rotation axis of scanning polygon 914B, as representatively seen in a front view of the scanning polygon 914B.

Assuming the scanning polygon 914B is included in the LIDAR system 300 for scanning the FOV 320 across a horizontal extent of, for example, 120° between −60° and 60°. Further assuming the LIDAR system 300 includes a vertical scanner such as the vertical scanner 310A and/or 310B adapted to deflect the light emitted by the light source(s) 112 across a vertical extent of, for example, 20° between −10° and 10° of the reflective facets 916B of the scanning polygon 916B to project the light 204 for vertically scanning the FOV 320 and/or part thereof.

In such case, since some of the reflective facets 916B of the scanning polygon 914B are straight while other reflective facets 916B are tilted downward, a projected FOV 930B of the scanned FOV 320 may include a first portion (region) 930B1 scanned via the straight reflective facets which has a horizontal extent (theta) of 120° between −60° and 60° and a vertical extent (phi) of 20° between −10° and 10°, and a second portion (region) 930B2 scanned via the tilted reflective facets which has a horizontal extent (theta) of 120° between −60° and 60° but a vertical extent (phi) of 20° between 0° and −20°. As seen, the first portion 930B1 and second portion 930B2 of the FOV 930B may be at least partially overlapping in a portion (region) 930B3 which is scanned through both the straight and the tilted reflective facets 916B.

As seen in FIG. 9B, yet another exemplary scanning polygon 914C such as the scanning polygon 914, i.e., an octagon scanner may have a plurality of reflective 916C such as the reflective facets 916C. Some of the reflective facets 916B may be downward tilted having reflective surfaces tilted downward, for example, at 10° with respect to the rotation axis of scanning polygon 914C, for example, reflective facets 916C1, 916C3, 916C5, and 916C7. Other reflective facets 916, for example, facets 916C2, 916C4, 916C6, and 916C8 may be upward tilted having reflective surfaces tilted upward, for example, at 10° with respect to the rotation axis of scanning polygon 914C.

Assuming the scanning polygon 914C is included in the LIDAR system 300 for scanning the FOV 320 across a horizontal extent of, for example, 120° between −60° and 60°. Further assuming the LIDAR system 300 includes the vertical scanner 310A and/or 310B adapted to deflect the light emitted by the light source(s) 112 across a vertical extent of, for example, 20° between −10° and 10° of the reflective facets 916C of the scanning polygon 916C to project the light 204 for vertically scanning the FOV 320 and/or part thereof.

In such case, since some of the reflective facets 916C of the scanning polygon 914C are tilted upward while other reflective facets 916C are tilted downward, a projected FOV 930C of the scanned FOV 320 may include a first portion (region) 930C1 scanned via the upward reflective facets which has a horizontal extent (theta) of 120° between −60° and 60° and a vertical extent (phi) of 20° between 0° and 20°, and a second portion (region) 930C2 scanned via the downward tilted reflective facets which has a horizontal extent (theta) of 120° between −60° and 60° and a vertical extent (phi) of 20° between 0° and −20°. As seen, the first and second portions of the FOV 930C are distinct and not overlapping.

As described herein before, the processor(s) 118 may be configured to aggregate the signal data generated by the sensor(s) 116 with respect to light received through the plurality of optical paths specifically in association with each optical path to produce an aggregated signal data which is typically with higher volume mapping an increased FOV 320, mapping one or more overlapping portions (regions) scanned through multiple optical paths, map one or more portions (regions) with increased resolution, and/or the like.

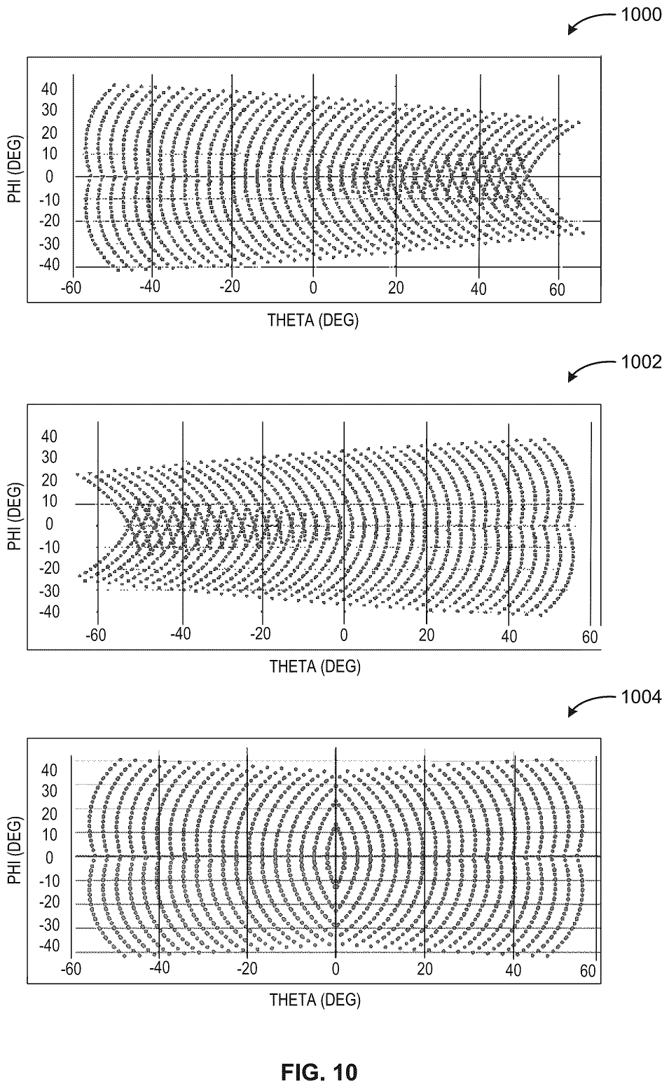

Reference is now made to FIG. 10, which illustrates spherical projection of light by a LIDAR system for scanning its FOV via multiple optical paths utilizing different facets of a scanning polygon having tilted reflective facets, in accordance with embodiments of the present disclosure.

An exemplary LIDAR system such as the LIDAR system 300 may comprise a light deflector such as the light deflector 114, for example, a scanning polygon such as the scanning polygon 314 for scanning an FOV such as the FOV 320 having a hFOV of −60° and 60° and a vFOV of −40° and 40°. The scanning polygon 314 may be configured to have one or more tilted reflective facets 316, for example, one or more upward tilted facets 316 and one or more downward tilted facets 316. Each of the upward tilted facets 316 may have a reflective surface tilted upward, for example, at 20° with respect to the rotation axis of scanning polygon 314 while each of the downward tilted facets 316 may have a reflective surface tilted upward, for example, at −20° with respect to the rotation axis of scanning polygon 314.

Illustrations 1000 and 1002 depict spherical projections of projected light such as the light 204 directed in the LIDAR system 300 towards FOV 320 through different optical paths such as the optical paths 350. For example, the spherical projection 1000 may be obtained by scanning the FOV 320 with projected light 204A directed to the FOV 320 through the first optical path 350A while the spherical projection 1002 may be obtained by scanning the FOV 320 with projected light 204B directed to the FOV 320 through the second optical path 350B.

In particular, a top section of the spherical projections 1000 and 1002 may relate to scanning the FOV 320 via an upward tilted reflective facet 316 of the scanning polygon 314 while a bottom section of the spherical projections 1000 and 1002 may relate to scanning the FOV 320 via a downward tilted reflective facet 316 of the scanning polygon 314.

As seen in spherical projection 1000, the projection of light 204A is gradually distorted in the far filed, i.e., to the left side of the spherical projection 1000 for the light 204A projected via both the upward tilted reflective facet 316 and the downward tilted reflective facet 316. This distortion may be traced to the gradually increasing angle of incidence of the projected light 204A on the reflective facets 316 due to excessive grazing angles, diffused light beam, and/or the like.

Similarly, as seen in spherical projection 1002, the projection of light 204B is gradually distorted in the far filed, i.e., to the right side of the spherical projection 1002 for the light 204B projected via both the upward tilted reflective facet 316 and via the downward tilted reflective facet 316. This distortion may also be traced to the gradually increasing angle of incidence of the projected light 204A on the reflective facets 316 due to excessive grazing angles, diffused light beam, and/or the like.

As described herein before, one or more processors such as the processor(s) 118 and/or the processor 218 may aggregate the signal data received from one or more sensors such as the sensor 116 which is indicative of light 206 reflected from the FOV 320 in response to scanning the FOV 320 with light 204 directed to the FOV 320 via the plurality of different optical paths 350, for example, the optical path 350A and the second optical path 350B. For example, the processor(s) may extract first signal data relating to scanning the FOV 320 with light 204A directed to the FOV 320 via the first optical path 350A and second signal data relating to scanning the FOV 320 with light 204B directed to the FOV 320 via the second optical path 350B. The processor(s) may further combine the first signal data and the second signal data to produce an aggregated spherical projection 1004 having increased quality, for example, reduced distortion.

In particular, the processor(s) may select signal data received from the sensor(s) 116 which is indicative of light 206 reflected from the FOV 320 in response to scanning (illuminating) the FOV 320 with projected light 204 having an angle of incidence, on a respective reflective facet 316 with respect to the projection of the normal on the plane perpendicular to the rotation axis of the scanning polygon 314, which has an absolute value smaller than a certain threshold angle, for example, 60°, 75°, 90°, and/or the like.

The scanning polygon 314, and optionally one or more vertical scanners 310A and/or 310B may be therefore shaped, configured and/or adapted to scan an FOV 320 defined for the LIDAR system 300, i.e., having selected hFOV and vFOV extents. Moreover, as described herein before, since light 206 may be reflected responsive to illuminating (scanning) the FOV 320 with projected light 204 directed towards the FOV 320 through the plurality of optical paths 350 during an increased time period of the scan period, i.e., the scan period utilization is significantly increased, the sensor(s) 116 receiving the reflected light during the increased time period of the scan period may generate increased volume of signal data.

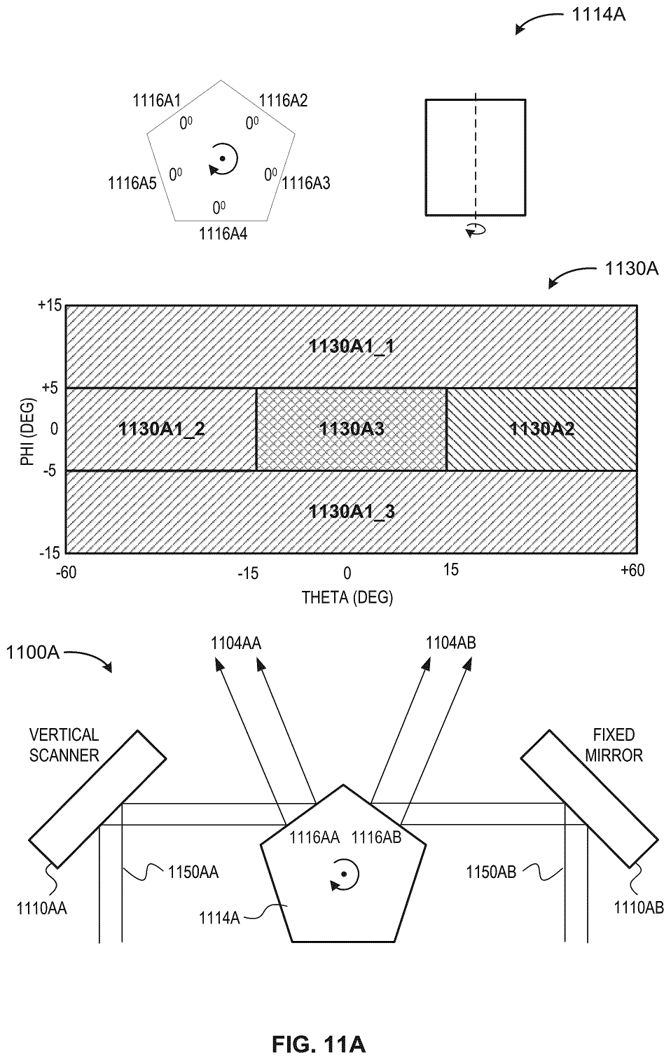

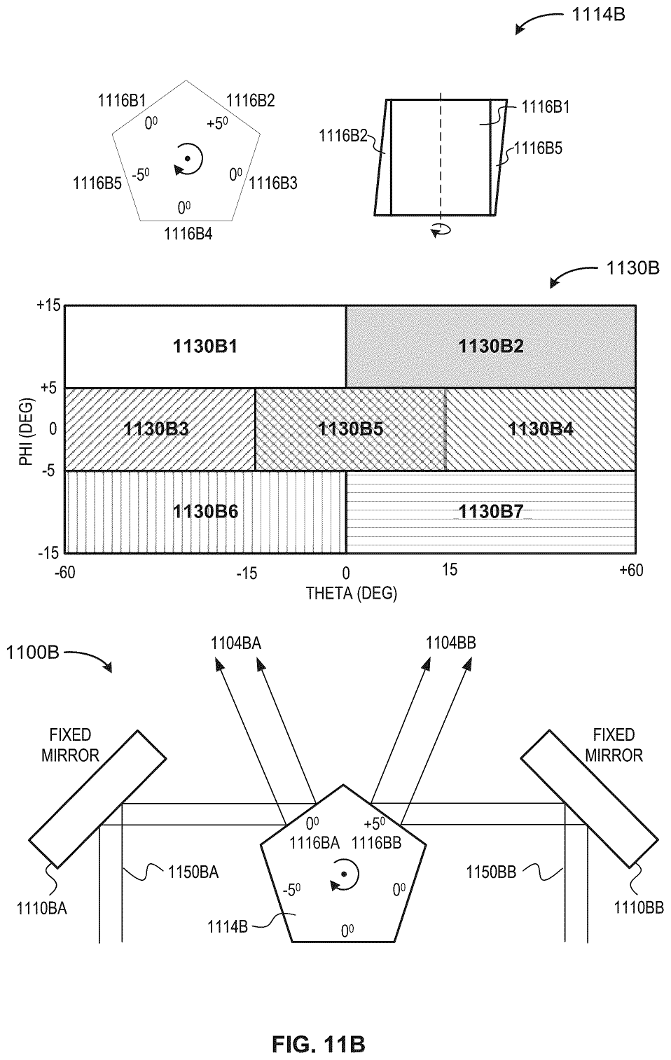

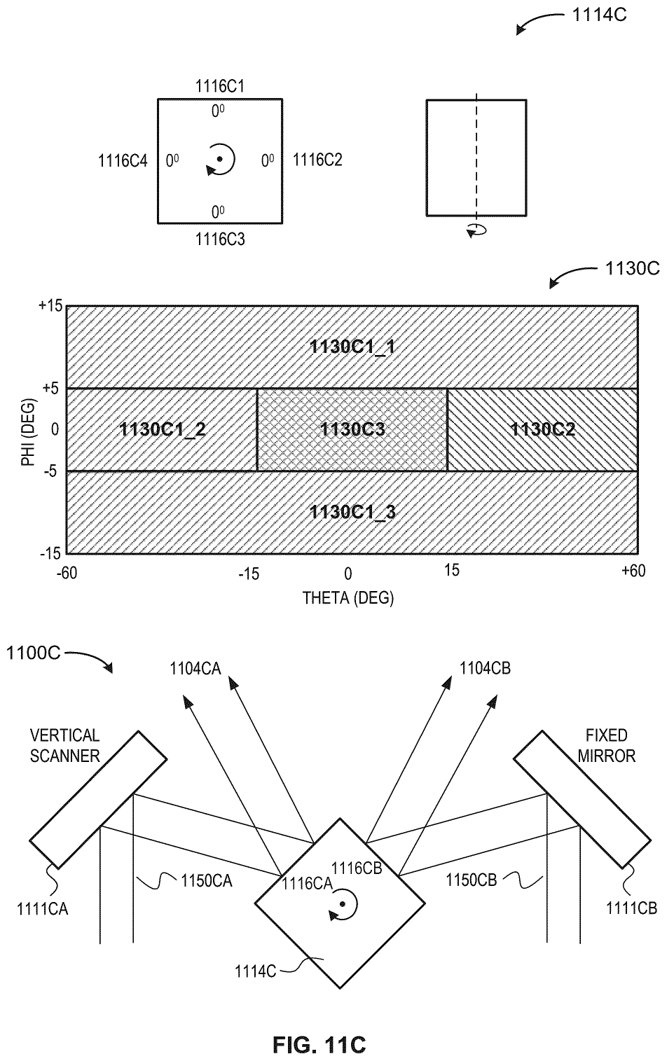

Reference is also made to FIG. 11A, FIG. 11B, and FIG. 11C, which are schematic illustrations of exemplary scanning polygons of a LIDAR system configured for scanning respective FOVs, in accordance with embodiments of the present disclosure.

As seen in FIG. 11A, an exemplary LIDAR system 1100A such as the LIDAR system 300 configured for scanning an FOV such as the FOV 320 with light 1104A such as the light 204 projected to scan the FOV 320 during each scan period (e.g., scan cycle) via a plurality of different reflective facets such as the reflective facets 316 of a light deflector 114, specifically a scanning polygon 1114A such as the scanning polygon 314.

A projected FOV 1130A of the FOV 320 may be required to have a hFOV (theta) of 120° between −60° and 60° and a vFOV (phi) of 30° between −15° and +15°. Moreover, the FOV 1130A may have a center ROI which needs to be scanned with increased resolution.

The LIDAR system 1100A may include one or more light sources such as the light source 112 configured to emit light, for example, one or more laser beams configured to scan a vertical extent of 10°.

In order to meet the required FOV 1130A, the LIDAR system 1100A may be configured to have a pentagon scanner having five reflective facets 1116A such as the reflective facets 316 of the scanning polygon 314 as seen in a top view of the scanning polygon 1114A. All of the reflective facets 1116A of the scanning polygon 1114A may be straight, i.e., have a straight or perpendicular reflective surface with respect to the rotation axis of scanning polygon 1114A, as representatively seen in a front view of the scanning polygon 1114A. The reflective facets 1116A are marked with 0° to indicate they have a zero angle with the plane perpendicular to the rotation axis of the scanning polygon 1114A.

The LIDAR system 1100A may further include one or more optical elements 1110A such as the optical elements 310, for example, a vertical scanner 1110AA configured to deflect the light emitted by the light source(s) 112 across a vertical extent of 10° and a fixed mirror 1110AB.

One or more processors such as the processor(s) 118 may be configured to operate one or more optical switches such as the optical switch(es) 302 in synchronization with the scanning polygon 1114A to direct the light beam(s) emitted by the light source(s) 112 towards the FOV through two optical paths 1150AA and 1150AB. In particular, the processor(s) may switch the optical switch(es) 302 between states during each scan period (e.g., scan cycle and/or part thereof) to direct the light beam(s) emitted by the light source(s) 112 towards the FOV through each of the optical paths 1150AA and 1150AB during different time segments of the respective scan period, for example, through the first optical path 1150AA via reflective facet 1116AA during a first time segment of the scan period and through the second optical path 1150AB via reflective facet 1116AB during a second time segment of the scan period.

The processor(s) may construct the FOV 1130A to have several distinct portions (regions) based on signal data generated by one or more sensor(s) such as the sensor 116 of the LIDAR system 1100A which is indicative of light reflected from the FOV in response to projecting light 1104AA to the FOV through the first optical path 1150AA via the first reflective facet 1116AA and signal data indicative of light reflected from the FOV in response to projecting light 1104AB to the FOV through the second optical path 1150AB via the second reflective facet 1116AB.

Since the vertical scanner 1110AA may deflect the light beam(s) emitted by the light source(s) 112 across a vertical extent of 20° the light 1104AA projected via the first reflective facet 1116AA may scan a vFOV of 30° between −15° and +15° while the light 1104AB projected via the fixed mirror and the second reflective facet 1116AB may scan a vFOV of 10° between −5° and +5°.

The FOV 1130A constructed by the processor(s) may comprise, for example, three distinct portions or regions, a first portion 1130A1 constructed based on light reflected from the FOV in response to light 1104AA directed to the FOV via the first reflective facet 1116AA, a second portion 1130A2 constructed based on light reflected from the FOV in response to light 1104AB directed to the FOV via the second reflective facet 1116AB, and an overlapping portion 1130A3 (e.g., ROI) constructed based on light reflected from the FOV in response to light 1104AA and light 1104AB directed to the FOV via the first and second reflective facet 1116AA and 1116AB respectively. The scanning resolution of the overlapping portion 1130A3 may be significantly increased as it may be scanned twice during one or more scan periods (e.g., scan cycles).

Optionally, the first portion 1130A1 may comprise multiple sub-regions constructed based on different scanning frequencies of the FOV with light directed to the FOV the first optical path 1150AA. For example, the sub-regions 1130A1_1 and 1130A1_3 may be scanned at lower frequency compared to a higher frequency of scanning the sub-region 1130A_2, for example, the sub-regions 1130A1_1 and 1130A1_3 may be scanned once every four scan periods while the sub-region 1130A1_2 may be scanned every scan period.

As seen in FIG. 11B, an exemplary LIDAR system 1100B such as the LIDAR system 300 configured for scanning an FOV such as the FOV 320 with light 1104B such as the light 204 projected to scan the FOV 320 during each scan period (e.g., scan cycle) via a plurality of different reflective facets such as the reflective facets 316 of a light deflector 114, specifically a scanning polygon 1114B such as the scanning polygon 314.

A projected FOV 1130B of the FOV 320 may be required to have a hFOV (theta) of 120° between −60° and 60° and a vFOV (phi) of 30° between −15° and +15°. Moreover, the FOV 1130A may have a center ROI which needs to be scanned with increased resolution.

The LIDAR system 1100B may include one or more light sources such as the light source 112 configured to emit light, for example, one or more laser beams configured to scan a vertical extent of 10°.

In order to meet the required FOV 1130B, the LIDAR system 1100A may be configured to have a pentagon scanner having five reflective facets 1116B such as the reflective facets 316 of the scanning polygon 314 as seen in a top view of the scanning polygon 1114B. Three of the reflective facets 1116B of the scanning polygon 1114B, for example, reflective facets 1116B1, 1116B3, and 1116B4 may be straight, i.e., have a straight or perpendicular reflective surface with respect to the rotation axis of scanning polygon 1114B, as seen in a front view of the scanning polygon 1114B. The reflective facets 1116B1, 1116B3, and 1116B4 are marked with 0° to indicate they have a zero angle with the plane perpendicular to the rotation axis of the scanning polygon 1114B.

One of the reflective facets 1116B, for example, reflective facet 1116B2 may be tilted upward and have a reflective surface having an angle of +5° with respect to the rotation axis of scanning polygon 1114B, as seen in the front view of the scanning polygon 1114B. The reflective facets 1116B2 is marked with +5° to indicate it has a +5° angle with the plane perpendicular to the rotation axis of the scanning polygon 1114B.

Another one of the reflective facets 1116B, for example, reflective facet 1116B5 may be tilted downward and have a reflective surface having an angle of −5° with respect to the rotation axis of scanning polygon 1114B, as seen in the front view of the scanning polygon 1114B. The reflective facets 1116B5 is marked with −5° to indicate it has a −5° angle with the plane perpendicular to the rotation axis of the scanning polygon 1114B.

The LIDAR system 1100A may further include one or more optical elements 1110B such as the optical elements 310, for example, a fixed mirror 1110BA and a fixed mirror 1110BB.

One or more processors such as the processor(s) 118 may be configured to operate one or more optical switches such as the optical switch(es) 302 in synchronization with the scanning polygon 1114B to direct the light beam(s) emitted by the light source(s) 112 towards the FOV through two optical paths 1150BA and 1150BB. In particular, the processor(s) may switch the optical switch(es) 302 between states during each scan period (e.g., scan cycle and/or part thereof) to direct the light beam(s) emitted by the light source(s) 112 towards the FOV through each of the optical paths 1150BA and 1150BB during different time segments of the respective scan period, for example, through the first optical path 1150BA via reflective facet 1116BA during a first time segment of the scan period and through the second optical path 1150BB via reflective facet 1116BB during a second time segment of the scan period.

The processor(s) may construct the FOV 1130B to have several distinct portions (regions) based on signal data generated by one or more sensors 116 of the LIDAR system 1100B which is indicative of light reflected from the FOV in response to projecting light 1104BA to the FOV through the first optical path 1150BA via the first reflective facet 1116BA and signal data indicative of light reflected from the FOV in response to projecting light 1104BB to the FOV through the second optical path 1150BB via the second reflective facet 1116BB.

Since the light 1104BA and 1104BB is projected via fixed mirrors 1100BA and 1100BB the light projected via the straight reflective facets 1116B1, 1116BC3 and/or 1116C4 may scan a vFOV of 10° between −5° and +5°. However, light projected via the upward tilted reflective facet 1116B2 may scan a vFOV of 10° between +5° and +15° while light projected via the downward reflective facet 1116B5 may scan a vFOV of 10° between −5° and −15° thus achieving the required FOV 1130B.

The FOV 1130B constructed by the processor(s) may comprise, for example, seven distinct portions or regions. First portion 1130B1 constructed based on light reflected from the FOV in response to light 1104BA directed to the FOV through the first optical path 1150BA via the upward tilted reflective facet 1116B2. A second portion 1130B2 constructed based on light reflected from the FOV in response to light 1104BB directed to the FOV through the second optical path 1150BB via the upward tilted reflective facet 1116B2. A third portion 1130B3 constructed based on light reflected from the FOV in response to light 1104BA directed to the FOV through the first optical path 1150BA via the straight reflective facets 1116B1, 1116B3 or 1116B4. A fourth portion 1130B4 constructed based on light reflected from the FOV in response to light 1104BB directed to the FOV through the second optical path 1150BB via the straight reflective facets 1116B1, 1116B3 or 1116B4. An overlapping portion 1130B5 (e.g., ROI) constructed based on light reflected from the FOV in response to light 1104BA and light 1104BB directed to the FOV through the first and second optical paths 1150BA and 1150BB via the straight reflective facets 1116B1, 1116B3 or 1116B4. A sixth portion 1130B6 constructed based on light reflected from the FOV in response to light 1104BA directed to the FOV through the first optical path 1150BA via the down tilted reflective facet 1116B5 and a seventh portion 1130B7 constructed based on light reflected from the FOV in response to light 1104BB directed to the FOV through the second optical path 1150BB via the downward tilted reflective facet 1116B5. The scanning resolution of the overlapping portion 1130A5 may be significantly increased as it may be scanned twice during one or more scan periods (e.g., scan cycles).

As seen in FIG. 11C, an exemplary LIDAR system 1100C such as the LIDAR system 300 configured for scanning an FOV such as the FOV 320 with light 1104C such as the light 204 projected to scan the FOV 320 during each scan period (e.g., scan cycle) via a plurality of different reflective facets such as the reflective facets 316 of a light deflector 114, specifically a scanning polygon 1114C such as the scanning polygon 314.

A projected FOV 1130C of the FOV 320 may be required to have a hFOV (theta) of 120° between −60° and 60° and a vFOV (phi) of 30° between −15° and +15°. Moreover, the FOV 1130A may have a center ROI which needs to be scanned with increased resolution.

The LIDAR system 1100C may include one or more light sources such as the light source 112 configured to emit light, for example, one or more laser beams configured to scan a vertical extent of 10°.

In order to meet the required FOV 1130A, the LIDAR system 1100C may be configured to have a square scanner having four reflective facets 1116c such as the reflective facets 316 of the scanning polygon 314 as seen in a top view of the scanning polygon 1114C. All of the reflective facets 1116C of the scanning polygon 1114C may be straight, i.e., have a straight or perpendicular reflective surface with respect to the rotation axis of scanning polygon 1114C, as representatively seen in a front view of the scanning polygon 1114C. The reflective facets 1116C are marked with 0° to indicate they have a zero angle with the plane perpendicular to the rotation axis of the scanning polygon 1114C.

The LIDAR system 1100C may further include one or more optical elements 1110C such as the optical elements 310, for example, a vertical scanner 1110CA configured to deflect the light emitted by the light source(s) 112 across a vertical extent of 10° and a fixed mirror 1110CB.

One or more processors such as the processor(s) 118 may be configured to operate one or more optical switches such as the optical switch(es) 302 in synchronization with the scanning polygon 1114C to direct the light beam(s) emitted by the light source(s) 112 towards the FOV through two optical paths 1150CA and 1150CB. In particular, the processor(s) may switch the optical switch(es) 302 between states during each scan period (e.g., scan cycle and/or part thereof) to direct the light beam(s) emitted by the light source(s) 112 towards the FOV through each of the optical paths 1150CA and 1150CB during different time segments of the respective scan period, for example, through the first optical path 1150CA via reflective facet 1116CA during a first time segment of the scan period and through the second optical path 1150CB via reflective facet 1116CB during a second time segment of the scan period.

The processor(s) may construct the FOV 1130C to have several distinct portions (regions) based on signal data generated by one or more sensor(s) such as the sensor 116 of the LIDAR system 1100C which is indicative of light reflected from the FOV in response to projecting light 1104CA to the FOV through the first optical path 1150CA via the first reflective facet 1116CA and signal data indicative of light reflected from the FOV in response to projecting light 1104CB to the FOV through the second optical path 1150CB via the second reflective facet 1116CB.

Since the vertical scanner 1110CA may deflect the light beam(s) emitted by the light source(s) 112 across a vertical extent of 20°, the light 1104CA projected via the first reflective facet 1116CA may scan a vFOV of 30° between −15° and +15° while the light 1104CB projected via the fixed mirror and the second reflective facet 1116CB may scan a vFOV of 10° between −5° and +5°.

The FOV 1130C constructed by the processor(s) may comprise, for example, three distinct portions or regions, a first portion 1130C1 constructed based on light reflected from the FOV in response to light 1104CA directed to the FOV via the first reflective facet 1116CA, a second portion 1130C2 constructed based on light reflected from the FOV in response to light 1104CB directed to the FOV via the second reflective facet 1116CB, and an overlapping portion 1130C3 (e.g., ROI) constructed based on light reflected from the FOV in response to light 1104CA and light 1104CB directed to the FOV via the first and second reflective facet 1116CA and 1116CB respectively. The scanning resolution of the overlapping portion 1130C3 may be significantly increased as it may be scanned twice during one or more scan periods (e.g., scan cycles).

Optionally, the first portion 1130C1 may comprise multiple sub-regions constructed based on different scanning frequencies of the FOV with light directed to the FOV the first optical path 1150CA. For example, the sub-regions 1130C1_1 and 1130C1_3 may be scanned at lower frequency compared to a higher frequency of scanning the sub-region 1130C_2, for example, the sub-regions 1130C1_1 and 1130C1_3 may be scanned once every four scan periods while the sub-region 1130C1_2 may be scanned every scan period.

According to some embodiments, rather than using a single rotatable light deflector such as the light deflector 114 (e.g., spinning polygon 814), the LIDAR system 100 may include a plurality of distinct rotatable light deflectors 114 each comprising one or more reflective facets such as the reflective facets 316 through which light 204 emitted by light source(s) 112 is projected to the FOV 320 and reflected light 206 is received from the FOV 320 and directed towards the sensor(s) 116.

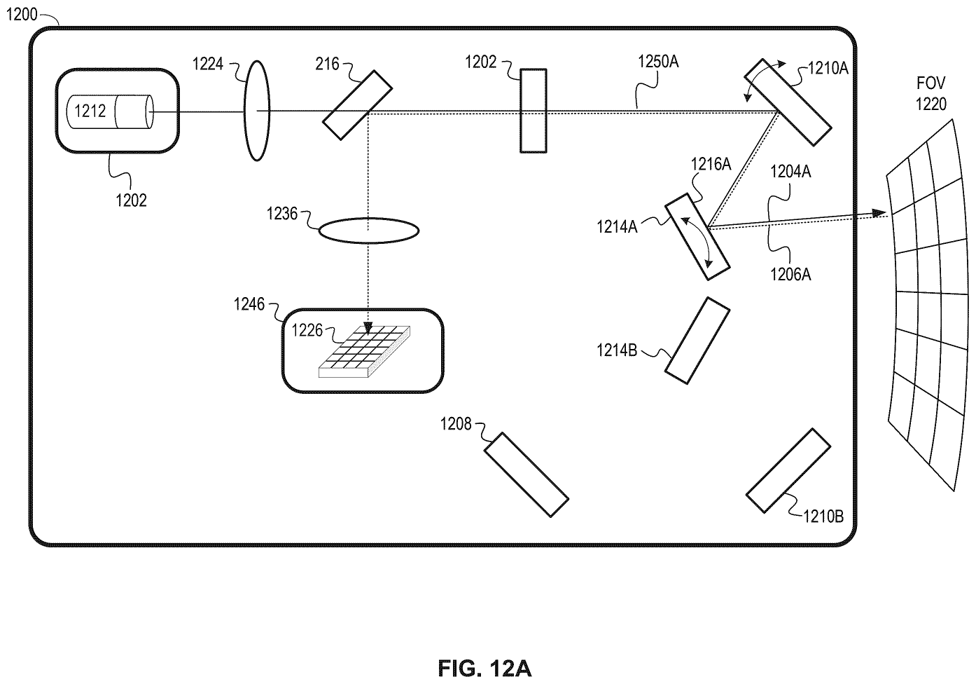

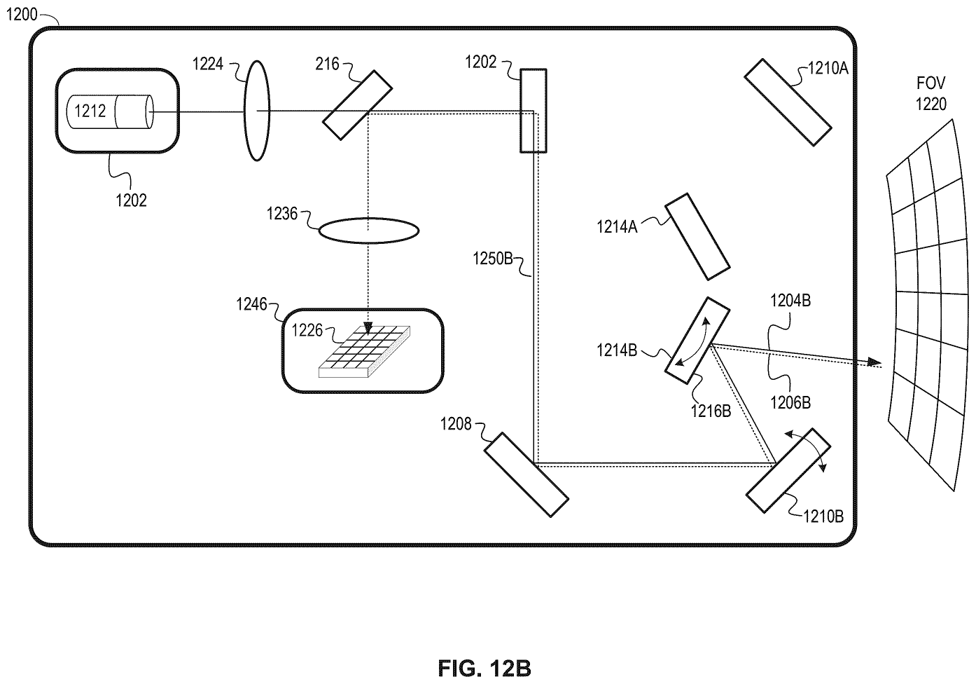

Reference is now made to FIG. 12A and FIG. 12B, which are schematic illustrations of an exemplary LIDAR system comprising multiple rotatable light deflectors configured to direct light for scanning its FOV and receive light reflected from the FOV via multiple optical paths, in accordance with embodiments of the present disclosure.

An exemplary LIDAR system 1200 such as the LIDAR system 100 may be deployed and configured to scan an FOV 1220 such as the FOV 120 and/or part thereof. The LIDAR system 1200 may include an illumination unit 1202 such as the illumination unit 102 comprising one or more light sources 1212 such as the light source 112, a sensing unit 1246 such as the sensing unit 106 comprising one or more light sensors 1226 such as the sensor 116 and multiple rotatable light deflectors such as the light deflector 114, for example, a first rotatable light deflector 1214A and a second rotatable light deflector 1214B. Each of the first rotatable light deflector 1214A and the second rotatable light deflector 1214B may comprise one or more reflective facets 1216 such as the reflective facets 316. For example, the first rotatable light deflector 1214A may have a first reflective facet 1216A and the second rotatable light deflector 1214B may have a second reflective facet 1216B.

The LIDAR system 1200 may comprise one or more optical switches 1202 such as the optical switch 302 for directing the projected light 1204 towards the FOV 1220 through a plurality of optical paths 1210, for example, a first optical path 1250A through which projected light 1204A is projected towards the FOV 1220 via the reflective facet 1216A of the first rotatable light deflector 1214A and a second optical path 1250B through which projected light 1204B is projected towards the FOV 1220 via the reflective facet 1216B of the second rotatable light deflector 1214B. The reflected light 1206 may be also directed towards the sensor(s) 1216 via the same plurality of optical paths 1250A and 1250B each utilizing the respective reflective facets 1216 of the two rotatable light deflectors 1214A and 1214B.

As described for the LIDAR system 800, the optical switch 1202 may be controlled, for example, by a processor such as the processor 118, to direct the projected light 1204 and/or the reflected light 1206 via the two optical paths 1250A or 1250B. For example, when the optical switch 1202 is set in a first state, the projected light 1204A and reflected light 1206A corresponding to the projected light 1204A may be directed by the optical switch 802 via the first optical path 1250A. However, when the optical switch is set in a second state, projected light 1204B and reflected light 806B corresponding to the projected light 1204B may be directed via the second optical switch path 1250B.

It should be noted that while each of the first and second rotatable light deflectors 1214A and 1214B are illustrated to have a single reflective facets 1216, this should not be construed as limiting since one or more of the first rotatable light deflector 1214A and the second rotatable light deflector 1214B may be configured to have more than one reflective facet 11216, for example, to support one or more additional optical paths such as the optical paths 350.

Similarly to the LIDAR system 800, the LIDAR system 1200 may employ monostatic architecture meaning that light 1204 projected to illuminate and scan the FOV 1220 and light 1206 (interchangeably designated reflected light 1206) received from the FOV 1220 share an at least partially common optical path through the LIDAR system 1200. While a monostatic architecture is described herein for the LIDAR system 1200, this should not be construed as limiting since, as described for the LIDAR system 300, according to some embodiments, the LIDAR system 1200 may employ a bistatic architecture in which the transmitted light 1204 and the reflected light 1206 may be directed via separate optical paths each comprising one or more optical elements which are not shared between the transmit and receive optical paths.

The rotatable light deflectors 1214A and 1214B may be rotatable in one or more axis. For example, in some embodiments one or more of the rotatable light deflectors 1214A and 1214B may be rotatable in two axes to support scanning the FOV 1220 across two axes, for example, vertical and horizontal scanning. In such case, the LIDAR system 1200 may include one or more additional optical elements positioned on the optical paths 1250A and/or 1250B to direct the projected light 1204 and the received light 1206, for example, one or more fixed folding mirrors 1210A and 1201B deployed for facilitating the first optical path 1250A and the second optical path 1250B respectively.

In another example, one or more of the rotatable light deflectors 1214A and 1214B may be rotatable in only one axis and thus may enable scanning the FOV 1220 across only one axis, for example, horizontal scanning. In such case, the optical elements 1201A and 1210B positioned on the optical paths 1250A and/or 1250B may include actively rotatable light deflectors, for example, a vertical scanner 1210A and/or a vertical scanner 1210B rotatable around at least one axis to support vertical scanning of the FOV 1220 by light projected via the first optical path 1250A and the second optical path 1250B respectively.

As described for the LIDAR system 800, the LIDAR system 1200 may optionally comprise one or more additional optical elements 824 and/or 826, for example, a lens, an aperture, a window, a light filter, a waveguide, a waveplate, a beam splitter, and/or the like deployed for adjusting the light 1204 emitted by the light source(s) 1212 and/or the reflected light 1206 received from the FOV 1220 respectively, for example, collimating, focusing, de-focusing, polarizing, and/or the like the emitted and/or reflected light.

As described herein before with respect to the LIDAR systems 300 and 800, one or more of the reflective facets 1216 of one or more of the rotatable light deflectors 1214A and/or 1214B may be tilted to form a tilted reflective facet 1216 having a reflective surface tilted with respect to a rotation axis of the respective light deflector 1214. The tilted facet(s) 1216 may be configured, adjusted, and/or selected to adjust the FOV 1220 scanned by the LIDAR system 1200, for example, increase the vertical extent of the scanned FOV 1220.

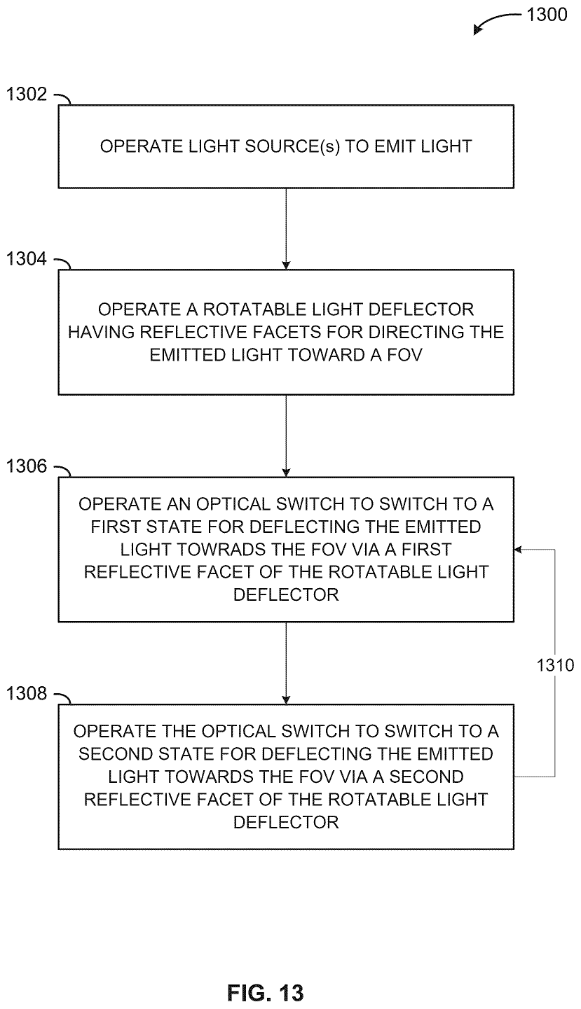

Reference is now made to FIG. 13, which is a flow chart of an exemplary process of scanning an FOV of a LIDAR by light directed towards the FOV through multiple optical paths of the LIDAR system selected using an optical switch, in accordance with embodiments of the present disclosure.

An exemplary process 1300 may be executed for scanning an FOV such as the FOV 320 by a LIDAR system such as the LIDAR system 300 configured to project light such as the projected light 204 towards the FOV 320 through a plurality of optical paths such as the optical paths 350 each via a respective reflective facet such as the reflective facets 316 of a rotatable light deflector such as the light deflector 114, for example, a scanning polygon such as the scanning polygon 314. The process 1300 may also be executed for controlling the LIDAR system 800, and/or LIDAR system 1200 for scanning an FOV such as the FOV 820 and/or 1220, respectively. However, for brevity and clarity, the process 1300 is described hereinafter with respect to the LIDAR system 300.

The process 1300 may be executed by one or more processors, typically the processor(s) 118 of the LIDAR system 300.

As shown at 1302, the processor(s) 118 may operate one or more light sources such as the light source 112 to emit light, for example, one or more laser beams.

As shown at 1304, the processor(s) 118 may operate the rotatable light deflector 114, for example, the scanning polygon 314 to rotate for deflecting the light emitted by the light source(s) 112 toward the FOV 320.

As shown at 1306, the processor(s) 118 may operate one or more optical switches such as the optical switch 302 interposed between the light source(s) 112 and the rotatable light deflector, for example, the scanning polygon 314, to switch to a first state for directing the light emitted by the light source(s) 112 towards the FOV 320 through a first optical path such as, for example, the first optical path 350A and deflecting the projected light 204 via a first reflective facet 316A of the scanning polygon 314. In particular, the processor(s) 118 may switch (set) the optical switch(es) 302 to the first state during a first time segment (portion) of a scan period of the FOV 320 by the LIDAR system 300.

As shown at 1308, the processor(s) 118 may operate the optical switch(es) to switch to a second state for directing the light emitted by the light source(s) 112 towards the FOV 320 through a second optical path such as, for example, the second optical path 350B and deflecting the projected light via a second reflective facet 316B of the scanning polygon 314. In particular, the processor(s) 118 may switch (set) the optical switch(es) 302 to the second state during a second time segment (portion) of the scan period of the FOV 320 by the LIDAR system 300.

In particular, the processor(s) 118 may synchronize the first and second time segments in which the optical switch 302 is in the first and second states with rotation of the scanning polygon 314 such that the reflective facets 316 through which the projected light 204 is projected towards the FOV 320 are positioned and/or oriented to effectively utilize sections of their reflective surfaces for projecting the light 204 for scanning the FOV 320 and/or part thereof.

As seen at 1310, the process 1300 may be an iterative process having a plurality of iterations each corresponding to a respective scan period of the of the FOV 320 by the LIDAR system 300, for example, a line scan, a scan cycle of the FOV 320 and/or part thereof, and/or the like. In particular, during each scan period, the processor(s) 118 may operate the optical switch 320 to direct the light emitted by the light source(s) 112 through the first optical path 350A and through the second optical path 350A during the first time segment and the second time segment respectively of the respective scan period.

As described herein before, during each iteration of the process 1300 the projected light 204 may be directed from the light source(s) 112 towards the FOV 320 via a respective pair of reflective facets 316 of the rotatable light deflector 114, for example, the scanning polygon 314. As such the projected light 204 may be directed towards the FOV 320 via the same reflective facet 316 during different iterations, i.e., during different scan periods. Moreover, in some embodiments, a certain reflective facet 316 may serve as the first reflective facet 316A during a first scan period and as the second reflective facet 316B during a second scan period, for example, a subsequent scan period following the first scan period. In other embodiments, a certain reflective facet 316 may serve as the second reflective facet 316B during a first scan period and as the first reflective facet 316A during a second scan period, for example, a subsequent scan period following the first scan period.

During each scan period, the processor(s) 118 may receive signal data generated by the sensor(s) 116 which is indicative of light received by the sensor(s) 116. Moreover, based on the switching timing of the optical switch(es) 320, the processor(s) 118 may associate the signal data received from the sensor(s) 116 with the light 206 reflected from the FOV 320 in response to light projected to the FOV through the plurality of optical paths via the plurality of reflective facets 316. For example, the mapping processor(s) may associate a first signal data generated by the sensor(s) 116 during the first time segment of the scan period with light reflected from the FOV 320 via the first reflective facet 316A. In another example, the mapping processor(s) may associate a second signal data generated by the sensor(s) 116 during the second time segment of the scan period with light reflected from the FOV 320 via the second reflective facet 316B.

As described herein before, one or more processors, for example, the processor(s) 118 and/or the processor(s) 218 (designated mapping processor(s) herein before) may map one or more objects in the FOV 320 and/or part thereof using aggregated signal data comprising signal data indicative of light reflected from the FOV 320 in response to light 204 projected towards the FOV 320 via a plurality of reflective facets 316 of the scanning polygon 314. For example, the mapping processor(s) may generate one or more 3D models, for example, a point cloud representing the FOV and/or part thereof based on signal data indicative of light 206 reflected by one or more objects in the FOV illuminated with projected light 204 directed to the FOV 320 via a plurality of reflective facets 316 during each scan period.

According to some embodiments disclosed herein, rather than implementing an optical switch, a LIDAR system such as the LIDAR system 300 may have one or more light sources such as the light source 112 configured to emit a plurality of light beams, specifically a plurality of distribute light beams, for example, a beam array, and direct different subsets of the emitted light beams towards an FOV such as the FOV 320 through a plurality of optical paths utilizing different reflective facets of a rotatable light deflector such as the light deflector 114, for example, a scanning polygon such as the scanning polygon 314.

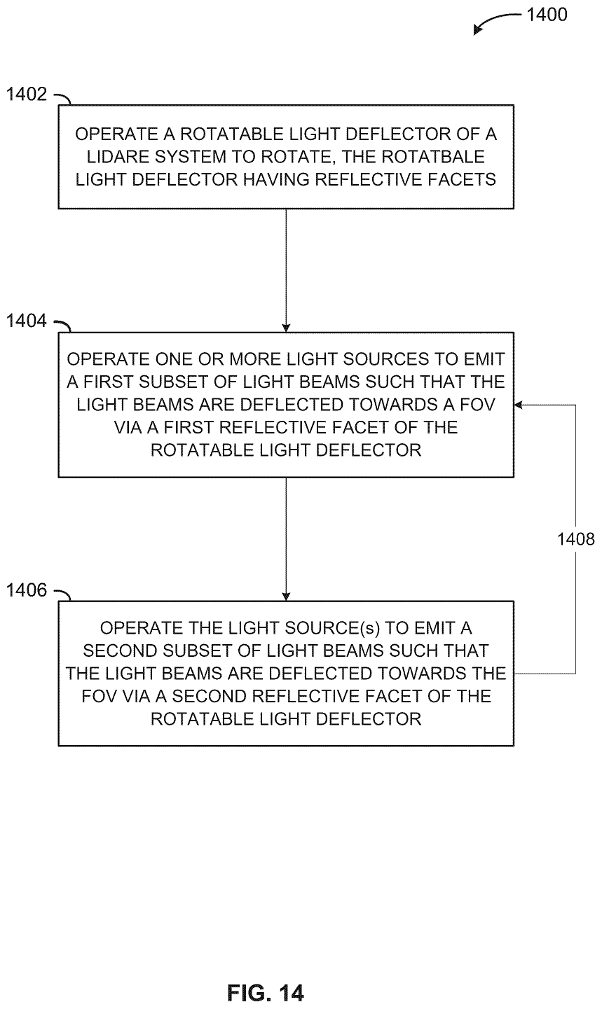

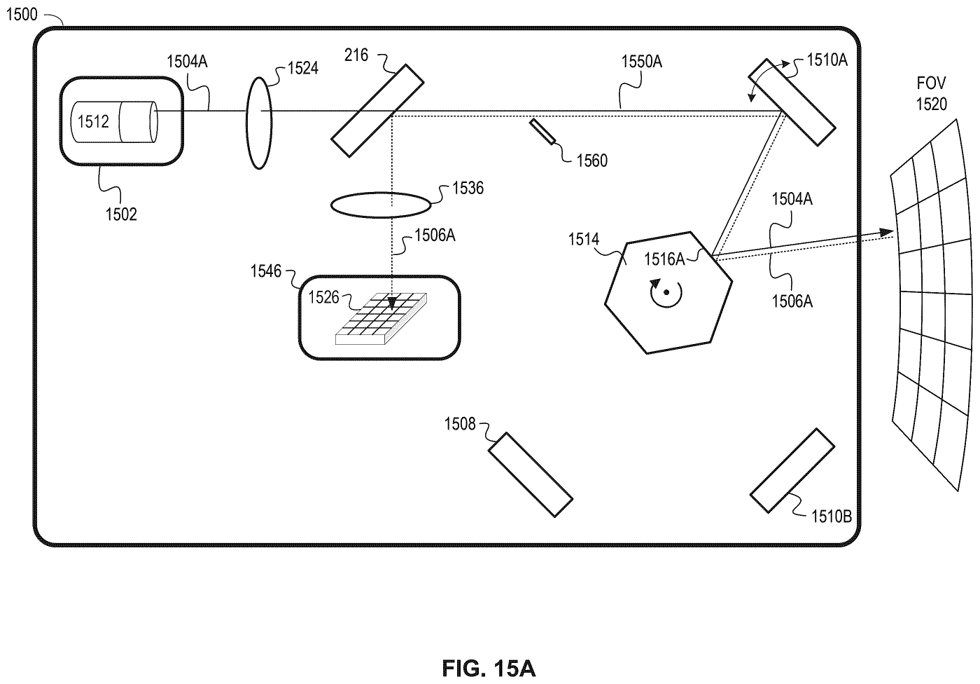

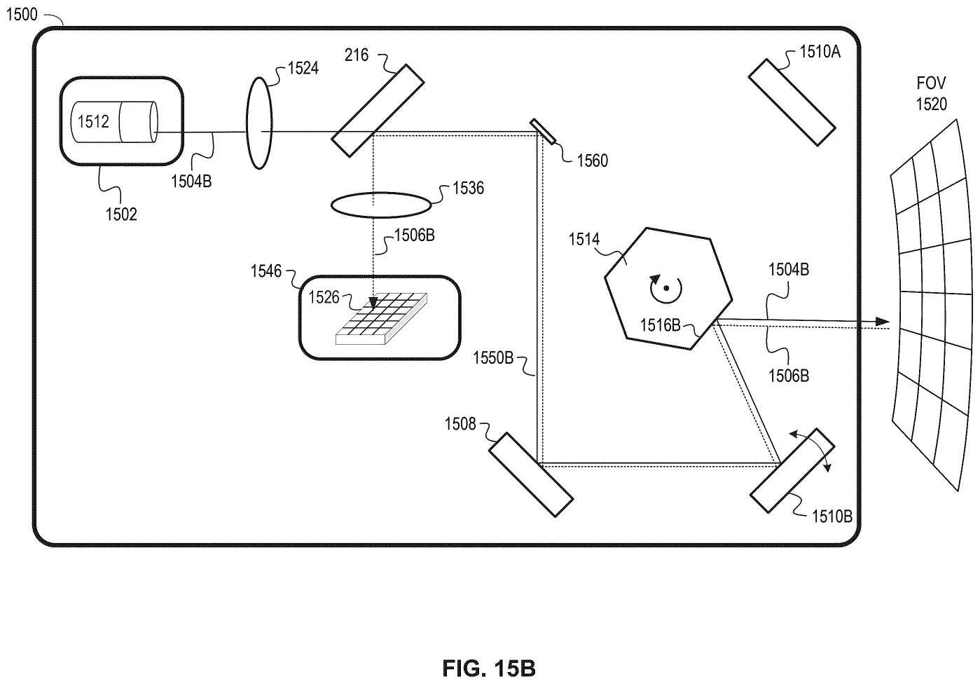

Reference is now made to FIG. 14, which is a flow chart of an exemplary process of scanning an FOV of a LIDAR by projecting to the FOV distinct beam subsets directed via multiple optical paths of the LIDAR system, in accordance with embodiments of the present disclosure. Reference is also made to FIG. 15A and FIG. 15B, which are schematic illustrations of an exemplary monostatic LIDAR system configured to scan its FOV using distinct beam subsets directed via multiple optical paths of the LIDAR system, in accordance with embodiments of the present disclosure.

An exemplary process 1400 may be executed by one or more processors such as the processor(s) 118 of an exemplary LIDAR system 1500 such as the LIDAR system 100 configured and deployed to scan an FOV 1520 such as the FOV 120. The LIDAR system 1500 may be similar to the LIDAR system 300 configured to scan the FOV 320 by light directed to the FOV through a plurality of optical paths. However, rather than directing the light emitted by one or more light sources 1512 such as the light source 112 towards the FOV 1520 through multiple optical paths 350 using one or more optical switches such as the optical switch 302 as done by the LIDAR system 300, the LIDAR system 1520 is configured to direct each of a plurality of subsets of light beams emitted by the light source(s) 1512 towards the FOV 1520 through a receptive one of a plurality of optical paths 1550.

Most of the components of the LIDAR system 1500 may be similar to corresponding components of the LIDAR system 300 and are not further described herein as they function the same as described for the LIDAR system 300. For example, the LIDAR system 1500 may include an illumination unit 1502 such as the illumination unit 102 comprising one or more light source 1512 such as the light source 112 configured to transmit light, in particular a plurality of light beams 1504, for example, a plurality of laser beams. The LIDAR system 1500 may also include a light deflector such as the light deflector 114, for empale, a scanning polygon 1516 such as the scanning polygon 314, optical elements 1510, and 1508 such as the optical elements 310 and 308, respectively. The LIDAR system 1500 may also include a sensing unit 1506 such as the sensing unit 106 which comprises one or more light sensors 1516 such as the sensor 116. Optionally, the LIDAR system 1500 may further include one or more optical elements 1524 such as the optical elements 304, for example, a lens, an aperture, a window, a light filter, a waveguide, a waveplate, a beam splitter, a mirror, and/or the like deployed for adjusting the light 1504 emitted by the light source(s) 1512, for example, collimating, focusing, de-focusing, polarizing, and/or the like. The LIDAR system 300 may further optionally comprise one or more optical elements 1536, for example, a lens, an aperture, a window, a light filter, a waveguide, a waveplate, a beam splitter, and/or the like deployed for adjusting the reflected light 1506 received from the FOV 820, for example, focusing, de-focusing, polarizing, and/or the like.

According to some embodiments, as illustrated in FIG. 15A and FIG. 15B, the LIDAR system 1500 may employ monostatic configuration similar to the LIDAR system 800 in which light 1504 projected to the FOV 1520 and light 1506 reflected (received) from the FOV 1520 may be directed through multiple at least partially common optical paths 1550, specifically a first optical path 1550A and a second optical path 1550B. In such embodiments the LIDAR system 1500 may also include one or more asymmetrical deflectors 216 configured to separate between the transmitted light 1504 and the reflected light 1504 by not deflecting the projected light 204 emitted by the light source(s) 1512 towards the FOV 1520 and deflecting the reflected light 206 received from the FOV 1520 towards the sensing unit 1506.

However, as described for the LIDAR systems 300 and 800, according to some embodiments, the LIDAR system 1500 may be a bistatic system in which the transmitted light 1504 and reflected light 1506 may be directed via separate optical paths each comprising one or more optical elements which are not shared between the transmit and receive optical paths.

The LIDAR system 1500 may further include one or more optical elements 1560 for directing at least part of the light beams 1504 emitted by the light source(s) 1512 towards the scanning polygon 1514 through the plurality of optical paths via a plurality of reflective facets 1516 of the scanning polygon 1514. For example, a first subset of light beams 1504A may be directed to the FOV 1520 through a first optical path 1550A via a first reflective facet 1516A of the scanning polygon 1514 and a second subset of light beams 1504B may be directed to the FOV 1520 through a second optical path 1550B via a second reflective facet 1516B of the scanning polygon 1514. In order to direct the second subset of light beams 1504B towards the second optical path 1550B and the second reflective facet 1516B, the LIDAR system 1500 may include one or more optical elements 1560, for example, a folding mirror positioned and configured to deflect the second subset of light beams 1504B towards the scanning polygon 1514 through the second optical path 1550B. As seen, the optical element(s) 1560 are positioned and configured to deflect the second subset of light beams 1504B towards the second optical path 1550B while not affecting (deflecting) the path of the first subset of light beams 1504A which thus pass through the first optical path 1550A.

As shown at 1402, the processor(s) 118 may operate the rotatable light deflector, for example, the scanning polygon 1514 to rotate.

As shown at 1404, at a first time segment of a scan period of the LIDAR system 1500, for example, a scan cycle, a part of the scan cycle, and/or the like, the processor(s) 118 may operate the source(s) 1512 to emit light, in particular, to emit a first subset of light beams 1504A comprising one or more light beams, for example, laser beams. The first subset of light beams 1504A may be directed towards the FOV 1520 through the first optical path 1550A and deflected (projected) towards the FOV 1520 via a first reflective facet 1516A of the rotatable light deflector, for example, the scanning polygon 1516.

As shown at 1406, at a second time segment of the scan period, the processor(s) 118 may operate the source(s) 1512 to emit light, in particular, to emit a second subset of light beams 1504B comprising one or more light beams, for example, laser beams. The second subset of light beams 1504B may be directed towards the FOV 1520 through the second optical path 1550B and deflected (projected) towards the FOV 1520 via a second reflective facet 1516B of the scanning polygon 1514.

In particular, the processor(s) 118 may synchronize the light source(s) 1512 with rotation of the scanning polygon 1514 such that the reflective facets 1516 through which the projected light 1504 is projected towards the FOV 320 are positioned and/or oriented to effectively utilize sections of their reflective surfaces for projecting the light 1504 for scanning the FOV 1520 and/or part thereof.

Optionally, rather than operating the light source(s) 1512 to emit the first and second subsets of light beams 1504 during alternating time segments of the scan period, the processor(s) 118 may operate one or more elements, for example, a shutter configured to pass through or block each of the first and/or second subsets of light beams during their respective time segments. In another example, the light source(s) 1512 may include one or more rotatable light sources which may be configured and/or operated to rotate and thus alternate their projection point between a plurality of states, for example, two states. As such, the rotatable light source(s) may be operated to set in its first state during the first time segment of the scan period such that the rotatable light source(s) is oriented to project the first subset of light beams 1504A towards the first optical path 1550A. During the second time segment of the scan period, the rotatable light source(s) may be set in its second state such that the rotatable light source(s) is oriented to project the second subset of light beams 1504B towards the second optical path 1550B.

As seen at 1408, the process 1400 may be an iterative process having a plurality of iterations each corresponding to a respective scan period of the of the FOV 1520 by the LIDAR system 1500 such that during each scan period, the processor(s) 118 may operate the light source(s) 1512 to emit the first subset of light beams 1504A and the second subset of light beams 1504B during the first time segment and the second time segment respectively of the respective scan period.

As described herein before, during each iteration of the process 1400 the projected light beams 1504 may be directed from the light source(s) 1512 towards the FOV 1520 via a respective pair of reflective facets 1516 of the rotatable light deflector 114, for example, the scanning polygon 1514. As such the projected light 1504 may be directed towards the FOV 1520 via the same reflective facet 1516 during different iterations, i.e., during different scan periods. Moreover, in some embodiments, a certain reflective facet 1516 may serve as the first reflective facet 1516A during a first scan period and as the second reflective facet 1516B during a second scan period, for example, a subsequent scan period following the first scan period. In other embodiments, a certain reflective facet 1516 may serve as the second reflective facet 1516B during a first scan period and as the first reflective facet 1516A during a second scan period, for example, a subsequent scan period following the first scan period.

Also as described herein before with relation to the process 1300, during each scan period, the processor(s) 118 may receive signal data generated by one or more sensors 1526 such as the sensor 116 of a sensing unit 1546 such as the sensing unit 106. The signal data received from the sensor(s) 1526 is indicative of light received by the sensor(s) 1526 and, based on the timing of the projected subsets of switch(es)light beams 1504, the processor(s) 118 may associate the signal data received from the sensor(s) 1526 with the light 1506 reflected from the FOV 1520 in response to light 1504 projected to the FOV through the plurality of optical paths via the plurality of reflective facets 1516. For example, the mapping processor(s) may associate a first signal data generated by the sensor(s) 1526 during the first time segment of the scan period with light 1506A reflected from the FOV 1520 in response to light 1504A projected to the FOV 1520 via the first reflective facet 1516A. In another example, the mapping processor(s) may associate a second signal data generated by the sensor(s) 1526 during the second time segment of the scan period with light 1506 reflected from the FOV 1520 in response to light 1504B projected to the FOV 1520 via the second reflective facet 1516B.

Moreover, one or more processors, for example, the processor(s) 118 and/or the processor(s) 218, designated mapping processor(s), may map one or more objects in the FOV 1520 and/or part thereof using aggregated signal data comprising signal data indicative of light reflected from the FOV 1520 in response to light 1504 projected towards the FOV 1520 via the plurality of reflective facets 1516 of the scanning polygon 1514. For example, the mapping processor(s) may generate one or more 3D models, for example, a point cloud representing the FOV and/or part thereof based on signal data indicative of light 1506 reflected by one or more objects in the FOV illuminated with projected light 1504 directed to the FOV 1520 via the plurality of reflective facets 1516 during each scan period.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Moreover, aspects of the present disclosure may be embodied as a system, method and/or computer program product. As such, aspects of the disclosed embodiments may be provided in the form of an entirely hardware embodiment, an entirely software embodiment, or a combination thereof.

Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs and computer programs products based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure.

It is expected that during the life of a patent maturing from this application many relevant systems, methods and computer programs will be developed and the scope of the terms LIDAR systems, light projection technologies, light sensing technologies, and scanning mechanisms are intended to include all such new technologies a priori.

The terms “comprise”, “comprising”, “include”, “including”, “having” and their conjugates mean “including but not limited to”. These terms encompass the terms “consisting of” and “consisting essentially of” which mean that the composition or method may include additional ingredients and/or steps if the additional elements and/or steps do not materially alter the novel characteristics of the claimed composition or method.

As used herein the term “about” refers to ±5%.

Throughout this disclosure, various embodiments may be presented in a range format. Description in range format is merely for convenience and brevity and should not be construed as an inflexible limitation on the scope of the invention. Accordingly, the description of a range should be construed to include all the possible subranges as well as individual numerical values within that range.

It is appreciated that certain features of embodiments disclosed herein, which are, for clarity, described in the context of separate embodiments, may also be provided in combination in a single embodiment. Also, features described in combination in the context of a single embodiment may also be provided separately or in suitable sub-combinations in other embodiments described herein.

Publications, patents, and patent applications referred to in this disclosure are to be incorporated into the specification in their entirety by reference as if each individual publication, patent, or patent application was specifically and individually included in the disclosure. However, indication and/or identification of any such referenced document may not be construed as admission that the referenced document is available as prior art to embodiments disclosed hereon.

The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A LIDAR system, comprising:
at least one light source configured to emit light;
at least one rotatable light deflector having a plurality of reflective facets to direct light emitted by the at least one light source to scan a field of view (FOV) of the LIDAR system; and
at least one optical switch having at least two states, the at least one optical switch interposed between the at least one light source and the at least one rotatable light deflector is configured to switch between the at least two states such that:
in a first state the at least one optical switch directs the emitted light towards the FOV via a first reflective facet of the plurality of reflective facets, and
in a second state the at least one optical switch directs the emitted light towards the FOV via a second reflective facet of the plurality of reflective facets.

2. The LIDAR system of claim 1, further comprising at least one processor configured to set the at least one optical switch in the first state during a first time segment of a scan period of the LIDAR system and in the second state during a second time segment of the scan period different from the first time segment.

3. The LIDAR system of claim 2, wherein the first time segment and the second time segment are defined according to a size of a cross section of a beam of the emitted light and a length of each reflecting facet.

4. The LIDAR system of claim 2, wherein the at least one processor is configured to synchronize switching of the at least one optical switch between states with rotation of the at least one rotatable light deflector based on a number of the plurality of reflective facets and a number of the at least two states.

5. The LIDAR system of claim 2, wherein the at least one processor is configured to prevent transmission of light emitted by the at least one light source towards the at least one optical switch during a transition time period during which the at least one optical switch transitions between states.

6. The LIDAR system of claim 1, wherein the plurality of reflective facets comprise at least three reflective facets, wherein during each scan period, the first reflective facet and the second reflective facet are selected from a respective pair of the at least three reflective facets.

7. The LIDAR system of claim 1, wherein the emitted light is directed to a first portion of the FOV via the first reflective facet and to a second portion of the FOV via the second reflective facet, wherein the first and second portions are distinct from each other or at least partially overlapping with each other.

8. The LIDAR system of claim 1, wherein at least one light sensor of the LIDAR system is configured to receive light reflected from the FOV illuminated by the light emitted by the at least one light source, the at least one light sensor is configured to generate signal data indicative of light collected by the at least one light sensor, wherein first signal data is associated with light received by the at least one light sensor from the FOV in response to light projected towards the FOV via the first reflective facet, and second signal data is associated with light received by the at least one light sensor from the FOV in response to light projected towards the FOV via the second reflective facet, the association is based on a timing of the first and second states of the at least one optical switch.

9. The LIDAR system of claim 8, wherein the emitted light directed towards the FOV and the reflected light which is received from the FOV and directed to the at least one light sensor share an at least partially common optical path comprising at least one optical component.

10. The LIDAR system of claim 9, wherein the at least one optical switch is further configured to direct the light reflected from the FOV toward the at least one light sensor of the LIDAR system via the at least partially common optical path, wherein, in the first state, light received from the FOV via the first reflective facet is directed toward the at least one light sensor, and in the second state, light received from the FOV via the second reflective facet is directed toward the at least one light sensor.

11. The LIDAR system of claim 1, wherein the at least one optical switch comprises a rotatable element comprising at least one mirror section configured to reflect light and at least one pass-through section configured to pass light.

12. The LIDAR system of claim 11, wherein when the rotatable element is in the first state, the emitted light is deflected by the at least one mirror section toward the FOV via the first reflective facet, and when the rotatable element is in the second state, the emitted light passes through the at least one pass-through section toward the FOV via the second reflective facet.

13. The LIDAR system of claim 11, wherein the at least one pass-through section comprises an aperture and/or a window transparent to the emitted light.

14. The LIDAR system of claim 1, wherein the at least one rotatable light deflector comprises a multi-faceted polygon.

15. The LIDAR system of claim 1, wherein the at least one light source is configured to emit a plurality of distributed light beams.

16. The LIDAR system of claim 1, further comprising:
at least one first lens interposed between the at least one light source and the at least one optical switch, the at least one first lens is configured to focus the emitted light directed towards the at least one optical switch, and
at least one second lens interposed between the at least one optical switch and the at least one rotatable deflector, the at least one second lens is configured to collimate the focused light received from the at least one first lens via the at least one optical switch.

17. The LIDAR system of claim 1, further comprising:
at least one first mirror disposed along a first optical path through which the light emitted by the at least one light source is directed towards the FOV via the first reflective facet, and
at least one second mirror disposed along a second optical path through which the light emitted by the at least one light source is directed towards the FOV via the second reflective facet,
wherein the at least one first mirror and the at least one second mirror are oriented according to a structure of the at least one rotatable light deflector and an extent of the FOV.

18. The LIDAR system of claim 1, wherein the plurality of reflective facets comprise at least one tilted reflective facet having a reflective surface tilted with respect to a rotation axis of the at least one light deflector.

19. The LIDAR system of claim 1, wherein objects in the FOV are mapped based on increased pixel data generated through increased pixel rate based on aggregated signal data indicative of light reflected from the FOV via the first reflective facet and via the second reflective facet.

20. The LIDAR system of claim 1, further comprising aggregating signal data indicative of light reflected from the FOV via the first reflective facet at incident angles, with respect to a projection of a normal to the first reflective facet on a plane perpendicular to a rotation axis of the rotatable light deflector, having an absolute value smaller than a certain threshold angle and signal data indicative of light reflected from the FOV via the second reflective facet at incident angles, with respect to a projection of a normal to the second reflective facet on a plane perpendicular to a rotation axis of the rotatable light deflector, having an absolute value, having an absolute value smaller than the certain threshold angle.

21. A method of scanning a field of view (FOV) of a LIDAR system, comprising:
using at least one processor configured for:
operating at least one light source of a LIDAR system to emit light;
operating at least one rotatable light deflector to rotate, the at least one light deflector has a plurality of reflective facets;
operating, at first time segment of a scan period of the LIDAR system, at least one optical switch interposed between the at least one light source and the at least one rotatable light deflector to switch to a first state for directing the light emitted by the at least one light source towards the FOV via a first reflective facet of the plurality of reflective facets of the at least one rotatable light deflector; and
operating, at second time segment of the scan period, the at least one optical switch to switch to a second state for directing the emitted light towards the FOV via a second reflective facet of the plurality of reflective facets.

22. The method of claim 21, wherein at least one of the plurality of reflective facets is tilted with respect to a rotation axis of the at least one light deflector, the at least one processor is further configured to aggregate first signal data indicative of light reflected from the FOV in response to light projected towards the FOV via the at least one tilted reflective facet and at least one second signal data indicative of light reflected from the FOV in response to light projected towards the FOV via at least one another reflective facet of the plurality of reflective facets,
wherein the first signal data is indicative of light received in response to light projected towards the FOV at incident angles, with respect to a projection of a normal to the at least one tilted reflective facet on a plane perpendicular to a rotation axis of the rotatable light deflector, having an absolute value smaller than a certain threshold angle, and
wherein the at least one second signal data is indicative of light received in response to light projected towards the FOV at incident angles, with respect to a projection of a normal to the at least one another reflective facet on a plane perpendicular to a rotation axis of the rotatable light deflector, having an absolute value smaller than a certain threshold angle.

23. The method of claim 22, wherein the at least one processor is further configured to operate at least one light sensor of the LIDAR system, wherein, in the first state of the at least one optical switch, light reflected from the FOV is directed to the at least one light sensor via a first reflective facet, and in the second state of the at least one optical switch, light reflected from the FOV is directed to the at least one light sensor via a second reflective facet.

24. A LIDAR system, comprising:
at least one light source configured to emit a plurality of light beams;
at least one light sensor configured to receive light;
at least one rotatable light deflector having a plurality of reflective facets for directing light beams emitted by the at least one light source to scan a field of view (FOV) of the LIDAR system and directing light reflected from the FOV towards the at least one light sensor; and
at least one processor configured for:
operating the at least one light source, at a first time segment of a scan period of the LIDAR system, to emit a first subset of light beams towards the FOV via a first reflective facet of the at least one rotatable light deflector and directing light reflected from the FOV towards the at least one light sensor via the first reflective facet; and
operating the at least one light source, at a second time segment of the scan period, to emit a second subset of light beams towards the FOV via a second reflective facet of the at least one rotatable light deflector and directing light reflected from the FOV towards the at least one light sensor via the second reflective facet.
